(19) United States
(12) Patent Application Publication
(10) Pub. No.: US 2025/0212908 A1
(43) Pub. Date: Jul. 3, 2025

(54) CHOCOLATE CONSUMABLES PRODUCED FROM CACAO WASTE PRODUCTS

(71) Applicant: Voyage Foods, Inc., Oakland, CA (US)

(72) Inventors: BreeAnn Crofts, Richmond, CA (US); Kelsey Tenney, Oakland, CA (US); Brandon Head, Oakland, CA (US); Lucas Baker, San Francisco, CA (US); Adam Maxwell, San Francisco, CA (US)

(21) Appl. No.: 19/005,483

(22) Filed: Dec. 30, 2024

Related U.S. Application Data
(60) Provisional application No. 63/616,290, filed on Dec. 29, 2023.

(51) Int. Cl. A23G 1/48; A23G 1/00; A23G 1/02; A23G 1/34; A23G 1/36; A23G 1/38

(52) U.S. Cl. CPC A23G 1/48; A23G 1/0016; A23G 1/02; A23G 1/34; A23G 1/36; A23G 1/38

(57) ABSTRACT

Consumable products and food ingredients made with cacao waste materials (e.g., cocoa shells and cocoa pods) are provided herein, as are methods and materials for processing the cacao waste materials.

### CROSS-REFERENCE TO RELATED APPLICATIONS

This application claims priority to U.S. Application No. 63/616,290, filed on Dec. 29, 2023, the disclosure of which is incorporated herein by reference in its entirety.

### TECHNICAL FIELD

This document relates to methods and materials for processing and using cacao waste materials (e.g., cocoa shells and cocoa pods) and compositions (e.g., food products and consumables) containing the processed cacao waste materials.

### BACKGROUND

Cocoa beans are the precursor ingredient to chocolate. The beans are removed from the cacao fruit, which also includes pulp and an outer cocoa pod husk, and left to ferment and mature in the sun for color, flavor, and other biochemical processes that are necessary to make chocolate. The cocoa pod husk can constitute between 70 to 80% of the weight of the whole fruit. After removal of the beans, the cocoa pods after harvest are generally thrown on the ground and composted for the soil. The remaining beans consist of an inside nib, which is the prized “meat” of the bean that has an attached shell surrounding the outer part of the cocoa bean. This cocoa shell represents between 12 and 15% of the total cocoa bean weight. The cocoa shell is generally removed from the cocoa bean before making chocolate, and thus the shell is a by-product of the chocolate industry. Once separated, the shell waste is typically discarded or composted.

Although there has been great interest in obtaining food products from waste stream materials, there are challenges to using cocoa shells or cocoa pods in chocolate production. Cocoa shells, for example, are notoriously difficult to process due to their high lignin-cellulosic content, which constitutes about 50-60% of its weight in insoluble fiber. See, e.g., Sánchez et al., Antioxidants. 2023; 12 (5):1028. The shells also are damaging to refining equipment used in chocolate manufacturing. Further, roasting cocoa pods and shells does not make them more friable (i.e., prone to breakage). Rather, in some instances, roasting or other processes can render them even more resistant to breakdown through grinding or other mechanical processes. Thus, there remains a long-felt need presented by cacao waste stream ingredients that are not able to be used as consumable products despite their abundance, low-cost, and valuable nutritional characteristics. There also remains a long-felt need to improve the processability and also the sensory qualities of products that otherwise would have fewer desirable characteristics, such that the improved products can be applied to new categories of foods and beverages.

### SUMMARY

The methods and materials provided herein take a new approach to creating cocoa fillers and coatings by solving a long-felt need in the chocolate industry: finding a suitable replacement of all or a portion of dry cocoa solids in a chocolate product with abundant and inexpensive cacao waste materials (which also can be referred to as “cocoa waste materials”). This document provides solutions to the technical challenges for producing food products and consumables from cacao waste materials, specifically cocoa pods and cocoa shells. For example, by using particular treatments (e.g., pH adjustment and acid or base hydrolysis, enzymatic breakdown, roasting, or a combination thereof), valuable new food products can be created from these waste materials. This document provides materials and methods for processing cocoa shells, cocoa pods and/or other lignocellulosic biomass from cacao fruit to produce ingredients that can be used (e.g., as carbohydrate-based fillers and/or to replace one or more traditional ingredients) in consumable food and beverage products. In some cases, for example, processed cocoa shells or cocoa pods generated by the methods provided herein can be used in chocolate or coffee replacement beverages, cocoa-alternative products, fillers for chocolate and chocolate-alternative consumables, replacements for dry cocoa solids, fat-based spreads, and alternative plant-based foods. The methods provided herein allow for the use of cacao waste streams such that there are few—if any—differences between standard of identity chocolate products and chocolate products containing the processed cacao waste products. For example, the processed cacao waste materials described herein can provide cocoa flavor similar to that of cocoa products produced using cocoa nibs, without off-notes or odors. As used herein, “traditional” chocolate refers to chocolate products produced through standard chocolate making processes, which include the farming of cacao beans and processing of nibs from the cacao beans. Cacao nibs, the edible part of the cacao bean remaining once the inedible shells have been removed, are ground to create traditional chocolate liquor, which can be pressed to separate cocoa butter from cocoa solids. Because cacao nibs are the source of both cocoa solids and cocoa butter, cacao nibs are essentially the defining ingredient of traditional chocolate.

In general, the methods provided herein can include subjecting a cocoa shell or cocoa pod to one or more treatments (e.g., acid or base hydrolysis and/or enzymatic treatment) before or after it is further processed by optionally roasting and/or grinding, in order to facilitate downstream food processing and to produce ground products having desirable sensory characteristics. The methods provided herein for processing cocoa shells and cocoa pods can overcome technical challenges and increase the availability of desirable components of such waste materials. The present document provides processes for utilizing cocoa shells in value-added consumables, which would have the added benefit of reducing waste in chocolate production by up to 15%. This improvement in processability does not compromise on product quality. In addition, the use of cacao waste materials provide the benefit of reducing oxidation. In typical treatments of cocoa nibs, beans or liquor, there is a fat content of approximately 50% in the form of cocoa butter. Fats and oils are notorious for fat oxidation, which can be exacerbated through processes like hydrolysis. However, the use of high-lignin content, low-fat content cacao waste in chocolate-based products can reduce oxidation and thus increase the shelf life and quality of the final product (e.g., by reducing off flavor notes that are related to rancidity).

In a first aspect, this document provides a consumable product that contains, consists essentially of, acid-hydrolyzed and roasted cacao waste material or alkali-hydrolyzed and roasted cacao waste material, wherein the cacao waste material comprises cocoa shells, cocoa pods, or cocoa shells and cocoa pods. The consumable product can further include enzymatically-treated cacao waste material. The cacao waste material can be ground cacao waste material having an average particle size of about 15 to about 300 microns, about 200 to about 300 microns, about 150 to about 200 microns, about 100 microns to about 150 microns, about 50 microns to about 100 microns, about 50 microns to about 75 microns, about 25 to about 50 microns, about 25 microns, about 20 microns, or less than about 20 microns. The consumable product can be a chocolate or chocolate-like product containing a milk, semi-sweet, or dark chocolate, or containing a milk, semi-sweet, or dark chocolate-like product. The consumable product can be a chocolate including a semi-sweet chocolate, milk chocolate, or dark chocolate, and the ground cacao waste material can be a filler for the chocolate. The consumable product can be a chocolate including a semi-sweet chocolate, milk chocolate, or dark chocolate, and the consumable product can further contain one or more fillers. The chocolate can contain cocoa nibs, cocoa solids, dry cocoa powder, or cocoa liquor. The ground cacao waste material can be a cocoa-free substitute for cocoa solids or a cocoa-free substitute for cocoa liquor. The consumable product can further comprise one or more of the following: a fat, a liquid oil, a vegetable fat, cocoa butter, cocoa butter equivalent and/or a cocoa butter substitute, wherein the ground cacao waste material is wet milled with the fat, a liquid oil, a vegetable fat, cocoa butter, cocoa butter equivalent and/or a cocoa butter substitute to produce a cocoa-free substitute for chocolate liquor. The consumable product can include cacao waste material dry milled with a mechanical grinder, a power grinder, a crushing mill, a burr mill, an espresso grinder, a jet mill, a blade grinder, a vortex grinder, and/or a hammer mill. The consumable product can be a chocolate-like product containing a cocoa-free substitute for dry cocoa solids or a cocoa-free substitute for chocolate liquor. The consumable product can be a chocolate or chocolate-like product that contains 0.01% to about 50% by weight of the ground cacao waste material; about 20% to about 55% by weight cocoa butter, cocoa butter equivalent, or cocoa butter substitute; about 20% to about 60% by weight sugar; and optionally, about 0.01% to about 50% by weight cocoa solids. The consumable product can be a chocolate or chocolate-like product that contains about 22.5% by weight of the ground cacao waste material; about 22.5% by weight cocoa butter, cocoa butter equivalent, or cocoa butter substitute; about 20 to about 60% by weight sugar; and optionally, about 0.01% to about 50% by weight cocoa solids. The consumable product can be a chocolate or chocolate-like product that further contains one or more of sugar, vanilla extract, soy lecithin, and sunflower lecithin. The ground cacao waste material can include about 50 wt % of the consumable product, and cocoa butter, a cocoa butter equivalent, or a cocoa butter substitute can comprise about 50 wt % of the consumable product. The consumable product can be in the form of a powder. The consumable product can be a substitute for dry cocoa powder. The consumable product can be in the form of a paste. The consumable product can be a chocolate-like liquor. The product can be a consumable food or beverage. The acid-hydrolyzed cacao waste material can have been hydrolyzed with an acid including sulfuric acid, hydrochloric acid, phosphoric acid, lactic acid, citric acid, malic acid, acetic acid, fumaric acid, tartaric acid, nitric acid, or glucono-delta-lactone. The base-hydrolyzed cacao waste material can have been hydrolyzed with a base including sodium hydroxide, potassium hydroxide, lye, sodium carbonate, calcium carbonate, calcium hydroxide, or potassium bicarbonate.

In another aspect, this document features a consumable product that contains, consists essentially of, or consists of an acid-hydrolyzed or base-hydrolyzed cacao waste material ground to an average particle size of less than about 300 microns. The cacao waste material can include cocoa shells, cocoa pods, or cocoa shells and cocoa pods. The acid-hydrolyzed or base-hydrolyzed cacao waste material can include acid-hydrolyzed and roasted cacao waste material or base-hydrolyzed and roasted cacao waste material. The consumable product can further contain enzymatically-treated cacao waste material. The average particle size can be about 15 to about 300 microns, about 200 to about 300 microns, about 150 to about 200 microns, about 100 microns to about 150 microns, about 50 microns to about 100 microns, about 50 microns to about 75 microns, about 25 to about 50 microns, about 25 microns, about 20 microns, or less than about 20 microns. The consumable product can further contain cocoa nib solids. The consumable product can be a chocolate or chocolate-like product containing a milk, semi-sweet, or dark chocolate, or containing a milk, semi-sweet, or dark chocolate-like product. The consumable product can be a chocolate including a semi-sweet chocolate, milk chocolate, or dark chocolate, and the ground cacao waste material can be a filler for the chocolate. The consumable product can be a chocolate including a semi-sweet chocolate, milk chocolate, or dark chocolate, and the consumable product can further contain one or more fillers. The chocolate can contain cocoa nibs, cocoa solids, dry cocoa powder, or cocoa liquor. The ground cacao waste material can be a cocoa-free substitute for cocoa solids or a cocoa-free substitute for cocoa liquor. The consumable product can be a chocolate-like product containing a cocoa-free substitute for dry cocoa solids or a cocoa-free substitute for chocolate liquor. The consumable product can be a chocolate or chocolate-like product that contains 0.01% to about 50% by weight of the ground cacao waste material; about 20% to about 55% by weight cocoa butter, cocoa butter equivalent, or cocoa butter substitute; about 20% to about 60% by weight sugar; and optionally, about 0.01% to about 50% by weight cocoa solids. The consumable product can be a chocolate or chocolate-like product that contains about 22.5% by weight of the ground cacao waste material; about 22.5% by weight cocoa butter, cocoa butter equivalent, or cocoa butter substitute; about 20 to about 60% by weight sugar; and optionally, about 0.01% to about 50% by weight cocoa solids. The consumable product can be a chocolate or chocolate-like product that further contains sugar, vanilla extract, and/or soy lecithin. The ground cacao waste material can include about 50 wt % of the consumable product, and cocoa butter, a cocoa butter equivalent, or a cocoa butter substitute can comprise about 50 wt % of the consumable product. The consumable product can be in the form of a powder. The consumable product can be a substitute for dry cocoa powder. The consumable product can be in the form of a paste. The consumable product can be a chocolate-like liquor. The product can be a consumable food or beverage. The acid-hydrolyzed cacao waste material can have been hydrolyzed with an acid including sulfuric acid, hydrochloric acid, phosphoric acid, lactic acid, citric acid, malic acid, acetic acid, fumaric acid, tartaric acid, nitric acid, or glucono-delta-lactone. The base-hydrolyzed cacao waste material can have been hydrolyzed with a base including sodium hydroxide, potassium hydroxide, lye, sodium carbonate, calcium carbonate, calcium hydroxide, or potassium bicarbonate.

In another aspect, this document features a composition that contains, consists essentially of, or consists of ground cocoa shells and/or ground cocoa pods, and one or more of a butanal, a pyrazine, or pyrrole. In some cases, the composition is a consumable product. The cocoa shells and/or cocoa pods can include acid-hydrolyzed and roasted cocoa shells and/or cocoa pods, or base-hydrolyzed and roasted cocoa shells and/or cocoa pods. The acid-hydrolyzed cocoa shells and/or cocoa pods can have been hydrolyzed with an acid including sulfuric acid, hydrochloric acid, phosphoric acid, lactic acid, citric acid, malic acid, acetic acid, fumaric acid, tartaric acid, nitric acid, or glucono-delta-lactone. The base-hydrolyzed cacao shells and/or cocoa pods can have been hydrolyzed with an base including sodium hydroxide, potassium hydroxide, lye, sodium carbonate, calcium carbonate, calcium hydroxide, or potassium bicarbonate.

In another aspect, this document features a composition that contains, consists essentially of, or consists of a plant substrate, where the plant substrate includes ground cocoa shells and/or ground cocoa pods, where the ground cocoa shells and/or ground cocoa pods were hydrolyzed with an acid or a base prior to and/or after being ground, and where the composition contains 2-methylbutanal, 3-methylbutanal, 2,5-dimethylpyrazine, 2,3-dimethylpyrazine, 2,3,5-trimethylpyrazine, 3-ethyl-2,5-dimethylpyrazine, 2,3-dimethyl-5-ethylpyrazine, tetramethylpyrazine, 2,3,5-trimethyl-6-ethylpyrazine, 3-isopentyl-2,5-dimethyl-pyrazine, or 2-acetylpyrrole. The acid can include sulfuric acid, hydrochloric acid, phosphoric acid, lactic acid, citric acid, malic acid, acetic acid, fumaric acid, tartaric acid, nitric acid, or glucono-delta-lactone. The base can include sodium hydroxide, potassium hydroxide, lye, sodium carbonate, calcium carbonate, calcium hydroxide, or potassium bicarbonate. In some cases, the composition is a consumable product.

In another aspect, this document features a method for making a substitute for cocoa nib solids from cocoa shells or cocoa pods. The method can include, or consist essentially of, (a) treating a plurality of cocoa shell or cocoa pod fragments with a chemical solution and/or an enzymatic solution, thereby producing treated shell or pod fragments; (b) reducing the moisture content of the treated shell or pod fragments to about 3% w/w or less of the treated shell or pod fragments, thereby producing dried shell or pod fragments; (c) roasting the dried shell or pod fragments, thereby producing roasted shell or pod fragments; and (d) grinding the roasted shell or pod fragments, thereby producing a ground cocoa shell or ground cocoa pod composition, where the composition is effective as a substitute for cocoa nib solids. The method can include treating the cocoa shell or cocoa pod fragments with a chemical solution containing an acid or base solution for about 15 minutes to about 60 minutes, thereby producing acid-treated or base-treated cocoa shell or cocoa pod fragments. The method can include treating the cocoa shell or cocoa pod fragments with the acid or base solution at a temperature of about 50° C. to about 100° C. The method can include roasting the acid-treated or base-treated cocoa shell or cocoa pod fragments to a temperature of about 165° C. to about 250° C. The chemical solution can contain an acid such as sulfuric acid, hydrochloric acid, phosphoric acid, lactic acid, citric acid, malic acid, acetic acid, fumaric acid, tartaric acid, nitric acid, or glucono-delta-lactone. The chemical solution can contain a base such as sodium hydroxide, potassium hydroxide, lye, sodium carbonate, calcium carbonate, calcium hydroxide, or potassium bicarbonate.

In another aspect, this document features a method for making a substitute for chocolate liquor from cocoa shells or cocoa pods. The method can include, or consist essentially of, (a) treating a plurality of cocoa shell or cocoa pod fragments with a chemical solution and/or an enzymatic solution, thereby producing treated shell or pod fragments; (b) reducing the moisture content of the treated shell or pod fragments to about 3% w/w or less of the treated shell or pod fragments, thereby producing dried shell or pod fragments; (c) roasting the dried shell or pod fragments, thereby producing roasted shell or pod fragments; and (d) wet grinding the roasted shell or pod fragments in the presence of an oil or fat, thereby producing a ground cocoa shell or ground cocoa pod paste, where the paste is effective as a substitute for cocoa liquor. The method can include treating the cocoa shell or cocoa pod fragments with a chemical solution containing an acid or base solution for about 15 minutes to about 60 minutes, thereby producing acid-treated or base-treated cocoa shell or cocoa pod fragments. The method can include treating the cocoa shell or cocoa pod fragments with the acid or base solution at a temperature of about 50° C. to about 100° C. The method can include roasting the acid-treated or base-treated cocoa shell or cocoa pod fragments to a temperature of about 165° C. to about 250° C. The chemical solution can contain an acid such as sulfuric acid, hydrochloric acid, phosphoric acid, lactic acid, citric acid, malic acid, acetic acid, fumaric acid, tartaric acid, nitric acid, or glucono-delta-lactone. The chemical solution can contain a base such as sodium hydroxide, potassium hydroxide, lye, sodium carbonate, calcium carbonate, calcium hydroxide, or potassium bicarbonate.

In another aspect, this document features a method for making a filler for chocolate prepared from cocoa shell or cocoa pod fragments. In some cases, this document features a method for making a chocolate containing a filler prepared from cocoa shell or cocoa pod fragments. The methods can include, or consist essentially of, (a) treating a plurality of cocoa shell or cocoa pod fragments with a chemical solution and/or an enzymatic solution, thereby producing treated cocoa shell or cocoa pod fragments; (b) removing the treated cocoa shell or cocoa pod fragments from the chemical and/or enzymatic solution; (c) roasting the treated cocoa shell or cocoa pod fragments, thereby producing roasted cocoa shell or cocoa pod fragments; and (d) grinding the roasted cocoa shell or cocoa pod fragments, thereby producing a ground cocoa shell or ground cocoa pod composition, where the composition is used as all or a portion of the filler (e.g., a filler for chocolate). The methods can include treating the cocoa shell or cocoa pod fragments with a chemical solution containing an acid or base solution for about 15 minutes to about 60 minutes, thereby producing acid-treated or base-treated cocoa shell or cocoa pod fragments. The methods can include treating the cocoa shell or cocoa pod fragments with the acid or base solution at a temperature of about 50° C. to about 100° C. The methods can include roasting the acid-treated or base-treated cocoa shell or cocoa pod fragments to a temperature of about 135° C. to about 250° C. The methods can include roasting the acid-treated or base-treated cocoa shell or cocoa pod fragments to a temperature of about 165° C. to about 250° C. The chemical solution can contain an acid such as sulfuric acid, hydrochloric acid, phosphoric acid, lactic acid, citric acid, malic acid, acetic acid, fumaric acid, tartaric acid, nitric acid, or glucono-delta-lactone. The chemical solution can contain a base such as sodium hydroxide, potassium hydroxide, lye, sodium carbonate, sodium bicarbonate, calcium carbonate, calcium hydroxide, or potassium bicarbonate.

In another aspect, this document features a composition containing particles of a processed cacao waste product that has been (a) chemically or enzymatically treated and (b) ground, wherein the particles in the composition are less than 150 microns in size. The cacao waste product can include cocoa shells. The cacao waste product can include cocoa pods. The particles can be less than 100 microns in size. The particles can have an average particle size of about 15 microns to about 150 microns. The composition can be a powder. The composition can be a paste. The composition can be a chocolate liquor or a chocolate-like liquor. About 50 wt % of the composition can be the particles and about 50 wt % of the composition can be cocoa butter. In some cases, about 50 wt % of the composition can be the particles and about 50 wt % of the composition can be cocoa butter, a cocoa butter substitute, a cocoa butter equivalent, an oil, or a vegetable fat. The composition can be a consumable food or beverage.

In another aspect, this document features a method for preparing a ground plant substrate from cacao waste material for use in a consumable food or beverage. The method can include, or consist essentially of, treating the cacao waste material with an acid in aqueous solution until the cacao waste material reaches a pH of about 2 to 6, thereby generating an acid-treated cacao waste material, roasting the acid-treated cacao waste material to generate a roasted, acid-treated cacao waste material, and grinding the roasted, acid-treated cacao waste material to yield the ground plant substrate. The cocoa waste material can include cocoa shells. The cocoa waste material can include cocoa pods. The acid can include sulfuric acid, hydrochloric acid, phosphoric acid, lactic acid, citric acid, malic acid, acetic acid, fumaric acid, tartaric acid, nitric acid, or glucono-delta-lactone. The method can include treating the cacao waste material until a pH of about 2.5 to about 4.5 is reached. In some cases, the method can include treating the cacao waste material until its pH is lowered by at least about pH 1, as compared to the pH of cacao waste material that is untreated (e.g., the cacao waste material before it was treated). For example, from a starting pH of 5-6 for cocoa shells or cocoa pods, the method can include treating the shells or pods until the pH is about 4-5, 4, or lower. The method can include treating the cacao waste material with the acid solution at a temperature of about 50° C. to about 100° C. The method can include treating the cacao waste material with the acid solution for about 10 minutes to about 3 hours. The method can include treating the cacao waste material with the acid solution for about 15 minutes to about 60 minutes. The method can include roasting the acid-treated plant material to a temperature of about 165° C. to about 250° C. The method can include grinding the roasted, acid-treated plant material to an average particle size of about 15 microns to about 150 microns. The method can further include extracting the ground substrate with an aqueous solution to produce an extract. The method can include extracting the ground plant substrate with water at a temperature of about 60° C. to about 85° C. The method can further include cooling the extract. The method can further include filtering the extract. The method can further include concentrating the extract to form a concentrate. The method can include concentrating the extract by removing at least some water from the extract. A portion of the water can be removed by evaporation, freezing, and/or thawing of the extract. The method can further include drying the concentrate to form a powder concentrate. The drying can include spray drying, freeze drying or dehydrating. The concentrate can be a soluble powder having a moisture content from about 1% w/w to about 10% w/w. The soluble powder can be water soluble.

In another aspect, this document features a composition containing a ground plant substrate prepared using the method described above. The composition can be a consumable food or beverage. This document also features a composition containing an extract prepared using the method described above, as well as a composition containing a concentrate prepared using the method described above.

In another aspect, this document features a method for preparing a ground plant substrate from cacao waste material for use in a consumable food or beverage, wherein the method includes, or consists essentially of, treating the cacao waste material with a base in aqueous solution until the cacao waste material reaches a pH of about 7 to 12.5, thereby generating a base-treated cacao waste material, roasting the base-treated cacao waste material to generate a roasted, base-treated cacao waste material, and grinding the roasted, base-treated cacao waste material to yield the ground plant substrate. The cacao waste material can include cocoa shells. The cacao waste material can include cocoa pods. The base can include sodium hydroxide, potassium hydroxide, lye, sodium carbonate, calcium carbonate, calcium hydroxide, or potassium bicarbonate. The method can include treating the cacao waste material until a pH of about 6 to about 10.5 is reached. In some cases, the method can include treating the cacao waste material until its pH is increased by at least about pH 1, as compared to the pH of cacao waste material that is untreated (e.g., the cacao waste material before it was treated). For example, from a starting pH of 5-6 for cocoa shells or cocoa pods, the method can include treating the shells or pods until the pH is about 6, 6-7, or higher. The method can include treating the cacao waste material with the base solution at a temperature of about 50° C. to about 100° C. The method can include treating the cacao waste material with the base solution for about 10 minutes to about 3 hours. The method can include treating the cacao waste material with the base solution for about 15 minutes to about 60 minutes. The method can include roasting the base-treated plant material to a temperature of about 165° C. to about 250° C. The method can include grinding the roasted, base-treated plant material to an average particle size of about 15 microns to about 150 microns. The method can further include extracting the ground substrate with an aqueous solution to produce an extract. The method can include extracting the ground plant substrate with water at a temperature of about 60° C. to about 85° C. The method can further include cooling the extract. The method can further include filtering the extract. The method can further include concentrating the extract to form a concentrate. The method can include concentrating the extract by removing at least some water from the extract. A portion of the water can be removed by evaporation, freezing, and/or thawing of the extract. The method can further include drying the concentrate to form a powder concentrate. The drying can include spray drying, freeze drying or dehydrating. The concentrate can be a soluble powder having a moisture content from about 1% w/w to about 10% w/w. The soluble powder can be water soluble.

In another aspect, this document features a composition containing a ground plant substrate prepared using the method described above. The composition can be a consumable food or beverage. This document also features a composition containing an extract prepared using the method described above, as well as a composition containing a concentrate prepared using the method described above.

In another aspect, this document features a method for preparing a ground plant substrate from cacao waste material for use in a consumable food or beverage, where the method includes, or consists essentially of, contacting the cacao waste material with an enzymatic solution containing one or more enzymes to generate an enzymatically-treated plant material, roasting the enzymatically-treated plant material to generate a roasted, enzymatically-treated plant material, and grinding the roasted, enzymatically-treated plant material to yield the ground plant substrate. The cocoa waste material can include cocoa shells. The cocoa waste material can include cocoa pods. The one or more enzymes can include a carbohydrase, a protease, and/or a ligninase. The one or more enzymes can include at least one of amylase, α-amylase, β-amylase, lactase, sucrase, isomaltase, pectinase, cellulase, hemicellulase, xylanase, tannase, bromelain, an alkaline protease, papain, actinidin, and ligninase. The enzymatic solution can contain about 0.1% to about 1% enzyme. The method can include treating the cacao waste material with the enzymatic solution at a pH of about 7 to about 9. The method can include treating the cacao waste material with the acid solution at a temperature of about 30° C. to about 80° C. The method can include treating the cacao waste material with the enzymatic solution for about 15 minutes to about 60 minutes. The method can include roasting the acid-treated plant material to a temperature of about 165° C. to about 250° C. The method can include grinding the roasted, acid-treated plant material to an average particle size of about 100 microns to about 5 mm. The method can further include extracting the ground substrate with an aqueous solution to produce an extract. The method can include extracting the ground plant substrate with water at a temperature of about 60° C. to about 85° C. The method can further include cooling the extract. The method can further include filtering the extract. The method can further include concentrating the extract to form a concentrate. The method can include concentrating the extract by removing at least some water from the extract. A portion of the water can be removed by evaporation, freezing, and/or thawing of the extract. The method can further include drying the concentrate to form a powder concentrate. The drying can include spray drying, freeze drying or dehydrating. The concentrate can be a soluble powder having a moisture content from about 1% w/w to about 10% w/w. The soluble powder can be water soluble.

In another aspect, this document features a composition containing a ground plant substrate prepared using the method described above. The composition can be a consumable food or beverage. This document also features a composition containing an extract prepared using the method described above, as well as a composition containing a concentrate prepared using the method described above.

In another aspect, this document features a method for making a substitute for dry cocoa solids from cocoa shells, wherein the method comprises: (a) treating a plurality of cocoa shells with a chemical solution, thereby producing treated cocoa shells; (b) reducing the moisture content of the treated cocoa shells to 25% w/w or less of the treated cocoa shells, thereby producing dried cocoa shells; (c) roasting the dried cocoa shells, thereby producing roasted cocoa shells; and (d) grinding the roasted cocoa shells, thereby producing a ground cocoa shell composition, wherein the composition is effective as a substitute for dry cocoa solids. In some cases, step (a) comprises using a chemical solution comprising an acid (e.g., phosphoric acid, hydrochloric acid, sulfuric acid, acetic, adipic, citric, fumaric, lactic, malic, tartaric acids, glucono-delta-lactone, or a combination thereof), or a caustic agent (e.g., sodium hydroxide, potassium hydroxide, sodium carbonate, calcium carbonate, calcium hydroxide, potassium bicarbonate, iodine, or a combination thereof). In some cases, the cocoa shells are treated with the chemical solution at 60° C. to 150° C. (e.g., 75° C. to 100° C.) for 30 minutes to 2 hours, such that the treated cocoa shells have a pH of 2.0 to 4.5.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a representative chromatogram of a fermented and dried cocoa bean sample.

FIG. 2 is a representative chromatogram of a roasted cocoa bean sample.

FIG. 3 is a representative chromatogram of a dried cocoa shell sample.

FIG. 4 is a representative chromatogram of an acid hydrolyzed and roasted cocoa shell sample.

FIG. 5 is a representative chromatogram of a base hydrolyzed and roasted cocoa shell sample.

FIG. 6 is a representative chromatogram of a dutched special dark cocoa powder sample.

FIG. 7 is a representative chromatogram of a special dark cocoa powder sample.

FIG. 8 is a representative chromatogram of a dutched rouge cocoa powder sample.

FIG. 9 is a representative chromatogram of a dutched black cocoa powder sample.

FIG. 10 is a graphical representation of the results of sensory studies measuring perceived chocolate/cocoa flavor intensity for three cocoa shell chocolates (control cocoa shell chocolate made with untreated cocoa shells, a cocoa shell chocolate made with alkali hydrolyzed and roasted cocoa shells, and a cocoa shell chocolate made with phosphoric acid hydrolyzed and roasted cocoa shells) and a commercial semi-sweet chocolate. Upper case letters denote statistical significance at 95% confidence interval of mean difference between statistical groups A and B.

FIG. 11 shows particle size analysis results of a commercial 45% semi-sweet chocolate using an Anton Paar particle size analyzer.

FIG. 12 shows particle size analysis results of a cocoa shell chocolate made from untreated (control) cocoa shells using an Anton Paar particle size analyzer.

FIG. 13 shows particle size analysis results of cocoa shell chocolate made from alkali-hydrolyzed and heat-treated cocoa shells using an Anton Paar particle size analyzer.

FIG. 14 shows particle size analysis results of cocoa shell chocolate made from acid-hydrolyzed and heat-treated cocoa shells using Anton Paar particle size analyzer.

FIG. 15 is table showing particle size measurements of cocoa shell and cocoa pod chocolates produced with and without hydrolysis and/or roasting.

FIG. 16 is a list of identified compounds with retention time, retention index, and retention index for polar column from NIST library.

FIG. 17 is a table providing the peak area of compounds in cocoa samples. Bold compounds are reaction products of Maillard or caramelization with demonstrated increases in concentration with the pH treatment followed by a thermal roasting treatment in the cocoa shells.

FIG. 18 is a plot showing the relative amounts of 2,3,4-trimethyl-6-ethylpyrazine in cocoa shells hydrolyzed with phosphoric acid prior to roasting, cocoa shells hydrolyzed with sodium hydroxide prior to roasting, and dry roasted cocoa shells.

FIG. 19 is a plot showing the relative amounts of 2,3,5-trimethylpyrazine in cocoa shells hydrolyzed with phosphoric acid prior to roasting, cocoa shells hydrolyzed with sodium hydroxide prior to roasting, and dry roasted cocoa shells.

FIG. 20 is a plot showing the relative amounts of 2,3-dimethyl-5-ethylpyrazine in cocoa shells hydrolyzed with phosphoric acid prior to roasting, cocoa shells hydrolyzed with sodium hydroxide prior to roasting, and dry roasted cocoa shells.

FIG. 21 is a plot showing the relative amounts of 2,3-dimethylpyrazine in cocoa shells hydrolyzed with phosphoric acid prior to roasting, cocoa shells hydrolyzed with sodium hydroxide prior to roasting, and dry roasted cocoa shells.

FIG. 22 is a plot showing the relative amounts of 2,5-dimethylpyrazine in cocoa shells hydrolyzed with phosphoric acid prior to roasting, cocoa shells hydrolyzed with sodium hydroxide prior to roasting, and dry roasted cocoa shells.

FIG. 23 is a plot showing the relative amounts of 2-acetylpyrrole in cocoa shells hydrolyzed with phosphoric acid prior to roasting, cocoa shells hydrolyzed with sodium hydroxide prior to roasting, and dry roasted cocoa shells.

FIG. 24 is a plot showing the relative amounts of 2-methylbutanal in cocoa shells hydrolyzed with phosphoric acid prior to roasting, cocoa shells hydrolyzed with sodium hydroxide prior to roasting, and dry roasted cocoa shells.

FIG. 25 is a plot showing the relative amounts of 3-methylbutanal in cocoa shells hydrolyzed with phosphoric acid prior to roasting, cocoa shells hydrolyzed with sodium hydroxide prior to roasting, and dry roasted cocoa shells.

FIG. 26 is a plot showing the relative amounts of 3-ethyl-2,5-dimethylpyrazine in cocoa shells hydrolyzed with phosphoric acid prior to roasting, cocoa shells hydrolyzed with sodium hydroxide prior to roasting, and dry roasted cocoa shells.

FIG. 27 is a plot showing the relative amounts of 3-isopentyl-2,5-dimethyl-pyrazine in cocoa shells hydrolyzed with phosphoric acid prior to roasting, cocoa shells hydrolyzed with sodium hydroxide prior to roasting, and dry roasted cocoa shells.

FIG. 28 is a plot showing the relative amounts of tetramethylpyrazine in cocoa shells hydrolyzed with phosphoric acid prior to roasting, cocoa shells hydrolyzed with sodium hydroxide prior to roasting, and dry roasted cocoa shells.

### DETAILED DESCRIPTION

Cocoa pod husks and cocoa bean shells both have high percentages of fiber, and of that fiber content, a significant portion constitutes lignocellulosic biomass. Cocoa pod husks have upwards of 21% lignin on a dry weight basis along with further fiber sources of cellulose and hemicellulose at 26.2% and 12.8% respectively (Alemawor et al., Scientific Research and Essay, 4 (6):555-559, 2009). In general, lignins have low dietary value because of the very low digestibility of the material, and thus material with high lignin content is typically hard to utilize as animal feed, a common place for such waste to go in the food manufacturing cycle (Alemawor et al., supra). Rather, high-lignin content waste materials are primarily burned for energy instead of being utilized as value-added ingredients in food production (Cassoni et al., J Envir Man, 317:115258, 2022). The layered, composite structure of lignin, hemicellulose, and cellulose in lignocellulosic material can be very difficult to break down, even by microbial or enzymatic destruction (a characteristic referred to as “recalcitrance;” see, e.g., Clifford, Lesson 4.3: Pretreatment of Lignocellulosic Biomass, in Alternative Fuels from Biomass Sources (Course EGEE 439), Penn State University College of Earth and Mineral Sciences, 2023; available online at e-education.psu.edu/egee439/node/653). Multiple steps typically are required to fully access all parts of the complex cellulose-hemicellulose-lignin matrix structure.

A major issue with the fibers found in cocoa shells and cocoa pods is that they are difficult to physically break down in mechanical particle reduction processes, such as grinding (e.g., milling). Common grinders struggle to break the compact, dense structures of fibrous, proteinaceous plant substrates, which may become even more difficult to grind after the substrates have been roasted. Thus, such substrates are not fit to be used as ingredients in applications where the particle size of the substrate needs to be reduced. In many food applications, the substrate needs to be processed into fine particles that are undetectable by the human tongue and/or that are readily incorporated into food and beverage products (e.g., powdered drink mixes that dissolve into water, milk or other liquids without grittiness or discernible particles). Materials that are relatively easy to grind (high grindability) also tend to be more prone to breakage (high breakability), while materials that are tough and resistant to grinding (low grindability) also may tend to have low breakability, such that they are less likely to fracture or break under mechanical stress. Traditionally, this has been the case with cocoa shells and cocoa pods, which are lignocellulosic in nature.

Most chocolate manufacturers remove as much shell as possible from the cocoa beans since, as noted above, cocoa shells can be damaging to equipment used in chocolate manufacturing (e.g., stainless steel surfaces in refining equipment). In addition, insufficient or incomplete removal of the shell from the cocoa beans can result in inferior products that do not refine to desirable particle sizes similar to those of dry cocoa solids. Inexpensive chocolates may contain more shell in the formula to increase yield and reduce the cost of the final product, but this can cause damage to equipment and can result in a poorer quality chocolate with a sandier/grittier, more astringent mouthfeel due to the inability of roasted cocoa shells to be ground into a fine powder similar in particle size to that of dry cocoa solids.

Moreover, roasting cocoa shells and cocoa pods does not make them more friable (prone to breakage). Rather, roasting can render cocoa shells and pods even more resistant to breakdown through grinding or other mechanical processes (e.g., pulverization). This is because sugars, starches, and proteins bound in the lignocellulose can form a complex via bonds that make access to roasting precursor molecules such as sugars and amino acids difficult.

Some chocolate processers have resorted to employing a specialized grinder to grind cocoa shells, purportedly without causing equipment damage or producing high amounts of heat. However, this grinding equipment is relatively inaccessible and cost-prohibitive, making it an undesirable option for many producers. Others use specialty cryogenic milling that employs extremely cold air to freeze any oil or fat that has leached out of the product during milling, thus enabling the manufacturer to employ more intensive grinding to achieve smaller particle sizes. This process is also prohibitively expensive for almost all food manufacturers.

The methods provided herein can alleviate these issues, as they render cacao waste materials (e.g., cocoa shells and cocoa pods) readily grindable without the need for special equipment. Moreover, because cacao waste material has a high carbohydrate content, it has a lower cocoa butter content than, for example, cacao nibs (also referred to as “cocoa nibs” herein). The methods provided herein improve the grindability of cacao waste, such that a powder having a particle size that is equivalent to or even smaller than that of cocoa powder is generated. In addition, because of the lower cocoa butter content of cacao waste materials, there is no need to expeller press the cocoa butter out of the product before grinding to produce a powder. Grinding of cocoa nibs naturally produces cocoa butter, which requires processing steps to remove. Reduction or removal of cocoa butter is desirable, for example, for preparing products with fat systems that typically are not compatible with cocoa butter. Thus, the methods provided herein allow for improved functionality of products that do not utilize cocoa butter as the fat base. Fats that contain lauric fats for example, are not miscible with cocoa butter, which is a non-lauric fat system. Two incompatible fats, when mixed, can result in negative eutectic effects. Ground cacao waste materials produced according to the methods disclosed herein, however, do not appreciably contribute to negative eutectic effects when utilized in fat systems containing lauric fats. The lack of eutectic effects is beneficial for confectionery coatings, where softening or blooming would otherwise be a problem that affects product shelf life. Because of the lower fat and higher carbohydrate composition of cacao waste materials, these eutectic effects and fat incompatibility issues are averted, and the ground cacao waste materials can be utilized in consumable product applications where traditional cocoa nibs or cocoa liquor may not be as suitable.

This document provides materials and methods for processing cacao waste materials, e.g., cocoa shells and cocoa pod husks, and other lignocellulosic biomass from cacao fruit to produce ingredients that can be used (e.g., as a filler and/or to replace one or more traditional ingredients) in consumable food and beverage products. In some cases, for example, processed coffee shells or cocoa pods generated by the methods provided herein can be used in chocolate or coffee replacement beverages, cocoa-alternative products, fillers for chocolate and chocolate-alternative consumables, replacements for dry cocoa solids, fat-based spreads, and alternative plant-based foods. In general, the methods provided herein can include treating cocoa shells and/or cocoa pods (e.g., with alkali or acid hydrolysis and/or enzyme treatment) before or after they are further processed by optionally roasting and/or grinding, in order to facilitate further downstream processing and to produce ground products having desirable sensory characteristics. The methods provided herein for processing cocoa shells and/or cocoa pods successfully overcome technical challenges and increase the functional usability of these waste materials as value-added food ingredients and to improve the chemical profile of desired components. The methods provided herein can, for example, increase the availability of saccharides, peptides, and free amino acids to facilitate downstream reactions (e.g., Maillard reactions or Strecker degradations) that can impact the taste, aroma, and color of products based on cocoa shells or cocoa pods. The methods provided herein also address a long-standing need for process improvements to increase the breakability and thus, the grindability of cocoa shells and cocoa pods despite their complex lignocellulosic structure, which has resisted attempts to mill them to particle sizes similar to those achieved for dry cocoa solids obtained from milling cocoa nibs.

As used herein, the term “cocoa pod husks” refers to the outer layer of the entire cocoa pod that surrounds the interior beans and mucilage. In this disclosure, the cocoa pod husks will be referred to as cocoa pods, which refers to the outer layer and not the cacao pod in its entirety, which also includes pulp and other parts of the whole fruit. As used herein, the term “cocoa bean shells” refers to the thinner layer found around each individual bean. The cocoa bean shells are typically removed from the beans after the drying process during winnowing. In this disclosure, cocoa pod shells also are referred to as “cocoa shells.”

As used herein, the term “lignocellulose” refers to a component found in plant-based material made mainly of three types of carbon-based polymers: cellulose, hemicellulose, and lignin. Details about lignocellulose and its properties are described, for example, in Sanderson, Nature, 474:S12-S14, 2011.

When broken down, lignocellulosic plant materials such as cocoa shells or cocoa pods may yield useful components desirable in food products. For example, cellulose is a polymer of glucose. Hemicelluloses are polymers of various sizes that incorporate a range of different sugars, whereas lignin has a polymer backbone made from phenolic groups, which are ring-shaped, carbon-based structures. The glucose polymer chains in cellulose are largely insoluble and exist in crystalline microfibrils that make the sugars hard to reach. These cellulose microfibrils are attached to hemicellulose, which contains a variety of sugars, making it more complicated to convert to a single product such as ethanol. Surrounding all this is lignin, which protects the cellulose and hemicellulose. Lignin is a complex mass of polymers that are cross-linked to each other via strong bonds that make it difficult to break the lignin down.

As used herein, “roasting” refers to the process in which heat is applied to a food product, water is evaporated, and at least in some cases, nutritional and/or flavor profile changes, such as in the ratios of proteins, fats, fiber, and carbohydrates and/or the concentrations of flavor-providing compounds are observed. The heat applied can be convective (from air flow), conductive (from product contact), from radiation, from other applications of energy such as microwaves, or from any combination thereof. The roasting process typically includes an increase in product temperature up to 100° C. at atmospheric conditions to achieve changes in the product beyond standard dehydration. This temperature can facilitate water evaporation from the food product, thereby reducing the moisture content of the product. A further increase in product temperature above 100° C. (e.g., to about 125° C. or above, about 150° C. or above, about 175° C. or above, about 200° C. or above, or about 225° C. or above) then can be made. Once this stage is achieved, non-enzymatic browning reactions (e.g., Maillard browning, caramelization, and Strecker dehydration) begin to occur, and color, flavor, and physical changes typically are achieved. Moisture can continue to evaporate; generally, during this final step of the roasting process, moisture levels approach the theoretical level of 0% with increasing time and/or temperature, with moisture levels observed below 50%, below 20%, below 10%, below 5%, about 3%, below 3%, about 2%, below 2%, about 1%, or even below 1% w/w.

Roasting can enhance the sensory qualities (e.g., aromas, flavors, and/or appearance) of certain food products and their ingredients. Chocolate beans develop their characteristic aroma and flavor during roasting by undergoing chemical processes such as the Maillard reaction in which amino groups in proteins react with reducing sugars to form aroma and flavor compounds, Strecker degradations in which carbonyls react with amino acids to create valuable flavor and aroma producing aldehydes or ketones, and caramelization, which uses up remaining sugars in the coffee beans to create dark brown flavor producing compounds.

As used herein, the term “roastability” generally refers to the physical ease of roasting a product (e.g., whether the product is of an appropriate size for roasting), but “roastability” also can be used to describe products or conditions that are conducive to better roasting results. See, e.g., Jiang, “Flavor testing and more from the food technology side of peanut breeding,” available online at peanutgrower.com/feature/flavor-testing-and-more-from-the-food-technology-side-of-peanut-breeding/; and Hendrix et al., “Effect of kernel characteristics on color and flavor development during peanut roasting: Two years of data,” Meeting Abstract. Vol. 49, 2017, available online at ars.usda.gov/research/publications/publication/?seqNo115=340222. An increase in positive, desirable aspects of a product after roasting can be described to have higher “roastability.” Therefore, as used herein, the term “roastability” also can be linked to the quantity and concentration of volatile organic compounds that arise from Maillard reaction, Strecker degradation, and caramelization reactions that occur when roasting. See, Sucan and Weerasinghe, “Process and Reaction Flavors: An Overview,” Am Chem Soc, 2005.

The LAB color space is a color model that is designed to approximate human vision and perception. It consists of three components: L for lightness of color, A for the green-to-red axis, and B for the blue-to-yellow axis. The L value, which ranges from 0 to 100, represents the perceived lightness of the color. A value of 0 represents black, while a value of 100 represents white. The L value measures how dark or light a color appears, independent of its chromatic properties. This makes it a valuable tool in color analysis and color correction, as it allows for precise adjustments to the lightness of a color while keeping the color's perceived hue and saturation constant. In some cases, a product's roastability refers to a measure of the L value of a material (on a colorimeter), where a higher L value indicates a higher level of compounds associated with a browning reaction (e.g., the Maillard reaction, Strecker degradation, and/or caramelization reactions). Thus, a higher L value can serve as an analytical indicator of higher roastability of the treated ingredients.

In some cases, a Nix Colorimeter Pro 2, which is a device designed for color measurement and analysis, can be used to determine L values for roasted cocoa shells and/or cocoa pods (e.g., treated (chemically and/or enzymatically treated) and roasted cocoa shells and/or cocoa pods. In some cases, the roasted cocoa shells and/or cocoa pods are roasted to an internal temperature of about 140° C. to about 160° C., and then ground. In some cases, two (2) grams of ground and roasted cocoa shells and/or cocoa pods are placed on disposable sample containers. In some cases, color values are obtained three times per roast. In some cases, only the L value (of the LAB color scale values) is considered since the L value is commonly used to indicate the degree of roasting. A decrease in the L value is an indication of an increase in compounds that cause a browning reaction (e.g., Maillard, Strecker degradation, and/or caramelization), and also is an analytical indicator of higher roastability of the treated ingredients. When chemically treated (e.g., pH adjusted) and/or enzymatically treated ingredients were roasted in the same manner (i.e., for the same roast time and at the same temperature) and assessed using the LAB color scale, the L values, which indicate roast level, decreased significantly as compared to ingredients that were not pH adjusted and/or enzymatically treated.

As used herein, the term “breakability,” otherwise known as “friability,” refers to how easily an ingredient breaks under the application of force, as measured by TA.XT. The breakability (friability) of a plant material has been found to be a good predictor of its milling/grinding characteristics in downstream processing. Details regarding friability as a predictor of milling can be found, e.g., in Mestres et al., Cereal Chem., 72 (6):652-657, 1995.

The unavailability in cocoa shells and cocoa pods of “roasting precursors” (e.g., saccharides, peptides, and free amino acids) available for downstream reactions such as the Maillard reaction, Strecker degradation, and/or caramelization reaction that impact the taste, aroma, and color of products results in a limited amount of volatile organic compounds that are key for roasted products. Since these reaction precursors are tied-up, bound, or physically integrated within complex starches and proteins in the tough fibrous cocoa pods and hard cocoa shells, the precursors cannot be used as reagents for the Maillard, Strecker degradation and/or caramelization reactions.

As used herein, “wet milling” refers to milling solids in a liquid medium. For example, cocoa nibs can be milled to produce chocolate liquor, which consists of cocoa solids in a liquid cocoa butter base. As the nibs are milled, the cocoa butter forms a liquid medium for the cocoa solids. “Wet milling” also includes processing dry solid substrates to which a liquid substrate such as a fat or oil has been added. For example, an oil or fat can be added to a dry solid substrate that is generally free of fat, such as cocoa shells or cocoa pods, to produce a solid/liquid mixture that can be wet milled. Wet milling reduces the particle size of the solid substrate using equipment such as media milling (e.g., with a Ball mill, refiner conche or stone melanger). These processes require the material being refined/reduced in particle size to be in a liquid medium such as an oil or fat in order to prevent the milling machinery from breaking. In contrast, and as used herein, “dry milling” refers to reducing the particle size of items that are dry solids, in the absence of a liquid medium, which typically improves flow of the solids through the machinery and facilitates contact of the solids with the grinding surfaces of the mill. Examples of dry milling include, but are not limited to, spice grinding and hammermilling. Dry milling methods can be useful for rough grinding, pre-grinding that precedes grinding and milling to small particle sizes, and other applications where reduction to a particle size of about 200-300 microns or less is desired.

When using dry milling techniques, the relatively high-speed particle collisions in a grinding chamber, particularly when producing solids of smaller particle sizes (e.g., under about 200 microns) present a risk of clumping (also referred to as “agglomeration”), which can cause issues in processing if flow agents are not added. During dry milling of dry solids, the smallest particles can agglomerate together due to various forces, such as bonding forces between molecules of individual particles, electrostatic attraction when particles become oppositely charged due to friction between one another or equipment surfaces, or capillary forces in which moisture within the particles forms a liquid bridge and binds them together.

Dry milling generally does not reduce particle size as effectively as wet milling due to some of these agglomeration limitations. In contrast, wet milling allows for more particle size reduction, which can be advantageous in products such as chocolate, which, in order to have a smooth mouthfeel where the cocoa particles are not discernable by the human tongue, need a particle size below about 50 microns. Wet milling requires the addition of a fat or liquid, which can be desirable for the preparation of chocolates and filled chocolate consumables but would not be advantageous when preparing a final product in the form of a powder. The term “refining” is often used interchangeably with “milling,” but “refining” is used herein as a type of milling in chocolate processing to describe particle size reduction to size parameters typical of finished chocolates, e.g., about or below 100 microns, about or below 50 microns, about or below 30 microns, about or below 25 microns, about or below 20 microns, or about or below 15 microns.

Reducing fat in the solid substrate material can also be important for dry milling. Milling generates heat from the mechanical action of breaking ingredients into smaller particles. The heat, combined with the mechanical action itself breaking into plant structural walls creates a tendency for oil and/or fat to leach out of the product in a dry milling operation. The oily material can create further clumping issues in dry milling and can even clog the mill. This is exacerbated during high impact milling operations such as hammer milling because of the increased force exerted. That is also true for any reduction in particle size below 250 micrometers due to the small particle size. Thus, the success of dry milling is sensitive to oil content of the grinding material. Oil content at percentages higher than 10% can be detrimental to milling.

Cocoa shells, and particularly roasted cocoa shells, present milling challenges. Due to their abrasive nature, they typically are hard on milling equipment as compared to cocoa beans that are milled to produce standard cocoa liquor and dry cocoa solids, which already necessitate energy-intensive processing due to the significant portion of cocoa butter present in cocoa liquor.

In general, traditional cocoa powder is created with the following steps. First, the cocoa beans are roasted, and the shells are removed from the beans and the beans are cracked into nibs. Second, the cocoa nibs are roughly ground into a paste (referred to as “pre-grinding”) and then refined to a fine particle size (less than 100 microns). This is called “cocoa liquor.” Third, the liquor is pressed in a cocoa press to remove as much cocoa butter as possible from the liquor. The butter is separated from the cocoa solids—the cocoa liquor mixture typically begins with about 50-55% cocoa butter content and ends with about 8-20% cocoa butter content). Fourth, the cake from this pressing process is ground into a cocoa powder. There are some variations in the cocoa powder production process for color changes. For example, if a darker cocoa powder is desired, a Dutching process can be used in which the nibs or powder are alkalized slightly.

The process of making cocoa powder is quite energy intensive, and the grinding equipment required to grind the powder after cocoa butter pressing often requires a specialty air classifier mill with cooled air to prevent the cocoa butter remaining in the cocoa powder from melting and clumping in the mill. In contrast, once they are alkali or acid hydrolyzed and heat treated by roasting according to the methods described herein, cocoa shells are readily millable into a fine powder (without requiring specialty cooled air, for example) by virtue of their naturally lower fat composition compared to cocoa powder obtained from chocolate liquor.

The methods and materials provided herein can be used to enable crushing or grinding and reduction in particle size of cocoa shells and/or cocoa pods, which can improve the extractability of desired food components and/or enhance the roasted qualities of these cacao waste products. By hydrolyzing starches into smaller sugars and denaturing proteins into amino acid and peptides, desirable roasting precursors for Maillard, Strecker degradation, and caramelization reactions can be generated. When these hydrolyzed ingredients are roasted, the free precursors can react with one another to create volatile organic compounds that provide sensory qualities to roasted food products such as chocolate or coffee-alternatives, filled chocolates, powdered drinks, beverage concentrates, and nut or nut-alternative spreads.

Any form of cocoa shells and/or cocoa pods can be used in the methods provided herein. The cocoa shells and/or cocoa pods can be, for example, in raw form or in dried and/or roasted form, and they may have been physically broken into smaller pieces prior to processing according to the methods provided herein.

In general, the methods provided herein include treating cocoa shells and/or cocoa pods with one or more chemical agents to alter the pH and cause acid or base hydrolysis, and/or treating the cocoa shells and/or cocoa pods with one or more enzymes that can break down components of the plant material (e.g., proteins and/or fiber). Following such treatment, the cocoa shell and/or cocoa pod substrate can be processed by roasting, grinding, and/or any other appropriate steps.

As used herein, “Dutch process” or “dutching” or “dutched” refers to the treatment of chocolate with alkali, usually potassium carbonate. Cocoa beans have a pH of about 5.2. Treatment with alkali can raise the pH of the finished product and affect the flavor and color of the chocolate product. Alkaline solution is generally applied to the raw beans or nibs, but not to the liquor.

As used herein, “hydrolysis” refers to a chemical reaction in which compounds are broken down or cleaved into smaller constituents by the addition of water in acidic or alkaline conditions. The term also refers to enzymatic hydrolysis, whereby compounds are broken down into smaller constituents by the addition of a solution containing one or more enzymes (e.g., proteases or carbohydrases) that can break down carbohydrates and proteins into smaller units such as less complex starches or sugars, peptides, and/or amino acids. In acidic conditions, functional groups in carbohydrates and proteins are protonated. Water can bind to these functional groups, cleaving them from the macromolecule. In proteins, amino acids are cleaved, while in carbohydrates, sugars are cleaved. Acid, base, and enzymatic hydrolysis can all be used to release sugars from starch and amino acids from proteins. As used herein, the terms “base” and “basic” are used interchangeably with “alkali,” alkaline,” and “caustic.”

In the methods provided herein, the breakdown of fibrous cocoa shells and/or cocoa pods occurs without causing significant liquefaction that can result in complete disintegration of a solid plant material into a liquid matter, which would render the solid plant material unusable for most roasting processes.

In some cases, cacao waste material (e.g., cocoa shells and/or cocoa pods) can be treated with one or more chemical agents. Any appropriate chemical agent(s) can be used. Non-limiting examples of suitable agents include one or more acids (e.g., sulfuric acid, hydrochloric acid, phosphoric acid, lactic acid, citric acid, malic acid, acetic acid, fumaric acid, tartaric acid, nitric acid, and glucono-delta-lactone), caustic agents (e.g., bases such as sodium hydroxide, potassium hydroxide, lye, sodium carbonate, calcium carbonate, calcium hydroxide, or potassium bicarbonate), one or more oxidizing agents (e.g., hydrogen peroxide), and/or iodine. In some cases, a chemical solution (e.g., a solution containing any of the chemical agents described herein) is combined with a cacao waste material. One or more additional ingredients can be included in the reaction. In some cases, for example, one or more sugars, amino acids, transition/catalyst metals, and/or salts can be included in a reaction mixture that includes the cacao waste material and a chemical agent.

Any appropriate reaction conditions can be used when treating the cacao waste material with a chemical agent as described herein. For example, an acid solution can be combined with material in an amount sufficient to fully cover the material, such that as much of the cacao plant material as possible is in contact with the solution. Naturally acidic in nature, cocoa beans have a pH of about 5.2, so the usefulness of acid treatment of cocoa beans was unexpected.

In some embodiments of the methods provided herein, an acid solution is combined with a cacao waste material. In certain embodiments of the methods provided herein, an acid solution (e.g., 85 w/w % phosphoric acid) can be combined with a cacao waste material (e.g., cocoa shells and/or cocoa pods) in an amount sufficient to fully cover the material, such that as much of the cacao waste material as possible is in contact with the solution. In some cases, a solution of water and an acid (e.g., phosphoric acid, hydrochloric acid, or sulfuric acid) can be used, where the solution contains about 30% to about 99% (e.g., about 30% to about 40%, about 35% to about 45%, about 40% to about 50%, about 45% to about 55%, about 50% to about 60%, about 55% to about 65%, about 60% to about 70%, about 65% to about 75%, about 70% to about 80%, about 75% to about 85%, about 80% to about 90%, about 85% to about 95%, about 90% to about 99%, about 30%, about 35%, about 40%, about 45%, about 50%, about 55%, about 60%, about 65%, about 70%, about 75%, about 80%, about 85%, about 90%, about 95%, or about 99%) acid on a weight/weight basis.

In some cases, the acid solution can be heated to about 50° C. to about 100° C. (e.g., about 50° C. to about 60° C., about 55° C. to about 65° C., about 60° C. to about 70° C., about 65° C. to about 75° C., about 70° C. to about 80° C., about 75° C. to about 85° C., about 80° C. to about 90° C., about 85° C. to about 95° C., about 90° C. to about 100° C., about 60° C., about 65° C., about 70° C., about 75° C., about 80° C., about 85° C., about 90° C., about 95° C., or about 100° C.) before or while it is combined with cacao waste material.

In certain embodiments of the methods provided herein, a caustic solution can be combined with cacao waste material. For example, a caustic solution (e.g., 100 w/w % NaOH) can be combined with cacao waste material (e.g., cocoa shells and/or cocoa pods) in an amount sufficient to fully cover the material, such that as much of the cacao waste material as possible is in contact with the solution. In some cases, a solution of water and a caustic agent (e.g., sodium hydroxide, potassium hydroxide, lye, sodium carbonate, calcium carbonate, calcium hydroxide, or potassium bicarbonate) can be used, where the solution contains about 30% to about 99% (e.g., about 30% to about 40%, about 35% to about 45%, about 40% to about 50%, about 45% to about 55%, about 50% to about 60%, about 55% to about 65%, about 60% to about 70%, about 65% to about 75%, about 70% to about 80%, about 75% to about 85%, about 80% to about 90%, about 85% to about 95%, about 90% to about 99%, about 30%, about 35%, about 40%, about 45%, about 50%, about 55%, about 60%, about 65%, about 70%, about 75%, about 80%, about 85%, about 90%, about 95%, or about 99%) caustic/alkaline agent on a weight/weight basis.

In some cases, the caustic/alkaline solution can be heated to about 50° C. to about 100° C. (e.g., about 50° C. to about 60° C., about 55° C. to about 65° C., about 60° C. to about 70° C., about 65° C. to about 75° C., about 70° C. to about 80° C., about 75° C. to about 85° C., about 80° C. to about 90° C., about 85° C. to about 95° C., about 90° C. to about 100° C., about 60° C., about 65° C., about 70° C., about 75° C., about 80° C., about 85° C., about 90° C., about 95° C., or about 100° C.) before or while it is combined with cacao waste plant material.

Once combined, cacao waste material and one or more chemical and/or enzymatic agents can be incubated/contacted (e.g., with or without mixing) for any appropriate length of time. For example, a cacao waste material can be incubated with one or more chemical and/or enzymatic agents for about 10 minutes to about 3 hours (e.g., about 10 to about 15 minutes, about 15 to about 20 minutes, about 20 to about 30 minutes, about 30 to about 45 minutes, about 45 to about 60 minutes, about 60 to about 90 minutes, about 90 to about 120 minutes, about 120 to about 180 minutes, about 15 minutes, about 20 minutes, about 30 minutes, about 45 minutes, about 60 minutes, about 75 minutes, about 90 minutes, about 105 minutes, about 120 minutes, about 150 minutes, or about 180 minutes). In some embodiments, the cacao waste material can be incubated with one or more chemical and/or enzymatic agents for about 10 minutes to about 30 minutes, about 10 minutes to about 60 minutes, about 10 minutes to about 90 minutes, about 10 minutes to about 120 minutes, about 10 minutes to about 150 minutes, about 30 minutes to about 60 minutes, about 30 minutes to about 90 minutes, about 30 minutes to about 120 minutes, about 30 minutes to about 150 minutes, about 30 minutes to about 180 minutes, about 60 minutes to about 90 minutes, about 60 minutes to about 120 minutes, about 60 minutes to about 150 minutes, about 60 minutes to about 180 minutes, about 90 minutes to about 120 minutes, about 90 minutes to about 150 minutes, about 90 minutes to about 180 minutes, about 120 minutes to about 150 minutes, about 120 minutes to about 180 minutes, or about 150 minutes to about 180 minutes.

In some cases, the cacao waste material and one or more chemical and/or enzymatic agents can be incubated until a desired pH is reached. For example, where the one or more chemical agents include a base, a cacao waste material and the one or more chemical agents can be incubated or contacted until the pH of the material is about 6 to about 12.5 (e.g., about pH 6 to about pH 7, about pH 6.5 to about pH 7.5, about pH 7 to about pH 8, about pH 7.5 to about pH 8.5, pH 8 to about pH 9, pH 8.5 to about pH 9.5, about pH 9 to about pH 10, about pH 9.5 to about pH 10.5, about pH 10 to about pH 11, about pH 10, to about pH 11.5, about pH 11 to about pH 12, about pH 11.5 to about pH 12.5, about pH 12 to about pH 12.5, about pH 6 to about pH 10.5, or about pH 7 to about pH 11.5). In some cases, a cacao waste material and one or more basic chemical agents can be contacted or incubated until the pH of the cacao waste material is about pH 1 or more higher than the pH of cacao waste material that is untreated (e.g., the cacao waste material before it was treated). For example, from a starting pH of 5-6 for cocoa shells or cocoa pods, the method can include treating the shells or pods until the pH is about 6, about 6-7, or higher.

In certain embodiments, where the one or more chemical agents include an acid, a cacao waste material and one or more chemical reagents can be incubated or contacted until the pH of the material is about 1 to about 5 (e.g., about pH 1 to about pH 2, about pH 1.5 to about pH 2.5, pH 2 to about pH 3, pH 2.5 to about pH 3.5, about pH 3 to about pH 4, about pH 3.4 to about pH 4.5, about pH 4 to about pH 5, about pH 2, about pH 2.5, about pH 3, about pH 3.5, about pH 4, about pH 4.5, or about pH 5). In some cases, a cacao waste material and one or more acidic chemical agents can be contacted or incubated until the pH of the cacao waste material is about pH 1 or more lower than the pH of cacao waste material that is untreated (e.g., the cacao waste material before it was treated). For example, from a starting pH of 5-6 for cocoa shells or cocoa pods, the method can include treating the shells or pods until the pH is about 4-5, about 4, or lower.

In some cases, cacao waste material can be incubated or contacted with an acid or base solution for about 15 to about 60 minutes (e.g., about 15 to about 30 minutes, about 20 to about 40 minutes, about 30 to about 45 minutes, about 40 to about 60 minutes, about 45 to about 60 minutes, about 15 minutes, about 20 minutes, about 25 minutes, about 30 minutes, about 35 minutes, about 40 minutes, about 45 minutes, about 50 minutes, about 55 minutes, or about 60 minutes). In some cases, the cacao waste material can be incubated or contacted with an acid or caustic (e.g., base) solution at a temperature of about 50° C. to about 100° C. (e.g., about 50° C., about 50° C. to about 60° C., about 55° C. to about 65° C., about 60° C. to about 70° C., about 65° C. to about 75° C., about 70° C. to about 80° C., about 75° C. to about 85° C., about 80° C. to about 90° C., about 85° C. to about 95° C., about 90° C. to about 100° C., about 50° C., about 55° C., about 60° C., about 65° C., about 70° C., about 75° C., about 80° C., about 85° C., about 90° C., about 95° C., or about 100° C.).

After the cacao waste material has been treated for a suitable length of time or until a desired pH is reached, the material can be further processed in any appropriate manner. For example, the liquid solution can be removed from treated cocoa shells or cocoa pods (e.g., by straining the treated cocoa shells and/or pods from the liquid solution). The treated shells and/or pods can then be roasted to an appropriate temperature, ground to an appropriate particle size, and finished into a desired final solid, powder, or liquid product form, including but not limited to chocolate liquor, dry powder, and solid consumable product such as bar chocolate, spreads, and beverages.

In some cases, the treated cocoa shells or pods can be roasted to a temperature of about 135° C. to about 250° C. (e.g., about 135° C. to about 140° C., about 140° C. to about 145° C., about 145° C. to about 150° C., about 150° C. to about 155° C., about 155° C. to about 160° C., about 160° C. to about 165° C.). In some cases, for example, the treated cocoa shells or pods can be roasted to a temperature of about 165° C. to about 250° C. (e.g., about 165° C. to about 170° C., about 170° C. to about 175° C., about 175° C. to about 180° C., about 180° C. to about 185° C., about 185° C. to about 190° C., about 190° C. to about 195° C., about 195° C. to about 200° C., about 200° C. to about 205° C., about 205° C. to about 210° C., about 210° C. to about 215° C., about 215° C. to about 220° C., about 220° C. to about 225° C., about 185° C. to about 200° C., about 200° C. to about 225° C., or about 225° C. to about 250° C.). In some cases, the treated cocoa shells or pods are roasted to a temperature of about 135° C. to about 145° C., about 140° C. to about 150° C., about 145° C. to about 155° C., about 150° C. to about 160° C., about 155° C. to about 155° C., about 165° C. to about 175° C., about 170° C. to about 180° C., about 175° C. to about 185° C., about 180° C. to about 190° C., about 185° C. to about 195° C., about 190° C. to about 200° C., about 195° C. to about 205° C., about 200° C. to about 210° C., about 205° C. to about 215° C., about 210° C. to about 220° C., about 215° C. to about 225° C., about 220° C. to about 230° C., about 225° C. to about 235° C., about 230° C. to about 240° C., about 235° C. to about 245° C., or about 240° C. to about 250° C. In some cases, enzyme-treated cacao waste material is roasted to a temperature of about 135° C., about 140° C., about 145° C., about 150° C., about 155° C., about 160° C., about 165° C., about 170° C., about 175° C., about 180° C., about 185° C., about 190° C., about 195° C., about 200° C., about 205° C., about 210° C., about 215° C., about 220° C., about 225° C., about 230° C., about 235° C., about 240° C., about 235° C., or about 250° C.

In some cases, treated (e.g., chemically and/or enzymatically treated) cocoa shells and/or cocoa pods are roasted to an L value of about 10 to about 70. For example, treated (e.g., chemically and/or enzymatically treated) cocoa shells and/or cocoa pods can be roasted to an L value of about 10 to about 30, about 20 to about 50, about 30 to about 40, about 35 to about 45, about 40 to about 50, about 45 to about 55, about 50 to about 60, about 55 to about 65, or about 60 to about 70. As a reference, dark roasted cacao beans used to make traditional chocolate typically have an L value below about 60.

Any appropriate type of roaster can be used (e.g., an electric coffee roaster, a convective/conductive roaster, a drum roaster, a tangential roaster, or an impingement oven roaster).

Without being bound by a particular mechanism, chemical treatment to adjust the pH of the cocoa shells can break down the fiber in the cocoa shells so that the shells are easier to grind and wear on the grinding machinery is reduced. The treatment processes described herein result in beneficial physical and chemical effects on the cacao waste products. Physically, the temperature and pH changes can disrupt the higher-order structure of the plant cell walls, increasing the available surface area and enhancing chemical/enzyme penetration into the plant cell walls, resulting in mechanical size reduction and fiber liberation. Chemical effects include solubilization, depolymerization, and breaking of crosslinks between lignocellulosic macromolecules. Lignin can be “redistributed” into a solution through breakdown, and lignin and carbohydrates can be depolymerized or modified chemically. Once the treatment is complete, the resulting product can be roasted to dry the material, to create a more friable product for grinding, and/or to generate additional roasted notes from more freely available sugars post pH treatment.

As discussed in the Examples below, a fine powder can be produced from cocoa shells such that the powder has a neutral flavor without off-notes and with desired cocoa-style notes. In certain embodiments, ground cocoa shells and pods produced according to the methods described herein are suitable as chocolate bulking agents or fillers for chocolate or chocolate alternative consumables. For example, cacao shells can be separated from cocoa beans (a process referred to as “winnowing”), treated according to the processes described herein, dried, and milled, resulting in a fine powder that, when blended with chocolate ingredients and refined, yields consumables with a low particle size chocolate of about 20 microns or lower (e.g., about 17-23 microns, about 10-20 microns, about 10-15 microns, or about 15 microns in certain embodiments).

In some cases, cacao waste material (e.g., cocoa shells and/or cocoa pods) can be treated with one or more enzymes (e.g., one or more enzymes that can break components of the cacao material into smaller pieces). For example, one or more enzymes can be used to break down lignin, cellulose, and/or protein within cocoa shells and/or cocoa pods into dimers or monomers of protein and carbohydrate units (e.g., peptides and/or amino acids for proteins and simple sugars such as dextrose, fructose, galactose, or sucrose for carbohydrates). Any appropriate enzyme(s) can be used. Non-limiting examples of suitable enzymes include carbohydrases (e.g., amylase, α-amylase, β-amylase, lactase, sucrase, isomaltase, pectinase, cellulase, hemicellulase, xylanase, and/or tannase), proteases (e.g., bromelain, alkaline proteases, papain, and/or actinidin), and ligninase. In some cases, the plant material can be ground prior to being treated with one or more enzymes.

Enzyme treatment of cacao waste material (e.g., cocoa shells and/or cocoa pods) can be carried out under any appropriate conditions. In some cases, prior to grinding, cocoa shells or cocoa pods can be treated with a solution containing about 0.1% to about 10% enzyme (e.g., about 0.1% to about 0.5%, about 0.3% to about 0.6%, about 0.5% to about 1%, about 0.1% to about 0.3%, about 0.2% to about 0.4%, about 0.3% to about 0.5%, about 0.4% to about 0.6%, about 0.5% to about 0.7%, about 0.6% to about 0.8%, about 0.7% to about 1%, about 0.8% to about 1.2%, about 1% to about 2%, about 1.5% to about 2.5%, about 3% to about 4%, about 3.5% to about 4.5%, about 4% to about 5%, about 4.5% to about 5.5%, about 5% to about 6%, about 5.5% to about 6.5%, about 6% to about 7%, about 6.5% to about 7.5%, about 7% to about 8%, about 7.5% to about 8.5%, about 8% to about 9%, about 8.5% to about 9.5%, or about 9% to about 10%). In some cases, cocoa shells or cocoa pods can be treated with a solution containing one or more enzymes at a weight ratio of about 100:1 to about 10:1 shell/pod to enzyme (e.g. about 100:1 to about 80:1, about 100:1 to about 60:1, about 100:1 to about 40:1, about 100:1 to about 20:1, about 80:1 to about 60:1, about 80:1 to about 40:1, about 80:1 to about 20:1, about 80:1 to about 10:1, about 60:1 to about 40:1, about 60:1 to about 20:1, about 60:1 to about 10:1, about 40:1 to about 20:1, about 40:1 to about 10:1, or about 20:1 to about 10:1 shell/pod to enzyme). For example, prior to grinding, cocoa shells or cocoa pods can be treated with a solution containing about 0.1% to about 1% enzyme (e.g., about 0.1% to about 0.5%, about 0.3% to about 0.6%, about 0.5% to about 1%, about 0.1% to about 0.3%, about 0.2% to about 0.4%, about 0.3% to about 0.5%, about 0.4% to about 0.6%, about 0.5% to about 0.7%, about 0.6% to about 0.8%, about 0.7% to about 1%, about 0.1%, about 0.2%, about 0.3%, about 0.4%, about 0.5%, about 0.6%, about 0.7%, about 0.8%, about 0.9%, or about 1% enzyme) at a weight ratio of about 100:1 shell/pod to enzyme. In some cases, cocoa shells or cocoa pods can be treated with a solution containing about 0.1%, about 0.2%, about 0.3%, about 0.4%, about 0.5%, about 0.6%, about 0.7%, about 0.8%, about 0.9%, about 1%, about 1.5%, about 2%, about 2.5%, about 3%, about 3.5%, about 4%, about 4.5%, about 5%, about 6.5%, about 6%, about 6.5%, about 7%, about 7.5%, about 8%, about 8.5%, about 9%, about 9.5%, or about 10% enzyme.

A cacao waste material can be incubated with one or more enzymatic agents for about 10 minutes to about 3 hours (e.g., about 10 to about 15 minutes, about 15 to about 20 minutes, about 20 to about 30 minutes, about 30 to about 45 minutes, about 45 to about 60 minutes, about 60 to about 90 minutes, about 90 to about 120 minutes, about 120 to about 180 minutes, about 15 minutes, about 20 minutes, about 30 minutes, about 45 minutes, about 60 minutes, about 75 minutes, about 90 minutes, about 105 minutes, about 120 minutes, about 150 minutes, or about 180 minutes). In some embodiments, the cacao waste material can be incubated with one or more enzymatic agents for about 10 minutes to about 30 minutes, about 10 minutes to about 60 minutes, about 10 minutes to about 90 minutes, about 10 minutes to about 120 minutes, about 10 minutes to about 150 minutes, about 30 minutes to about 60 minutes, about 30 minutes to about 90 minutes, about 30 minutes to about 120 minutes, about 30 minutes to about 150 minutes, about 30 minutes to about 180 minutes, about 60 minutes to about 90 minutes, about 60 minutes to about 120 minutes, about 60 minutes to about 150 minutes, about 60 minutes to about 180 minutes, about 90 minutes to about 120 minutes, about 90 minutes to about 150 minutes, about 90 minutes to about 180 minutes, about 120 minutes to about 150 minutes, about 120 minutes to about 180 minutes, or about 150 minutes to about 180 minutes. In some cases, cacao waste material can be incubated or contacted with an enzyme solution for about 15 to about 60 minutes (e.g., about 15 to about 30 minutes, about 20 to about 40 minutes, about 30 to about 45 minutes, about 40 to about 60 minutes, about 45 to about 60 minutes, about 15 minutes, about 20 minutes, about 25 minutes, about 30 minutes, about 35 minutes, about 40 minutes, about 45 minutes, about 50 minutes, about 55 minutes, or about 60 minutes).

In some cases, cacao waste material can be incubated or contacted with an enzyme solution at a temperature of about 30° C. to about 80° C. (e.g., about 30° C. to about 40° C., about 35° C. to about 45° C., about 40° C. to about 50° C., about 45° C. to about 55° C., about 50° C. to about 60° C., about 55° C. to about 65° C., about 60° C. to about 70° C., about 65° C. to about 75° C., about 70° C. to about 80° C., about 30° C., about 35° C., about 40° C., about 45° C., about 50° C., about 55° C., about 60° C., about 65° C., about 70° C., about 75° C., or about 80° C.).

In some cases, cacao waste material can be incubated or contacted with an enzyme solution at a pH of about 7 to about 9 (e.g., about 7 to about 8, about 7.5 to about 8.5, about 8 to about 9, about 7 to about 7.5, about 7.5 to about 8, about 8 to about 8.5, about 8.5 to about 9, about 7, about 7.5, about 8, about 8.5, or about 9).

After treatment with one or more enzymes, the cacao waste material can be further processed in any appropriate manner. In some cases, for example, the enzyme solution can be removed from the cacao waste material, and the enzyme-treated cacao waste material can then be roasted to an appropriate temperature, ground to an appropriate particle size, and/or extracted. For example, enzyme-treated cocoa shells or pods can be roasted to a temperature of about 135° C. to about 250° C. (e.g., about 135° C. to about 140° C., about 140° C. to about 145° C., about 145° C. to about 150° C., about 150° C. to about 155° C., about 155° C. to about 160° C., about 160° C. to about 165° C.,about 165° C. to about 170° C., about 170° C. to about 175° C., about 175° C. to about 180° C., about 180° C. to about 185° C., about 185° C. to about 190° C., about 190° C. to about 195° C., about 195° C. to about 200° C., about 200° C. to about 205° C., about 205° C. to about 210° C., about 210° C. to about 215° C., about 215° C. to about 220° C., about 220° C. to about 225° C., about 185° C. to about 200° C., about 200° C. to about 225° C., or about 225° C. to about 250° C.). In some cases, the treated cocoa shells or pods are roasted to a temperature of about 135° C. to about 145° C., about 140° C. to about 150° C., about 145° C. to about 155° C., about 150° C. to about 160° C., about 155° C. to about 155° C., about 165° C. to about 175° C., about 170° C. to about 180° C., about 175° C. to about 185° C., about 180° C. to about 190° C., about 185° C. to about 195° C., about 190° C. to about 200° C., about 195° C. to about 205° C., about 200° C. to about 210° C., about 205° C. to about 215° C., about 210° C. to about 220° C., about 215° C. to about 225° C., about 220° C. to about 230° C., about 225° C. to about 235° C., about 230° C. to about 240° C., about 235° C. to about 245° C., or about 240° C. to about 250° C. In some cases, enzyme-treated cacao waste material can be roasted to a temperature of about 185° C. to about 225° C. (e.g., about 185° C. to about 190° C., about 190° C. to about 195° C., about 195° C. to about 200° C., about 200° C. to about 205° C., about 205° C. to about 210° C., about 210° C. to about 215° C., about 215° C. to about 220° C., about 220° C. to about 225° C., about 185° C. to about 200° C., or about 200° C. to about 225° C.). In some cases, enzyme-treated cacao waste material is roasted to a temperature of about 135° C., about 140° C., about 145° C., about 150° C., about 155° C., about 160° C., about 165° C., about 170° C., about 175° C., about 180° C., about 185° C., about 190° C., about 195° C., about 200° C., about 205° C., about 210° C., about 215° C., about 220° C., about 225° C., about 230° C., about 235° C., about 240° C., about 235° C., or about 250° C.

Any appropriate type of roaster can be used (e.g., an electric coffee roaster, a convective/conductive roaster, a drum roaster, a tangential roaster, or an impingement oven roaster).

In some cases, enzyme treatment can be repeated with the same enzyme or with a different enzyme. For example, a first enzymatic treatment can occur with a first enzyme or group (e.g., two or more) of enzymes, followed by a second enzymatic treatment with the same or different enzyme or group of enzymes.

In some cases, enzymatic treatment can be used in a process in conjunction with chemical treatment with an acid or base. For example, a chemical treatment of cocoa shells or cocoa pods (e.g., treatment with a caustic agent such as NaOH) can be followed by one or more enzymatic treatments with one or more enzymes such as a carbohydrase. In certain embodiments, the treatment can include an initial treatment with an acid solution to facilitate acid hydrolysis, followed by one or more enzymatic treatments to break down starches using one or more carbohydrases, followed by a second enzymatic treatment to break down proteins using one or more proteases. The caustic, acid, and enzymatic treatments can occur in series such that they are carried out one after another, and can occur before or after roasting the material that is treated or is to be treated.

In some cases, the cacao waste material such as cocoa shells or cocoa pods can be treated with one or more carbohydrases after acid hydrolysis. For example, the cacao waste material can be treated with α-amylase and/or β-amylase, either individually or in combination. α-Amylase hydrolyzes the internal α-1,4-glycosidic bonds within starch and glycogen, resulting in maltose, maltotriose, and dextrins. β-amylase acts on the non-reducing ends of starch and glycogen, breaking the terminal α-1,4-glycosidic bond to produce maltose. In some cases, α-amylase and/or β-amylase treatment can be followed by enzymatic treatment with lactase, sucrase, and/or isomaltase; these enzymes break down products generated by enzymatic treatment of the plant material with a-amylase and β-amylase. In some cases, the cacao waste material can be treated with one or more proteases after acid hydrolysis. Proteases, include, but are not limited to, bromelain, alkaline proteases, papain, and actinidin. In some cases, combinations of one or more carbohydrases and one or more proteases can be used simultaneously or in series. In some cases, a caustic treatment with a base can be followed by acid treatment of the cacao waste material, including but not limited to cocoa shells and/or cocoa pods. In some cases, the caustic treatment with a base can be followed by acid treatment, followed by enzymatic treatment with one or more enzymes such as carbohydrases and/or proteases.

In some cases, chemical treatment can include contacting cacao waste material with an acid treatment, followed by a caustic treatment, followed by enzymatic treatment with one or more enzymes including, but not limited to, one or more carbohydrases and/or proteases. In some cases, cacao waste material can be treated with an acid solution, either before or after roasting and/or before or after grinding the material into a paste. In some cases, cocoa shells and/or cocoa pods can be treated with one or more enzymes prior to extraction. In some cases, cocoa shells and/or cocoa pods can be treated with an acid, after which they can be roasted and ground, and then treated with one or more enzymes such as one or more carbohydrases and/or one or more proteases during extraction in water. In some cases, cacao waste material can be treated with an acid or base, followed by roasting and then treatment with one or more enzymes such as one or more carbohydrates and/or proteases before the material is ground.

In some cases, cocoa shells and/or cocoa pods can be enzymatically treated with one or more enzymes such as tannase, followed by a caustic treatment with a base. In some cases, cocoa shells and/or cocoa pods, which are rich in lignocellulose, lignins, hemicellulose and/or cellulose, can be treated with one or more enzymes such as one or more cellulases, ligninases, and/or hemicellulases before acid or caustic treatment. In some cases, cocoa shells and/or cocoa pods can be treated with one or more cellulases, ligninases, and/or hemicellulases before or after enzymatic treatment with one or more carbohydrases and/or proteases, where no caustic or acid treatment of the plant-based material is carried out prior to roasting. In some cases, cocoa shells and/or cocoa pods can be treated with one or more enzymes (e.g., one or more cellulases, ligninases, and/or hemicellulases) after roasting.

Chemically and/or enzyme treated cacao waste material can be ground to any appropriate particle size. For example, in some cases, enzyme treated and optionally roasted cocoa shells and/or cocoa pods can be ground to any appropriate particle size. In some cases, chemically treated and optionally roasted cocoa shells and/or cocoa pods are ground to any appropriate particle size. In some cases, chemically and enzyme treated and optionally roasted cocoa shells and/or cocoa pods are ground to any appropriate particle size. Any suitable equipment can be used to grind the treated cacao waste material (e.g., a wet mill, a crushing mill, a burr mill, an espresso grinder, a stone mill, a jet mill, a blade grinder, or a hammer mill).

In some cases, treated (e.g., enzyme treated and/or chemically treated) and optionally roasted cocoa shells and/or cocoa pods can be ground to a mean particle size from of about 0.1 mm to about 5 mm (e.g., about 0.1 mm to about 0.25 mm, about 0.1 mm to about 0.5 mm, about 0.25 mm to about 0.5 mm, about 0.25 mm to about 0.75 mm, about 0.5 mm to about 0.75 mm, about 0.5 mm to about 1 mm, about 0.75 mm to about 1.25 mm, about 1 mm to about 2 mm, about 1 mm to about 1.5 mm, about 1.25 mm to about 1.75 mm, about 1.5 mm to about 2 mm, about 2 mm to about 3 mm, about 2 mm to about 2.25 mm, about 2.25 mm to about 2.75 mm, about 2.5 mm to about 3 mm, about 3 mm to about 4 mm, about 3 mm to about 3.25 mm, about 3.25 mm to about 3.75 mm, about 3.5 mm to about 4 mm, about 4 mm to about 5 mm, about 4 mm to about 4.25 mm, about 4.25 mm to about 4.75 mm, or about 4.5 mm to about 5 mm). In some cases, treated and optionally roasted cocoa shells and/or cocoa pods are ground to a mean particle size of about 100 microns, about 125 microns, about 150 microns, about 175 microns, about 200 microns, about 225 microns, about 250 microns, about 275 microns, about 300 microns, about 350 microns, about 400 microns, about 450 microns, about 500 microns, about 550 microns, about 600 microns, about 700 microns, about 800 microns, about 900 microns, about 1 mm, about 1.5 mm, about 2 mm, about 2.5 mm, about 3 mm, about 3.5 mm, about 4 mm, about 4.5 mm, or about 5 mm.

In some cases, treated and optionally roasted cocoa shells and/or cocoa pods are ground to a mean particle size of less than about 300 microns (e.g., less than about 250 microns, less than about 200 microns, less than about 150 microns, less than about 100 microns, less than about 50 microns, or less than about 20 microns). In some cases, treated and optionally roasted cocoa shells and/or cocoa pods are ground to a mean particle size of about 10 microns to about 300 microns. For example, about 10 microns to about 50 microns, about 10 microns to about 100 microns, about 10 microns to about 150 microns, about 10 microns to about 200 microns, about 10 microns to about 250 microns, about 50 microns to about 100 microns, about 50 microns to about 150 microns, about 50 microns to about 200 microns, about 50 microns to about 250 microns, about 50 microns to about 300 microns, about 100 microns to about 150 microns, about 100 microns to about 200 microns, about 100 microns to about 250 microns, about 100 microns to about 300 microns, about 200 microns to about 250 microns, about 200 microns to about 300 microns, or about 250 microns to about 300 microns. In some cases, treated and optionally roasted cocoa shells and/or cocoa pods are ground to a mean particle size of about 10 to about 15 microns, about 10 to about 20 microns, about 15 to about 20 microns, about 15 to about 25 microns, about 17 to about 23 microns, or about 20 to about 25 microns. In some cases, treated and optionally roasted cocoa shells and/or cocoa pods are ground to a mean particle size of about 10 microns, about 15 microns, about 20 microns, about 25 microns, about 30 microns, about 40 microns, about 50 microns, about 60 microns, about 70 microns, about 80 microns, or about 90 microns.

Any appropriate type of method or instrument for measuring particle size can be used. For example, laser diffraction is an established method to measure particle sizes from the upper nanometer to the millimeter range. In some cases, different particle size analyzers (PSAs) can be used to determine the size of particles within different ranges. For example, the single-laser Anton Paar PSA 990 can measure a wide range, e.g., about 0.2 μm to 500 μm, of particle sizes. For an even wider range of particle sizes, other particle size analyzers can be used, such as the Anton Paar PSA 1090 and PSA 1190 with an optical design for diffraction analysis and which include multiple lasers. Anton Paar PSA 1090 has been designed with two lasers to resolve particles as small as 40 nanometers and Anton Paar PSA 1190 has an additional third laser to cover the full measurement range of up to 2.5 millimeters.

In some cases, a MALVERN® particle size analyzer (PSA) can be used to take particle size measurements of samples of materials of the present invention. In MALVERN® particle size analyzer, a laser beam passes through a dispersed sample, and the variation in angular scattered light intensity can be measured. Small particles have a small scattering angle, while large particles have a large scattering angle. The angular scattering intensity data is then analyzed to calculate the size of the particles that created the scattering pattern using the Mie theory of light scattering. The particle size can be reported as a volume equivalent sphere diameter.

In addition to laser diffraction, dynamic light scattering/laser diffraction (DLS/LD) can be used to measure particle sizes of ground cocoa shell and/or cocoa pod samples. Dynamic light scattering/laser diffraction is an alternative analytical method for measuring particle size. In this method, two complementary devices (dynamic light scattering; laser diffraction) produce a highly accurate reading. The method uses a very small amount of sample diluted in an exact manner via an automated instrument. Once the dilution is complete, a laser passes through the sample. Based on the diffraction pattern from the diluted material, the machine can provide an accurate measurement of the distribution of particle size. This method can be used on a chocolate or chocolate-like mass as well as a dry material because of the flexibility of the instrument.

In some cases, a dynamic light scattering/laser diffraction analysis can be obtained for detailed analysis of cocoa shell and/or cocoa pod samples or alternatively, of finished consumable products containing cocoa shell and/or cocoa pod ingredients prepared according to the methods of the present invention. For example, these instruments can be used to conduct particle size analysis of fully finished cocoa shell and/or pod chocolates or chocolate-like products prepared from treated (e.g., chemically and/or enzymatically treated), roasted, and ground cocoa shells and/or cocoa pods blended with other standard chocolate ingredients such as sugar and fat (e.g., cocoa butter, cocoa butter substitute, or cocoa butter equivalent) and other ingredients such as oilseed meal, and/or 0-1 wt % lecithin. The formula is blended together, e.g., mixed at 35° C. for 30 minutes, and ground to form the finished cocoa shell chocolate or cocoa pod chocolate. Oilseed meals, also commonly referred to as seed meals, are by-products from the production of oils consumed by humans. This group includes rapeseed meal, canola meal, cottonseed meal, flaxseed meal, sunflower meal, and camelina (wild flax) meal.

Particle size analysis of cocoa shell and/or cocoa pod liquor, (e.g., a cocoa shell and/or cocoa pod liquor prepared by milling cocoa shells and/or cocoa pods in the presence of a fat to create a fat/shell or fat/pod slurry) can also be made. Further, particle size analysis of a cocoa shell liquor or chocolate (and/or a cocoa pod liquor or chocolate) that is blended with up to about 75% by weight or more traditional chocolate can be made. In some cases, the cocoa shell liquor or chocolate (and/or a cocoa pod liquor or chocolate) is blended with up to about 75% by weight of 45% semi-sweet chocolate or 0-75 wt % cocoa solids, The appropriate sample of liquor or finished product can be taken and analyzed via light diffraction, DLS/LD, or any other particle size analysis method as exemplified above.

Provided herein are compositions (e.g., consumable products) including any of the chemically and/or enzymatically treated and optionally roasted and/or ground cacao waste products provided herein. Consumable products can include food products and beverage products. In some cases, ground particles of chemically and/or enzymatically treated and optionally roasted cocoa shells and/or cocoa pods can be used in consumable food and beverage products. For example, ground particles of the chemically and/or enzymatically treated and optionally roasted cacao waste products provided herein can be incorporated into a chocolate product (e.g., a semi-sweet, milk, or dark chocolate product), a chocolate-like product (e.g., a semi-sweet chocolate-like product, a milk chocolate-like product, or a dark chocolate-like product), or a powdered cocoa beverage.

In some cases, a consumable product includes ground particles of an acid-hydrolyzed or alkali-hydrolyzed and optionally roasted cacao waste material (e.g., cocoa shells and/or cocoa pods). For example, provided herein are consumable products comprising acid-hydrolyzed and roasted cacao waste material or alkali-hydrolyzed and roasted cacao waste material, wherein the cacao waste material comprises cocoa shells, cocoa pods, or cocoa shells and cocoa pods. In some cases, a consumable product includes ground particles of an enzymatically-treated and optionally roasted cacao waste material (e.g., cocoa shells and/or cocoa pods). In some cases, a consumable product includes ground particles of a combination of chemically treated and optionally roasted waste material (e.g., cocoa shells and/or cocoa pods) and enzymatically treated and optionally roasted waste material (e.g., cocoa shells and/or cocoa pods).

In some cases, a consumable food or beverage product can contain one or more ingredients in addition to the treated and ground cacao waste product. For example, a consumable food or beverage product can contain cocoa butter, granulated sugar, vanilla extract, soy lecithin, sunflower lecithin, an oilseed meal, and/or one or more fillers (e.g., a cocoa-free filler; see, e.g., PCT/US2023/027719). Oilseed meals, also commonly referred to as seed meals, are by-products from the production of oils consumed by humans. This group includes rapeseed meal, canola meal, cottonseed meal, flaxseed meal, sunflower meal, and camelina (wild flax) meal.

In some cases, a consumable food or beverage product can contain a filler that is a cocoa-free substitute for cocoa solids or a cocoa-free substitute for chocolate liquor. In some cases, the filler is the chemically and/or enzymatically treated, optionally roasted, and ground cacao waste product.

In some cases, a consumable food or beverage product includes about 0.01% to about 50% by weight of the treated and ground cacao waste product. For example, the consumable food or beverage product can include about 0.01% to about 40%, about 0.01% to about 35%, about 0.01% to about 30%, about 0.01% to about 20%, about 0.01% to about 25%, about 0.01% to about 10%, about 0.01% to about 15%, about 0.01% to about 5%, about 5% to about 50%, about 5% to about 45%, about 5% to about 40%, about 5% to about 35%, about 5% to about 30%, about 5% to about 25%, about 5% to about 20%, about 5% to about 15%, about 5% to about 10%, about 10% to about 50%, about 10% to about 45%, about 10% to about 40%, about 10% to about 35%, about 10% to about 30%, about 10% to about 35%, about 10% to about 20%, about 20% to about 50%, about 20% to about 45%, about 20% to about 40%, about 20% to about 35%, about 20% to about 30%, about 20% to about 25%, about 30% to about 50%, about 30% to about 45%, about 30% to about 40%, about 30% to about 35%, about 40% to about 50%, or about 40% to about 45% by weight of the treated and ground cacao waste product. In some cases, a consumable food or beverage product includes about 0.1%, about 1%, about 5%, about 10%, about 15%, about 20%, about 22.5%, about 25%, about 30%, about 35%, about 40%, about 45%, or about 50% by weight of the treated and ground cacao waste product.

In some cases, a consumable food or beverage product includes a fat. As used herein, a fat is an edible fat of animal or plant origin. Fats of animal origin include, but are not limited to, butter, tallow, duck fat, chicken fat, lard, and other fats that are solid at room temperature. A vegetable fat is a fat of plant origin, such as nuts, seeds, fruit, or other plant parts. Animal fats and vegetable fats are solid at room temperature and are referred to herein as “hardstock” fats. Hardstock vegetable fats include cocoa butter, cocoa butter replacements, cocoa butter substitutes, and cocoa butter equivalents (CBEs). Cocoa butter replacements, substitutes, and equivalents include, for example, other vegetable fat sources and hardstock fats (fats that are solid at room temperature). Examples of such vegetable fat sources and hardstock fats include, without limitation, shea, illipe, palm oil, sal (Shorea robusta), kokum gurgi (Garcinia indica), mango kernel (Mangifera indica), coconut, oil blends, fractionated oils, and/or interesterified oils. In some cases, a vegetable fat can include two or more hardstock fats blended together. For example, a vegetable fat can include a 50%:50% blend of palm oil:shea oil. In some cases, a vegetable fat can include one or more cocoa butter equivalents blended together with cocoa butter. For example, a vegetable fat can include a 75%:25% blend of palm oil:cocoa butter. A blend of one or more cocoa butter equivalents with cocoa butter can provide some of the flavor and aroma characteristics of cocoa butter without the expense of pure cocoa butter. In some cases, a vegetable fat can include one or more hardstock fats blended with one or more liquid vegetable oils to create a blended fat. For example, a vegetable fat can include a 75%:25% blend of palm oil:rapeseed oil. In some cases, a blend of a hardstock fat and an oil that is liquid at room temperature (“liquid oil”) can yield a blended product with some of the desired characteristics of a pure hardstock fat. Liquid oils include one or more liquid vegetable oils, including but not limited to, olive oil, avocado oil, peanut oil, sesame oil, canola oil, sunflower oil, soybean oil, rapeseed oil, corn oil, grapeseed oil, nut oils, walnut oil, almond oil, flaxseed oil, pumpkin seed oil, and hemp seed oil.

In some cases, a consumable food or beverage product includes about 20% to about 55% by weight fat (e.g., cocoa butter, cocoa butter equivalent, or cocoa butter substitute). For example, the consumable food or beverage product can include about 20% to about 25%, about 20% to about 30%, about 20% to about 35%, about 20% to about 40%, about 20% to about 45%, about 25% to about 30%, about 25% to about 35%, about 25% to about 40%, about 25% to about 45%, about 25% to about 50%, about 30% to about 35%, about 30% to about 40%, about 30% to about 45%, about 30% to about 50%, about 35% to about 40%, about 35% to about 45%, about 35% to about 50%, about 40% to about 45%, about 40% to about 50%, or about 45% to about 50% by weight fat (e.g., cocoa butter, cocoa butter equivalent, or cocoa butter substitute). In some cases, a consumable food or beverage product includes about 20%, about 22.5%, about 25%, about 30%, about 35%, about 40%, about 45%, about 50%, or about 55% by weight fat (e.g., cocoa butter, cocoa butter equivalent, or cocoa butter substitute).

In some cases, a consumable food or beverage product includes about 20% to about 60% by weight sugar. For example, the consumable food or beverage product can include about 20% to about 25%, about 20% to about 30%, about 20% to about 35%, about 20% to about 40%, about 20% to about 45%, about 20% to about 50%, about 20% to about 55%, about 25% to about 30%, about 25% to about 35%, about 25% to about 40%, about 25% to about 45%, about 25% to about 50%, about 25% to about 55%, about 25% to about 60%, about 30% to about 35%, about 30% to about 40%, about 30% to about 45%, about 30% to about 50%, about 30% to about 55%, about 30% to about 60%, about 35% to about 40%, about 35% to about 45%, about 35% to about 50%, about 35% to about 55%, about 35% to about 60%, about 40% to about 45%, about 40% to about 50%, or about 45% to about 50%, about 45% to about 55%, about 45% to about 60%, about 50% to about 55%, about 50% to about 60%, or about 55% to about 60% by weight sugar. In some cases, a consumable food or beverage product includes about 20%, about 25%, about 30%, about 35%, about 40%, about 45%, about 50%, about 55%, or about 60% by weight sugar.

In some cases, a consumable food or beverage product includes about 0.01% to about 50% by weight cocoa solids. For example, the consumable food or beverage product can include about 0.01% to about 40%, about 0.01% to about 35%, about 0.01% to about 30%, about 0.01% to about 20%, about 0.01% to about 25%, about 0.01% to about 10%, about 0.01% to about 15%, about 0.01% to about 5%, about 5% to about 50%, about 5% to about 45%, about 5% to about 40%, about 5% to about 35%, about 5% to about 30%, about 5% to about 25%, about 5% to about 20%, about 5% to about 15%, about 5% to about 10%, about 10% to about 50%, about 10% to about 45%, about 10% to about 40%, about 10% to about 35%, about 10% to about 30%, about 10% to about 35%, about 10% to about 20%, about 20% to about 50%, about 20% to about 45%, about 20% to about 40%, about 20% to about 35%, about 20% to about 30%, about 20% to about 25%, about 30% to about 50%, about 30% to about 45%, about 30% to about 40%, about 30% to about 35%, about 40% to about 50%, or about 40% to about 45% by weight of cocoa solids. In some cases, a consumable food or beverage product includes about 0.1%, about 1%, about 5%, about 10%, about 15%, about 20%, about 25%, about 30%, about 35%, about 40%, about 45%, or about 50% by weight cocoa solids.

In some cases, a consumable food or beverage product further includes vanilla extract and/or soy lecithin. In some cases, a consumable food or beverage product further includes vanilla extract and/or sunflower lecithin. In some cases, a consumable product further includes cocoa nibs, cocoa solids, dry cocoa powder, cocoa liquor, or a combination thereof.

In some cases, the treated and ground cacao waste material can be wet milled with one or more of: a fat, a liquid vegetable oil, a vegetable fat, cocoa butter, a cocoa butter equivalent and a cocoa butter substitute to produce a cocoa-free substitute for chocolate liquor.

In some cases, a consumable food or beverage product is a chocolate or chocolate-like product. In some cases, a consumable food or beverage product comprises or is a milk, semi-sweet, or dark chocolate or a milk, semi-sweet, or dark chocolate-like product.

In some cases, ground particles of chemically and/or enzymatically treated and optionally roasted cocoa shells and/or cocoa pods can be extracted in an aqueous solution (e.g., water), and the extract can be used in consumable food and beverage products. For example, a chemically and/or enzymatically treated, optionally roasted, and ground material can be combined with water at any appropriate temperature (e.g., about 50° C. to about 100° C., about 50° C. to about 75° C., about 60° C. to about 85° C., about 70° C. to about 90° C., or about 80° C. to about 100° C.) in any appropriate vessel (e.g., in a recirculating pot) for any appropriate length of time (e.g., about 5 to about 60 minutes, about 5 to about 45 minutes, about 10 to about 20 minutes, about 20 to about 30 minutes, about 30 to about 45 minutes, or about 45 to about 60 minutes). The chemically and/or enzymatically treated, optionally roasted, and ground cocoa shells and/or cocoa pods and the water can be combined in any appropriate relative amounts. For example, the chemically and/or enzymatically treated, optionally roasted, and ground plant material can be combined with water at about 3% w/w to about 50% w/w (e.g., about 3% w/w to about 5% w/w, about 3% w/w to about 10% w/w, about 5% w/w to about 10% w/w, about 5% w/w to about 15% w/w, about 10% w/w to about 20% w/w, about 15% w/w to about 25% w/w, about 20% w/w to about 30% w/w, about 25% w/w to about 35% w/w, about 30% w/w to about 40% w/w, about 35% w/w to about 45% w/w, or about 40% w/w to about 50% w/w) grounds to water. After extraction, the extract can be cooled and/or filtered, and then combined with other ingredients to generate a food or beverage product. In some cases, the extract can be further processed, such as by concentrating into a liquid concentrate or a soluble powder form, or the extract can be concentrated through evaporation and then spray dried to create a soluble solid (e.g., a water-soluble solid). In some cases, a portion of the water is removed by evaporation, freezing, and/or thawing of the extract to form a liquid concentrate.

In certain aspects, this document provides a powder concentrate. In some cases, most (e.g., more than 50%, more than 60%, more than 70%, more than 80%, more than 90%, or more than 95%) of the water can be removed from a concentrate (e.g., a liquid concentrate) to create a soluble powder that has from about 1% to about 10% moisture content (e.g., for beverage applications such as powdered chocolate milk, hot cocoa mix, or flavored drink powders) and dissolves readily in water, milk, or other beverage liquid substrates. In some cases, a soluble powder concentrate has a moisture content of about 0.1% to about 1%, about 0.1% to about 5%, about 1% to about 5%, about 3% to about 8%, or about 5% to about 10%.

Drying a concentrate into a powder can occur through any appropriate drying method, including but not limited to spray drying, freeze drying, and/or dehydrating. In some cases, one or more additional ingredients (e.g., maltodextrin, gum arabica, a flow agent, and/or an anti-caking agent such as tricalcium phosphate, powdered or microcrystalline cellulose, or magnesium stearate) can be added to a soluble powder prepared from a chemically and/or enzymatically treated, optionally roasted, and ground cacao waste material as described herein.

In some cases, the chemically and/or enzymatically treated, optionally roasted, and ground cacao waste product is in the form of a paste. In some cases, the chemically and/or enzymatically treated, optionally roasted, and ground cacao waste product is a chocolate-like liquor.

In some cases, the chemically and/or enzymatically treated, optionally roasted, and ground cacao waste product is in the form of a solid. In some cases, the chemically and/or enzymatically treated, optionally roasted, and ground cacao waste product is a substitute for cocoa nib solids or a substitute for dry cocoa solids.

In some cases, the chemically and/or enzymatically treated, optionally roasted, cacao waste product is in the form of a powder. For example, the chemically and/or enzymatically treated, optionally roasted, cacao waste product can be ground into a powder using power grinding or any other grinding equipment for grinding dry solids. In some cases, the chemically and/or enzymatically treated, optionally roasted, cacao waste product can be ground into a powder using a mechanical grinder, a power grinder, a crushing mill, a burr mill, an espresso grinder, a jet mill, a blade grinder, a vortex grinder, and/or a hammer mill.

In some cases, a consumable product is or includes one or more of a chocolate-like liquor, a substitute for cocoa nib solids, and a substitute for dry cocoa solids.

Any of the compositions provided herein can include one or more of a butanal, a pyrazine, and a pyrrole. For example, a composition provided herein can include a plant substrate, wherein the plant substrate comprises ground cocoa shells and/or ground cocoa pods, and one or more of 2-methylbutanal, 3-methylbutanal, 2,5-dimethylpyrazine, 2,3-dimethylpyrazine, 2,3,5-trimethylpyrazine, 3-ethyl-2,5-dimethylpyrazine, 2,3-dimethyl-5-ethylpyrazine, tetramethylpyrazine, 2,3,5-trimethyl-6-ethylpyrazine, 3-isopentyl-2,5-dimethyl-pyrazine, and 2-acetylpyrrole. In some cases, the ground cocoa shells and/or ground cocoa pods were hydrolyzed with an acid or a base prior to being ground.

### EXEMPLARY EMBODIMENTS

Embodiment 1 is a consumable product comprising an acid-hydrolyzed or alkali-hydrolyzed cacao waste material ground to an average particle size of less than about 300 microns.

Embodiment 2 is the consumable product of embodiment 1, wherein the cacao waste material comprises cocoa shells, cocoa pods, or cocoa shells and cocoa pods.

Embodiment 3 is the consumable product of embodiment 1 or 2, wherein the acid-hydrolyzed or alkali-hydrolyzed cacao waste material comprises acid-hydrolyzed and roasted cacao waste material or alkali-hydrolyzed and roasted cacao waste material.

Embodiment 4 is the consumable product of any one of embodiments 1 to 3, further comprising enzymatically-treated cacao waste material.

Embodiment 5 is the consumable product of any one of embodiments 1 to 4, wherein the average particle size is about 15 to about 300 microns, about 200 to about 300 microns, about 150 to about 200 microns, about 100 microns to about 150 microns, about 50 microns to about 100 microns, about 50 microns to about 75 microns, about 25 to about 50 microns, about 25 microns, about 20 microns, or less than about 20 microns.

Embodiment 6 is the consumable product of any one of embodiments 1 to 5, wherein the consumable product further comprises cocoa nibs, cocoa solids, dry cocoa powder, or cocoa liquor.

Embodiment 7 is the consumable product of any one of embodiments 1 to 6, wherein the consumable product is a chocolate or chocolate-like product comprising a milk, semi-sweet, or dark chocolate or a milk, semi-sweet, or dark chocolate-like product. Embodiment 8 is the consumable product of any one of embodiments 1 to 7, wherein the consumable product is a chocolate comprising semi-sweet chocolate, milk chocolate, or dark chocolate, and wherein the ground cacao waste material is a filler for the chocolate.

Embodiment 9 is the consumable product of any one of embodiments 1 to 8, wherein the consumable product is a chocolate comprising semi-sweet chocolate, milk chocolate, or dark chocolate, and wherein the consumable product further comprises one or more fillers.

Embodiment 10 is the consumable product of any one of embodiments 7 to 9, wherein the chocolate comprises cocoa nibs, cocoa solids, dry cocoa powder, or cocoa liquor.

Embodiment 11 is the consumable product of any one of embodiments 1 to 10, wherein the ground cacao waste material comprises a cocoa-free substitute for cocoa solids or a cocoa-free substitute for chocolate liquor.

Embodiment 12 is the consumable product of any one of embodiments 1 to 11, wherein the consumable product further comprises a chocolate-like product comprising a cocoa-free substitute for cocoa solids or a cocoa-free substitute for chocolate liquor. Embodiment 13 is the consumable product of any one of embodiments 1 to 12, wherein the consumable product comprises a chocolate or chocolate-like product that comprises: 0.01% to about 50% by weight of the ground cacao waste material; about 20% to about 55% by weight cocoa butter, cocoa butter equivalent, or cocoa butter substitute; about 20% to about 60% by weight sugar; and optionally, about 0.01% to about 50% by weight cocoa solids.

Embodiment 14 is the consumable product of any one of embodiments 1 to 13, wherein the consumable product comprises a chocolate or chocolate-like product that comprises: about 22.5% by weight of the ground cacao waste material; about 22.5% by weight cocoa butter, cocoa butter equivalent, or cocoa butter substitute; about 20 to about 60% by weight sugar; and optionally, about 0.01% to about 50% by weight cocoa solids.

Embodiment 15 is the consumable product of any one of embodiments 1 to 14, wherein the consumable product is a chocolate or chocolate-like product that further comprises sugar, vanilla extract, and/or soy lecithin.

Embodiment 16 is the consumable product of any one of embodiments 1 to 15, wherein the ground cacao waste material comprises about 50 wt % of the consumable product and wherein cocoa butter, a cocoa butter equivalent, or a cocoa butter substitute comprises about 50 wt % of the consumable product.

Embodiment 17 is the consumable product of any one of embodiments 1 to 12, wherein the consumable product is in the form of a powder.

Embodiment 18 is the consumable product of any one of embodiments 1 to 12 or 17, wherein the consumable product is a substitute for dry cocoa powder.

Embodiment 19 is the consumable product of any one of embodiments 1 to 16, wherein the consumable product is in the form of a paste.

Embodiment 20 is the consumable product of any one of embodiments 1 to 12, 16, or 19, wherein the consumable product is a chocolate-like liquor.

Embodiment 21 is the consumable product of any one of embodiments 1 to 20, wherein the product is a consumable food or beverage.

Embodiment 22 is the consumable product of any one of embodiments 1 to 21, wherein the acid-hydrolyzed cacao waste material has been hydrolyzed with an acid comprising sulfuric acid, hydrochloric acid, phosphoric acid, lactic acid, citric acid, malic acid, acetic acid, fumaric acid, tartaric acid, nitric acid, or glucono-delta-lactone.

Embodiment 23 is the consumable product of any one of embodiments 1 to 22, wherein the alkali-hydrolyzed cacao waste material has been hydrolyzed with an alkali comprising sodium hydroxide, potassium hydroxide, lye, sodium carbonate, calcium carbonate, calcium hydroxide, or potassium bicarbonate.

Embodiment 24 is a composition comprising ground cocoa shells or ground cocoa pods, and one or more of a butanal, a pyrazine, or a pyrrole.

Embodiment 25 is the composition of embodiment 24, wherein the ground cocoa shells or ground cocoa pods comprise acid-hydrolyzed and roasted cocoa shells or cocoa pods or alkali-hydrolyzed and roasted cocoa shells or cocoa pods.

Embodiment 26 is the composition of embodiment 24, wherein the ground cocoa shells or cocoa pods comprise acid-hydrolyzed cocoa shells or cocoa pods hydrolyzed with an acid comprising sulfuric acid, hydrochloric acid, phosphoric acid, lactic acid, citric acid, malic acid, acetic acid, fumaric acid, tartaric acid, nitric acid, or glucono-delta-lactone.

Embodiment 27 is the composition of embodiment 24, wherein the ground cocoa shells or cocoa pods comprise alkali-hydrolyzed cocoa shells or cocoa pods hydrolyzed with an alkali comprising sodium hydroxide, potassium hydroxide, lye, sodium carbonate, calcium carbonate, calcium hydroxide, or potassium bicarbonate.

Embodiment 28 is a composition comprising a plant substrate, wherein the plant substrate comprises ground cocoa shells and/or ground cocoa pods, wherein the ground cocoa shells and/or ground cocoa pods were hydrolyzed with an acid or a base prior to being ground, and wherein the composition comprises one or more of 2-methylbutanal, 3-methylbutanal, 2,5-dimethylpyrazine, 2,3-dimethylpyrazine, 2,3,5-trimethylpyrazine, 3-ethyl-2,5-dimethylpyrazine, 2,3-dimethyl-5-ethylpyrazine, tetramethylpyrazine, 2,3,5-trimethyl-6-ethylpyrazine, 3-isopentyl-2,5-dimethyl-pyrazine, and 2-acetylpyrrole.

Embodiment 29 is the composition of embodiment 28, wherein the acid comprises sulfuric acid, hydrochloric acid, phosphoric acid, lactic acid, citric acid, malic acid, acetic acid, fumaric acid, tartaric acid, nitric acid, or glucono-delta-lactone.

Embodiment 30 is the composition of embodiment 28, wherein the alkali comprises sodium hydroxide, potassium hydroxide, lye, sodium carbonate, calcium carbonate, calcium hydroxide, or potassium bicarbonate.

Embodiment 31 is a method for making a substitute for cocoa nib solids from cocoa shells or cocoa pods, wherein the method comprises: (a) treating a plurality of cocoa shell or cocoa pod fragments with a chemical solution and/or an enzymatic solution, thereby producing treated shell or pod fragments; (b) reducing the moisture content of the treated shell or pod fragments to about 3% w/w or less of the treated shell or pod fragments, thereby producing dried shell or pod fragments; (c) roasting the dried shell or pod fragments, thereby producing roasted shell or pod fragments; and (d) grinding the roasted shell or pod fragments, thereby producing a ground cocoa shell or ground cocoa pod composition, wherein the composition is effective as a substitute for cocoa nib solids.

Embodiment 32 is a method for making a substitute for chocolate liquor from cocoa shells or cocoa pods, wherein the method comprises: (a) treating a plurality of cocoa shell or cocoa pod fragments with a chemical solution and/or an enzymatic solution, thereby producing treated shell or pod fragments; (b) reducing the moisture content of the treated shell or pod fragments to about 3% w/w or less of the treated shell or pod fragments, thereby producing dried shell or pod fragments; (c) roasting the dried shell or pod fragments, thereby producing roasted shell or pod fragments; and (d) wet grinding the roasted shell or pod fragments in the presence of an oil or fat, thereby producing a ground cocoa shell or ground cocoa pod paste, wherein the paste is effective as a substitute for cocoa liquor.

Embodiment 33 is a method for making a chocolate containing a filler prepared from cocoa shell or cocoa pod fragments, wherein said method comprises: (a) treating a plurality of cocoa shell or cocoa pod fragments with a chemical solution and/or an enzymatic solution, thereby producing treated cocoa shell or cocoa pod fragments; (b) removing the treated cocoa shell or cocoa pod fragments from the chemical and/or enzymatic solution; (c) roasting the treated cocoa shell or cocoa pod fragments, thereby producing roasted cocoa shell or cocoa pod fragments; and (d) grinding the roasted cocoa shell or cocoa pod fragments, thereby producing a ground cocoa shell or ground cocoa pod composition, wherein the composition is used as all or a portion of the filler.

Embodiment 34 is the method of any one of embodiments 31 to 33, comprising treating the cocoa shell or cocoa pod fragments with a chemical solution comprising an acid or alkali solution for about 15 minutes to about 60 minutes, thereby producing acid-treated or alkali-treated cocoa shell or cocoa pod fragments.

Embodiment 35 is the method of embodiment 34, comprising treating the cocoa shell or cocoa pod fragments with the acid or alkali solution at a temperature of about 50° C. to about 100° C.

Embodiment 36 is the method of embodiment 34 or embodiment 35, comprising roasting the acid-treated or alkali-treated cocoa shell or cocoa pod fragments to a temperature of about 165° C. to about 250° C.

Embodiment 37 is the method of any one of embodiments 31 to 36, wherein the chemical solution comprises an acid comprising sulfuric acid, hydrochloric acid, phosphoric acid, lactic acid, citric acid, malic acid, acetic acid, fumaric acid, tartaric acid, nitric acid, or glucono-delta-lactone.

Embodiment 38 is the method of any one of embodiments 31 to 36, wherein the chemical solution comprises an alkali comprising sodium hydroxide, potassium hydroxide, lye, sodium carbonate, calcium carbonate, calcium hydroxide, or potassium bicarbonate.

Embodiment 39 is a composition comprising particles of a processed cacao waste product that has been (a) chemically or enzymatically treated and (b) ground, wherein the particles in the composition are less than 150 microns in size.

Embodiment 40 is the composition of embodiment 39, wherein the cacao waste product comprises cocoa shells.

Embodiment 41 is the composition of embodiment 39 or embodiment 40, wherein the cacao waste product comprises cocoa pods.

Embodiment 42 is the composition of any one of embodiments 39 to 41, wherein the particles are less than 100 microns in size.

Embodiment 43 is the composition of any one of embodiments 39 to 41, wherein the particles have an average particle size of about 15 microns to about 150 microns. Embodiment 44 is the composition of any one of embodiments 39 to 43, wherein the composition is a powder.

Embodiment 45 is the composition of any one of embodiments 39 to 43, wherein the composition is a paste.

Embodiment 46 is the composition of any one of embodiments 39 to 43 or 45, wherein the composition is a chocolate liquor.

Embodiment 47 is the composition of any one of embodiments 45 or 46, wherein about 50 wt % of the composition is the particles and about 50 wt % of the composition is cocoa butter.

Embodiment 48 is the composition of any one of embodiments 39 to 47, wherein the composition is a consumable food or beverage.

Embodiment 49 is a method for preparing a ground plant substrate from cacao waste material for use in a consumable food or beverage, wherein the method comprises: treating the cacao waste material with an acid in aqueous solution until the cacao waste material reaches a pH of about 2 to 6, thereby generating an acid-treated cacao waste material, roasting the acid-treated cacao waste material to generate a roasted, acid-treated cacao waste material, and grinding the roasted, acid-treated cacao waste material to yield the ground plant substrate.

Embodiment 50 is the method of embodiment 49, wherein the cocoa waste material comprises cocoa shells.

Embodiment 51 is the method of embodiment 49 or embodiment 50, wherein the cocoa waste material comprises cocoa pods.

Embodiment 52 is the method of any one of embodiments 49 to 51, wherein the acid comprises sulfuric acid, hydrochloric acid, phosphoric acid, lactic acid, citric acid, malic acid, acetic acid, fumaric acid, tartaric acid, nitric acid, or glucono-delta-lactone. Embodiment 53 is the method of any one of embodiments 49 to 52, comprising treating the cacao waste material until a pH of about 2.5 to about 4.5 is reached.

Embodiment 54 is the method of any one of embodiments 49 to 53, comprising treating the cacao waste material with the acid solution at a temperature of about 50° C. to about 100° C.

Embodiment 55 is the method of any one of embodiments 49 to 54, comprising treating the cacao waste material with the acid solution for about 10 minutes to about 3 hours.

Embodiment 56 is the method of any one of embodiments 49 to 54, comprising treating the cacao waste material with the acid solution for about 15 minutes to about 60 minutes.

Embodiment 57 is the method of any one of embodiments 49 to 56, comprising roasting the acid-treated plant material to a temperature of about 165° C. to about 250° C. Embodiment 58 is the method of any one of embodiments 49 to 57, comprising grinding the roasted, acid-treated plant material to an average particle size of about 15 microns to about 150 microns.

Embodiment 59 is the method of any one of embodiments 49 to 58, further comprising extracting the ground substrate with an aqueous solution to produce an extract.

Embodiment 60 is the method of embodiment 59, wherein the method comprises extracting the ground plant substrate with water at a temperature of about 60° C. to about 85° C.

Embodiment 61 is the method of embodiment 59 or embodiment 60, further comprising cooling the extract.

Embodiment 62 is the method of any one of embodiments 59 to 61, further comprising filtering the extract.

Embodiment 63 is the method of any one of embodiments 59 to 62, further comprising concentrating the extract to form a concentrate.

Embodiment 64 is the method of embodiment 63, wherein the method comprises concentrating the extract by removing at least some water from the extract.

Embodiment 65 is the method of embodiment 64, wherein a portion of the water is removed by evaporation, freezing, and/or thawing of the extract.

Embodiment 66 is the method of any one of embodiments 63 to 65, further comprising drying the concentrate to form a powder concentrate.

Embodiment 67 is the method of embodiment 66, wherein the drying comprises spray drying, freeze drying or dehydrating.

Embodiment 68 is the method of embodiment 66 or embodiment 67, wherein the concentrate comprises a soluble powder having a moisture content from about 1% w/w to about 10% w/w.

Embodiment 69 is the method of embodiment 68, wherein the soluble powder is water soluble.

Embodiment 70 is a composition comprising a ground plant substrate prepared using the method of any one of embodiments 49 to 69.

Embodiment 71 is the composition of embodiment 70, wherein the composition is a consumable food or beverage.

Embodiment 72 is a composition comprising an extract prepared using the method of any one of embodiments 59 to 62.

Embodiment 73 is a composition comprising a concentrate prepared using the method of any one of embodiments 63 to 69.

Embodiment 74 is a method for preparing a ground plant substrate from cacao waste material for use in a consumable food or beverage, wherein the method comprises: treating the cacao waste material with a base in aqueous solution until the cacao waste material reaches a pH of about 7 to 12.5, thereby generating a base-treated cacao waste material, roasting the base-treated cacao waste material to generate a roasted, base-treated cacao waste material, and grinding the roasted, base-treated cacao waste material to yield the ground plant substrate.

Embodiment 75 is the method of embodiment 74, wherein the cacao waste material comprises cocoa shells.

Embodiment 76 is the method of embodiment 74 or embodiment 75, wherein the cacao waste material comprises cocoa pods.

Embodiment 77 is the method of any one of embodiments 74 to 76, wherein the base comprises sodium hydroxide, potassium hydroxide, lye, sodium carbonate, calcium carbonate, calcium hydroxide, or potassium bicarbonate.

Embodiment 78 is the method of any one of embodiments 74 to 77, comprising treating the cacao waste material until a pH of about 6 to about 10.5 is reached.

Embodiment 79 is the method of any one of embodiments 74 to 78, comprising treating the cacao waste material with the base solution at a temperature of about 50° C. to about 100° C.

Embodiment 80 is the method of any one of embodiments 74 to 79, comprising treating the cacao waste material with the base solution for about 10 minutes to about 3 hours.

Embodiment 81 is the method of any one of embodiments 74 to 79, comprising treating the cacao waste material with the base solution for about 15 minutes to about 60 minutes.

Embodiment 82 is the method of any one of embodiments 74 to 81, comprising roasting the base-treated plant material to a temperature of about 165° C. to about 250° C. Embodiment 83 is the method of any one of embodiments 74 to 82, comprising grinding the roasted, base-treated plant material to an average particle size of about 15 microns to about 150 microns.

Embodiment 84 is the method of any one of embodiments 74 to 83, further comprising extracting the ground substrate with an aqueous solution to produce an extract.

Embodiment 85 is the method of embodiment 84, wherein the method comprises extracting the ground plant substrate with water at a temperature of about 60° C. to about 85° C.

Embodiment 86 is the method of embodiment 84 or embodiment 85, further comprising cooling the extract.

Embodiment 87 is the method of any one of embodiments 84 to 86, further comprising filtering the extract.

Embodiment 88 is the method of any one of embodiments 84 to 87, further comprising concentrating the extract to form a concentrate.

Embodiment 89 is the method of embodiment 88, wherein the method comprises concentrating the extract by removing at least some water from the extract.

Embodiment 90 is the method of embodiment 89, wherein a portion of the water is removed by evaporation, freezing, and/or thawing of the extract.

Embodiment 91 is the method of any one of embodiments 88 to 90, further comprising drying the concentrate to form a powder concentrate.

Embodiment 92 is the method of embodiment 91, wherein the drying comprises spray drying, freeze drying or dehydrating.

Embodiment 93 is the method of embodiment 91 or embodiment 92, wherein the concentrate comprises a soluble powder having a moisture content from about 1% w/w to about 10% w/w.

Embodiment 94 is the method of embodiment 93, wherein the soluble powder is water soluble.

Embodiment 95 is a composition comprising a ground plant substrate prepared using the method of any one of embodiments 74 to 94.

Embodiment 96 is the composition of embodiment 95, wherein the composition is a consumable food or beverage.

Embodiment 97 is a composition comprising an extract prepared using the method of any one of embodiments 84 to 87.

Embodiment 98 is a composition comprising a concentrate prepared using the method of any one of embodiments 88 to 94.

Embodiment 99 is a method for preparing a ground plant substrate from cacao waste material for use in a consumable food or beverage, wherein the method comprises: contacting the cacao waste material with an enzymatic solution containing one or more enzymes to generate an enzymatically-treated plant material, roasting the enzymatically-treated plant material to generate a roasted, enzymatically-treated plant material, and grinding the roasted, enzymatically-treated plant material to yield the ground plant substrate.

Embodiment 100 is the method of embodiment 99, wherein the cocoa waste material comprises cocoa shells.

Embodiment 101 is the method of embodiment 99 or embodiment 100, wherein the cocoa waste material comprises cocoa pods.

Embodiment 102 is the method of any one of embodiments 99 to 101, wherein the one or more enzymes comprise a carbohydrase, a protease, and/or a ligninase.

Embodiment 103 is the method of embodiment 102, wherein the one or more enzymes comprise at least one of amylase, a-amylase, β-amylase, lactase, sucrase, isomaltase, pectinase, cellulase, hemicellulase, xylanase, tannase, bromelain, an alkaline protease, papain, actinidin, and ligninase.

Embodiment 104 is the method of any one of embodiments 99 to 103, wherein the enzymatic solution comprises about 0.1% to about 1% enzyme.

Embodiment 105 is the method of any one of embodiments 99 to 104, comprising treating the cacao waste material with the enzymatic solution at a pH of about 7 to about 9.

Embodiment 106 is the method of any one of embodiments 99 to 105, comprising treating the cacao waste material with the acid solution at a temperature of about 30° C. to about 80° C.

Embodiment 107 is the method of any one of embodiments 99 to 106, comprising treating the cacao waste material with the enzymatic solution for about 15 minutes to about 60 minutes.

Embodiment 108 is the method of any one of embodiments 99 to 107, comprising roasting the acid-treated plant material to a temperature of about 165° C. to about 250° C.

Embodiment 109 is the method of any one of embodiments 99 to 108, comprising grinding the roasted, acid-treated plant material to an average particle size of about 100 microns to about 5 mm.

Embodiment 110 is the method of any one of embodiments 99 to 109, further comprising extracting the ground substrate with an aqueous solution to produce an extract.

Embodiment 111 is the method of embodiment 110, wherein the method comprises extracting the ground plant substrate with water at a temperature of about 60° C. to about 85° C.

Embodiment 112 is the method of embodiment 110 or embodiment 111, further comprising cooling the extract.

Embodiment 113 is the method of any one of embodiments 110 to 112, further comprising filtering the extract.

Embodiment 114 is the method of any one of embodiments 110 to 113, further comprising concentrating the extract to form a concentrate.

Embodiment 115 is the method of embodiment 114, wherein the method comprises concentrating the extract by removing at least some water from the extract. Embodiment 116 is the method of embodiment 115, wherein a portion of the water is removed by evaporation, freezing, and/or thawing of the extract.

Embodiment 117 is the method of any one of embodiments 114 to 116, further comprising drying the concentrate to form a powder concentrate.

Embodiment 118 is the method of embodiment 117, wherein the drying comprises spray drying, freeze drying or dehydrating.

Embodiment 119 is the method of embodiment 117 or embodiment 118, wherein the concentrate comprises a soluble powder having a moisture content from about 1% w/w to about 10% w/w.

Embodiment 120 is the method of embodiment 119, wherein the soluble powder is water soluble.

Embodiment 121 is a composition comprising a ground plant substrate prepared using the method of any one of embodiments 99 to 120.

Embodiment 122 is the composition of embodiment 121, wherein the composition is a consumable food or beverage.

Embodiment 123 is a composition comprising an extract prepared using the method of any one of embodiments 110 to 113.

Embodiment 124 is a composition comprising a concentrate prepared using the method of any one of embodiments 114 to 120.

Embodiment 125 is a method for making a substitute for dry cocoa solids from cocoa shells, wherein the method comprises: (a) treating a plurality of cocoa shells with a chemical solution, thereby producing treated cocoa shells; (b) reducing the moisture content of the treated shells to 25% w/w or less of the treated shells, thereby producing dried cocoa shells; (c) roasting the dried shells, thereby producing roasted cocoa shells; and (d) grinding the roasted cocoa shells, thereby producing a ground shell composition, wherein the composition is effective as a substitute for dry cocoa solids.

Embodiment 126 is the method of embodiment 125, wherein step (a) comprises using a chemical solution comprising an acid (e.g., phosphoric acid, hydrochloric acid, sulfuric acid, acetic, adipic, citric, fumaric, lactic, malic, tartaric acids, glucono-delta-lactone, or a combination thereof), or a caustic agent (e.g., sodium hydroxide, potassium hydroxide, sodium carbonate, calcium carbonate, calcium hydroxide, potassium bicarbonate, iodine, or a combination thereof).

Embodiment 126 is the method of any one of embodiments 125 or 126, wherein the cocoa shells are treated with the chemical solution at 60° C. to 150° C. (e.g., 75° C. to 100° C.) for 30 minutes to 2 hours, such that the treated shells have a pH of 2.0 to 4.5.

The invention will be further described in the following examples, which do not limit the scope of the invention described in the claims.

### EXAMPLES

Improved processability of cacao waste products that are otherwise difficult to grind down was observed with hydrolysis reactions controlled with acids and bases. Cacao waste products were reacted within a vessel under acidic or basic conditions within a wet, heated environment over time. The products were then dehydrated to an appropriate moisture content and roasted to increase powderizing and/or grindability in a chocolate liquor equivalent. The ground product (ground flour) was then added into a chocolate application at a maximum percentage of 22.5%. In the examples that follow, additional cocoa solids were added to achieve desired flavor characteristics along with a desired particle size. Based on the intended final percentage of cocoa solids, the amount of cocoa solids added was adjusted to achieve the desired flavor characteristics while still providing a desirable particle size.

TABLE 1
Dry solids content in cocoa shell chocolate v. semi-sweet chocolate

| | Dry solids content | | Total cocoa |
|---|---|---|---|
| | from cocoa shells | Dry | content |
| | (cocoa | cocoa | (i.e., fat + |
| Sample | shell powder) | solids | dry solids) |
| Gold Standard Semisweet | | 22.5% | 45% |
| Chocolate | | | |
| Control (no treatment) Cocoa | 22.5% | | 45% |
| Shell Chocolate* 24 hours | | | |
| melanging (stone wet milling) | | | |
| Alkali Hydrolysis and Roasted | 22.5% | | 45% |
| Cocoa Shell Chocolate | | | |
| Acid Hydrolysis and Roasted | 22.5% | | 45% |
| Cocoa Shell Chocolate | | | |

*Due to the much harder material of the untreated cocoa shells used to make the control cocoa shell chocolate, the material was wet milled (e.g., wet ground in a stone melanger) for 24 hours instead of the 18 hours used for the other chocolate formulation preparations. This was necessary to create a homogenous mixture of fine particle size. However, it demonstrates how much more difficult it is to grind untreated shells.

TABLE 1 above shows the dry solids composition of a standard 45% chocolate liquor semi-sweet chocolate and of cocoa shell chocolates made with untreated cocoa shells, cocoa shells treated with alkali hydrolysis and roasting, and cocoa shells treated with acid hydrolysis and roasting. The ground products were incorporated in two formats—a powderized form and a chocolate liquor form. The powderized form, which provided a complete or partial replacement for dry cocoa solids on a 1:1 weight basis, was introduced into chocolate with other ingredients such as sugar, vanilla, and lecithin. The average particle size of the product, a cocoa shell powder that is an alternative to dry cocoa solids, was measured using particle size measurement methods described herein to be about 220-250 microns, in some cases about 200 microns, or otherwise less than about 300 microns. Since the cocoa shell powder was made of pure cocoa shells, the nutritional profile of the product was the same as that of the starting cocoa shells, which are high in fiber content and low in fat content. No additional ingredients needed to be added to the powderized ingredient. In addition, cocoa shell liquor, produced by wet milling of cocoa shells in fat or oil, was prepared as a one-for-one replacement for chocolate liquor. Chocolate liquor is defined by the FDA Code of Federal Regulations, Title 21 as having 50-60% by weight cacao fat. The cacao waste product liquor was formulated with cacao-based fat (e.g., cocoa butter) or another confectionery fat such as a plant oil or hard stock fat, such that the fat content was 50-60% by weight total fat. The particle size of the liquor, reduced through wet milling and measured according to the particle size measurement methods described herein, was found to be about 25-45 microns. Of the 50-60% of total nutritional fats, the specific fat content and fatty acid profile were dependent on the confectionery fat selected for the liquor. The other 40-50% of the product had a nutritional content determined by the cocoa shell or pod from which it was made, and therefore had a high fiber content and, due to the processing methods disclosed herein, a high sugar content.

When the treated cocoa shells were added as the sole source of non-fat cocoa solids, the maximum amount added was 22.5% to be at parity with a semi-sweet chocolate. Semi-sweet chocolate contains about 45% chocolate liquor, and thus about 22.5% fats and about 22.5% non-fat cocoa solids. The treated cocoa shells produced according to the methods described herein contained mostly fiber and a negligible amount of fat, and thus a powdered form of the processed cocoa shells was found to be suitable as a one-for-one replacement for non-fat cocoa solids. Further, the treated cocoa shells were found to be suitable as a filler in a traditional chocolate product, such as a bulking agent for a 45% semi-sweet chocolate, where it was added in tandem with or instead of all or a portion of cocoa nib solids (e.g., in the form of cocoa powder and/or chocolate liquor) to improve processing performance, enhance flavor, lower average particle size, lower the cost of the finished chocolate product, or other utilities and functions served by fillers or bulking agents.

Cocoa shells, with their fibrous structure and relatively high lignin (lignocellulosic) content, are typically challenging to break down with traditional food processing methods. Studies were conducted to test the efficacy of enzyme breakdown as a pre-treatment for winnowed cocoa shells. Lignin swelling at higher pH along with caustic treatment, in combination with an enzyme treatment, showed higher grindability for every enzyme treatment tested as compared to control and also as compared to pH treatment alone. As described below, cocoa shells were subjected to various treatments and then ground in a stone melanger, demonstrating that the presently described treatment methods dramatically improved process efficiency, as the cocoa shells were more friable and more readily ground, without causing liquefaction such that the solid structure of the cocoa shell fragments were preserved to make them suitable for roasting and grinding.

The methods described herein provide improved processability of cacao waste products that are otherwise difficult to grind down for cocoa products (chocolate, cocoa powder, etc.) with hydrolysis reactions controlled with acids and bases. Cacao waste products were reacted within a vessel under acidic or basic conditions in a wet, heated environment over time. The products were then dehydrated to an appropriate moisture content and roasted to increase improved grindability in a chocolate liquor equivalent or powderizing.

Since cocoa beans are naturally acidic, with a pH of about 5.2, alkali treatment of cocoa beans through Dutch processing, typically with potassium carbonate, can result in a slight increase in the pH of cocoa nibs, and dutching is known to deepen the color and improve the flavor of the resulting dry cocoa solids. Although this might have indicated that cacao waste materials (e.g., cocoa shells and/or cocoa pods) would also benefit from an alkali process the extensive experimentation detailed in the examples below demonstrated that chemical treatment in alkaline and/or acidic conditions resulted in significant improvement of many characteristics of the cacao waste products, beyond any benefits conferred by a typical Dutch process. The caustic treatments used in the methods provided herein, including treatments with alkali chemical agents, conducted at an alkaline level (e.g., submersion in a sodium hydroxide bath at pH 10-12 and at an elevated temperature), served a fundamentally different purpose than the Dutch process, in which cocoa is washed in an alkaline solution of potassium carbonate to neutralize its mild acidity and bring it to a neutral pH of 7.

When compared with commercial chocolates, both dutched and non-dutched, the chocolate products prepared with cocoa shells and/or cocoa pods treated as described herein shared the hallmarks of high-quality cocoa bean-based chocolate in terms of particle size, flavor, color, and aroma. It was particularly surprising that cocoa shells, which are already naturally acidic (with a pH of about 5.8), when submerged in an acidic environment to undergo acidic hydrolysis, resulted in a cocoa shell chocolate product of intense chocolate flavor that was virtually indistinguishable from commercial “gold standard” semi-sweet chocolates in sensory testing. The intense chocolate flavor was particularly unexpected given that the chemical profiles of cocoa shell products prepared according to the methods described herein were fundamentally and markedly different from the chemical profiles of traditional semi-sweet 45 w/w % chocolates.

Even more surprising was that cocoa shell chocolates produced according to the methods provided herein possessed all of the hallmarks of a high-quality chocolate, refining down to a small particle size with complex depth of flavor, color, and odor associated with a traditional chocolate made with cocoa nibs, but displayed a chemical profile that was markedly different from that of a traditional chocolate. That is, the cocoa shell chocolate was fundamentally different on a chemical level, but was surprisingly experienced by the palate as a traditional chocolate, a highly complex product that includes thousands of compounds.

Exposure of food products to high heat (e.g., a temperature of about 100° C. or higher, such as about 140° C.) often causes oxidation of lipids present in the food, which can lower the nutritional value of the food products because healthy triglycerides that are present are broken down. Thermal degradation of lipids can start at about 140° C., or even at about 100° C. with prolonged exposure. In addition, oxidation of fat in food products can have deleterious effects on consumer health. Furthermore, exposure to high heat and the process of oxidation can have negative effects on flavor by creating off notes through rancidity. As a result of heat exposure, the shelf life due to flavor changes can be reduced. Heat also can change the ratio of insoluble to soluble fiber and can even lower the overall fiber content. Although in the context of chocolate, heat and roasting can improve flavor characteristics such as nuttiness, over-roasting can result in burnt, bitter, and flat flavors.

Exposure of cocoa pods and cocoa shells to heat (e.g., through roasting) can increase their hardness because of further complexation of their lignocellulosic contents while evaporating the water to levels below about 3%, which can make the cocoa pods and cocoa shells more difficult to break down with mechanical energy. This was demonstrated in the work described herein when pure roasting was used a treatment. Heat also can reduce levels of antioxidants that are typically present in cocoa-based ingredients. For example, cocoa shells, which are naturally high in antioxidants, can be used to increase levels of antioxidants in chocolate products that are lost during processing and for such applications, the cocoa shells are generally untreated so as to keep the levels of those antioxidant components as high as possible. Specialized grinding operations are generally used in these applications, but there is still increased wear and tear on the milling equipment.

As described in the Examples below, the heating process revealed an enhanced roastability of the chemically and/or enzymatically treated cocoa shell and cocoa pod products. In addition, as demonstrated in the Examples below, cocoa shells and cocoa pods treated according to the disclosed methods exhibited vastly improved “grinding efficiency”—the ability of cocoa shells or cocoa pods to be readily ground and/or milled into a fine particle size (e.g., less than about 100 microns, less than about 50 microns, less than about 20 microns, or even down to about 15 microns in certain production runs). Moreover, as described in the Examples below, a surprising effect of applying pH treatment to cacao waste materials was that it resulted in a more friable, functional product for grinding (thus enhancing grindability), and, in some cases, a higher percentage of dimers or monomers of carbohydrates.

### Example 1—Methods for Measuring Particle Size

Micrometer screw: To prepare the sample, an aliquot was diluted 1:1 with a neutral oil (e.g., sunflower oil) to break up agglomerates. The micrometer screw method utilized a measuring stage with a dial gauge. The dial of the dial gauge was turned until the measuring stage was pressed against the opposite side of the gauge. The distance between the two surfaces was measured precisely on the instrument, which indicated the size of the largest particle on the stage, reported in micrometers. Measurements were repeated and the average was taken to obtain a mean particle size.

Hegman gauge: A Hegman gauge (grindometer) was used to measure the mean particle size of wet material, such as roasted and milled wet cocoa shells or cocoa pods, cocoa liquor, cocoa shells or cocoa pods to which fat or liquid was added before wet milling into a paste, cocoa shells or cocoa pods to which fat or liquid was added after dry milling, filler made with cocoa shells or cocoa pods, control chocolate product, and chocolate with filler. To prepare the samples for the present studies, an aliquot was diluted 1:1 with a neutral oil (e.g., sunflower oil) to break up agglomerates. The grindometer had a base with grooves having heights that could be calibrated to the diameter of the particles. An aliquot of diluted material was poured into the grooves. Moving from the larger end to the smaller end (that is, from deeper to shallower grooves), the grindometer was pressed with a steel flat edge (a scraper) at a slight angle. Upon reaching the end of the gauge, a pattern in the grooves was observed. In particular, streaking indicated that the particle size was larger than the groove depth at that point. The groove location where the streaking initially formed indicated the high end of the distribution, and the point at which 50-75% of the surface streaking was observed indicated the average particle size. Thus, the grindometer provided an indication of particle size distribution in addition to average particle size.

RoTap: The Rotap instrument is a standard piece of equipment that uses dynamic sifting methods to measure the particle size distribution of powders. The instrument is a set of sieves (selected by the user for the expected particle size distribution) stacked from larger openings at the top to smaller openings at the bottom. The stack sits on a stage with an arm that sits on top of the stack. A measured amount of the material was placed in the top sieve. When the instrument was turned on, the Rotap proceeded to rotate the stack of sieves from the bottom while tapping the stack of sieves from the top. This action was continuously repeated, at the same force, for a set period of time (usually 30-60 seconds). This allowed the material to separate between the sieves by size, such that the particles fell through the stack of sieves until they were too big to fall through the next sieve. Once the action was complete, the sieves were weighed to determine the distribution of particle sizes from each sieve in the stack.

Particle Size Analyzer: A particle size analyzer (Anton Paar particle size analyzer PSA 990) was used to determine particle size distribution, and particle sizes at different percentiles were determined through a laser diffraction particle size analyzer. A laser diffraction particle size analyzer is typically suitable for detailed analysis of a small sample (˜0.25 g). A laser beam was first directed onto dispersed particles. The laser light is diffracted by the particles, and the corresponding diffraction pattern was detected and evaluated. The Anton Paar PSA 990 possesses high-resolution detectors to provide accurate and reproducible measuring signals that was used to calculate particle size distributions based on the Fraunhofer and Mie theories with full compliance with the ISO 13320 and USP standards. The single-laser PSA 990 covers a wide measuring range of 0.2 μm to 500 μm.

The Anton Paar PSA 990 particle size analyzer worked best for the 0.2 micron to 500 micron range for the most accurate readings. For the oil based liquor that was generated, an oil dispersant (e.g., sunflower oil) was used for most accurate results. The process and parameters for the particle size analysis were as follows:
1. The sunflower oil dispersant was heated to 25° C. to create a clear dispersant that did not interfere with laser diffraction with a cloudy nature. 500 mL was added to the analyzer and background was measured.
2. 50 mL of sunflower oil was mixed with a small amount of the melted cocoa shell liquor to dilute the product down to be added directly, dropwise into the particle size analyzer cell at an obscuration of 5 to 30%.
3. In order to prevent background bubbles, the material passed through a debubbling phase of pumping through the cell for five minutes.
4. After this phase, the material underwent sonication for two minutes to break up agglomerates.
5. The material was then equilibrated for five minutes to reduce inconsistencies in measurement readings.
6. The measurement was then taken with the Fraunhofer method during a period of 45 seconds. These measurements were taken in triplicate and the D(10), D(50), D(90), mean size and particle size distribution were collected.

### Example 2—Preparation of Consumables from Cacao Waste Products

Cacao waste product (cocoa shells or cocoa pods) in a dry state (below 10% moisture) was submerged in water at an elevated temperature from about 50 to about 100° C. In certain production runs, for example, the temperature was set at 75° C. Hydrolysis was initiated once the cacao waste product was submerged and brought up to the reaction temperature of about 50 to about 100° C. The cacao waste products were treated with acid or base hydrolysis. Depending on the amount and concentration strength of the acid or base added, the ratio of the acid/base to cacao waste product changed as the acid/base was taken up by the waste product, and was adjusted to achieve the final desired pH range (pH 2-4 for acid and pH 7-9 for alkali). Once hydrolysis was initiated, an elevated temperature of about 50 to about 100° C. was maintained for about 15 to 45 minutes with added stirring to distribute the acid or base evenly on the cacao waste substrate. After the cacao waste products underwent hydrolysis, the reaction was halted by dehydrating the reacted cacao waste products to a moisture content below about 20% over a period of about 8 to 25 hours at an elevated temperature between about 50° C. and about 70° C. Cocoa shells having a moisture content of about 20% moisture or below were then roasted at a temperature of about 140° C. to about 160° C. for about 15 to 45 minutes. During this time, residual moisture was driven from the cocoa shells and/or cocoa pods to reduce the moisture content below about 3%, to prevent seizing during the liquor making phase. It was found that if the moisture content was higher than about 3%, moisture interacted with the hydrophilic particles of the cacao waste and increased friction at the hydrophilic surface of the particles and the hydrophobic fat, which could have caused seizing of the system. The reduction of moisture also improved grindability of the cocoa shells and cocoa pods because the solids were less malleable and thus were more easily ground. However, without treatment, reduction in the moisture content increased hardness and thus resulted in cocoa solids that were more difficult to grind. The reduction in moisture content also reduced issues of microbial growth, so cacao waste products could be stored after roasting.

Cacao waste products from the roasting step were ground to a particle size of 350 μm or less (e.g., 150 μm or less) using a mill (e.g., a wet mill, a crushing mill, a burr mill, an espresso grinder, a stone mill, or a jet mill), and optionally were sifted to remove unwanted material. For dry milling, cacao waste products were added to a spice grinder and blended for 45 seconds. For wet milling, a fat or liquid oil (e.g., a vegetable fat such as cocoa butter or a cocoa butter equivalent) was added to the shells or pods pre-grinding, then ground to a paste. Fat was added in an amount of between about 30-60% by weight to the roasted cacao waste product, and the roasted cacao waste product was wet milled in the fat to produce wet milled cocoa shells or cocoa pods in a paste form. Wet milling was performed on a stone mill (e.g., stone melanger), a colloid mill, a blade mill, or a corundum mill. For liquor production, grinding efficiency for each product was tested in a melanger at full pressure for about 6 hours. Cacao waste products were made into a chocolate product according to the Food and Drug Administration Code of Federal Regulations Title 21 standard of identity for semisweet chocolate. Commercially available semi-sweet chocolate “gold standard” formulation consisted of cocoa liquor made of one-half dry cocoa solids and one-half fat ingredients, e.g., cocoa butter. Thus, in a commercial 45% semi-sweet chocolate that contained 45% chocolate liquor, half of that liquor (22.5% of the weight of the total semi-sweet chocolate) was cocoa butter and the other half of the cocoa liquor (22.5% of the weight of the total semi-sweet chocolate) was dry cocoa solids. As detailed in the examples below, cocoa shell chocolate was created that replicated the formulation of the traditional 45% semi-sweet chocolate, except that the dry cocoa solids were entirely replaced with chocolate shells such that the cocoa shell chocolate contained 22.5 wt % cocoa shells and no dry cocoa solids whatsoever. In these formulations, cocoa shell chocolate was made at a maximum percentage of about 22.5 wt %. The 22.5 wt % represented the percentage of non-fat cocoa solids that was replaced in the semisweet chocolate formula. This was determined based on the nutritional information of the control semisweet chocolate liquor used. The chocolate liquor used had 50% fat overall, and the other 50% was nonfat cocoa solids. Since 45% chocolate liquor was used, there was 22.5% non-fat cocoa solids present in the gold standard formula. The control and treatment samples were added at 22.5% to be a 100% replacement of non-fat cocoa solids. The other 22.5% in the formula was replaced with cocoa butter to provide an equivalent fat percentage as the chocolate liquor added in the gold standard formula.

The finished cocoa shell chocolate contained, in addition to the above cocoa shell solids, cocoa butter, granulated sugar, vanilla extract, and soy lecithin. The results of the tests described above were compared to the results for a similar semisweet formula using the standard of identity chocolate liquor. The chocolate ingredients were mixed together (all fat-based ingredients were melted) and then reduced in particle size in a melanger for a period of 8-24 hours to obtain a desired particle size of about 17 to 23 microns. In some cases, additional methods were used to achieve particle size reduction, viscosity adjustment, and flavor development included refiner-conching, three roll refining, and conching.

Cacao waste products were evaluated for grindability and flavor when compared to a standard chocolate prepared using cocoa shell or cocoa pod-based solids instead of dry cocoa solids or cocoa liquor but otherwise identical ingredients. Particle size analysis was conducted with a micrometer as well as a particle size analyzer, which showed discreet differences based on particle size distribution using the more discerning laser diffraction technique. Observable differences such as the time required to refine to the designated particle size were determined for the treatments.

### Example 3—Manufacture of Cocoa Shell Chocolate Product

1. Cocoa shells in a dry state (having a moisture level of about or below 10%) were submerged in water at a temperature of 75° C.
2. Hydrolysis was initiated with the addition of acid or alkali once the cacao waste material was submerged and brought up to the reaction temperature. For each run, the cocoa shells were subjected to either acid or base hydrolysis.
   a. For acid hydrolysis, the ratio of acid solution to the cacao waste material was adjusted to achieve a final desired pH of the solution in the range of 2-4.
   b. For alkali hydrolysis, the ratio of base solution to the cacao waste material was adjusted to achieve a final desired pH of the solution in the range of 7-9.
3. Once hydrolysis was initiated, a temperature of 75° C. was maintained for 30 minutes with stirring to distribute the acid or base evenly on the cacao waste substrate.
4. The next step was dehydration of the reacted cacao waste products to a moisture content below 20% over a period of 8 to 25 hours at a temperature between 50° C. and 70° C.
5. The dehydrated cocoa shells were roasted at a temperature between 14° and 160° C. for 15 to 45 minutes to reduce the moisture content below 1%.
6. Cocoa shells were subjected to particle size reduction processing in which cocoa shells from the previous roasting step were ground to a particle size of 350 μm or less using a mill (e.g., a wet mill, a crushing mill, a burr mill, an espresso grinder, a stone mill, or a jet mill). A variety of dry and wet mills were utilized for different runs.
7. When wet milling was utilized, a fat or liquid oil (e.g., a vegetable fat such as cocoa butter or a cocoa butter equivalent) was added to the shells pre-grinding, (e.g., to the roasted cocoa shells) and the combination was ground to a paste. The fat or liquid oil was added to the roasted cocoa shells in an amount of about 30-60% by weight, and the roasted cocoa shells were wet milled in the fat to produce a wet milled cocoa shell in a paste form. For example, wet milling was performed on a stone mill (e.g., stone melanger), a colloid mill, a blade mill, or a corundum mill to form a milled chocolate shell liquor.
8. The milled chocolate shell liquor product was then combined with other ingredients to create a chocolate formula with guidance from the Food and Drug Administration Code of Federal Regulations Title 21 standard of identity for semisweet chocolate (formula below). The milled chocolate shell liquor was introduced at a maximum percentage of 22.5 wt % with other ingredients (e.g., cocoa butter, granulated sugar, vanilla extract, and soy lecithin).
9. The chocolate ingredients were mixed together, and all fat-based ingredients were melted to 40-50° C.
10. The ingredients were added to a melanger and were processed for a period of 8-24 hours to obtain a desired particle size of 17-23 microns. Additional processing steps used to achieve particle size reduction, viscosity adjustment, and flavor development included refiner-conche, three roll refining, and conching, and were optionally utilized in one or more production runs.
11. For tasting evaluation purposes, the finished product (cocoa shell chocolate), was tempered to 31-32° C. to achieve a fat crystallization structure that is typical of commercial chocolate eaten by consumers.

### Example 4—Manufacture of Cocoa Pod Chocolate Product

1. Cocoa pods in a dry state (below 10% moisture) were submerged in water at a temperature of 75° C.
2. Hydrolysis was initiated with the addition of acid or alkali once the cacao waste material was submerged and brought up to the reaction temperature.
   a. For acid hydrolysis, cocoa pods were treated with acid to achieve a final pH of about 2-4.
   b. For alkali hydrolysis, cocoa pods were treated with alkali to achieve a final pH of about 7-9.
3. Once hydrolysis was initiated, an elevated temperature (75° C.) was maintained for 30 minutes with stirring to distribute the acid or base evenly on the cacao waste substrate.
4. The next step was dehydration of the reacted cocoa pods to a moisture content below 20% over a period of 8 to 25 hours, at a temperature of 50° C. to 70° C.
5. The dehydrated cocoa pods were roasted at a temperature between 14° and 160° C. for 15 to 45 minutes to reduce the moisture content below 1%.
6. Cocoa pods from the roasting step were ground to a particle size of 350 μm or less using a mill (e.g., a wet mill, a crushing mill, a burr mill, an espresso grinder, a stone mill, or a jet mill). A variety of dry and wet mills were utilized for different runs.
7. The product was sifted to remove unwanted material (e.g., cocoa pod stems, which are more prevalent when processing cocoa pods compared with cocoa shells).
8. When wet milling was utilized, a fat or liquid oil (e.g., a vegetable fat such as cocoa butter or a cocoa butter equivalent) was added to the cocoa pods pre-grinding (e.g., to the roasted cocoa pods), and the cocoa pods were then ground to a paste. The fat or liquid oil was added to the roasted cocoa pods at an amount of 30-60% by weight, and the pods were wet milled in the fat to produce wet milled cocoa pods in a paste form. Wet milling was performed on a stone mill (e.g., stone melanger), a colloid mill, a blade mill, or a corundum mill to form a milled chocolate pod liquor.
9. The milled chocolate pod liquor product was incorporated with other ingredients to generate a chocolate formula with guidance from the Food and Drug Administration Code of Federal Regulations Title 21 standard of identity for semisweet chocolate (formula below). The milled chocolate pod liquor was introduced at a maximum percentage of 22.5 wt % with the addition of other ingredients (e.g., cocoa butter, granulated sugar, vanilla extract, and soy lecithin).
10. The chocolate ingredients were mixed together and all fat-based ingredients were melted at a temperature of 40-50° C.
11. The ingredients were processed in a melanger for a period of 8-24 hours to obtain a desired particle size of 17-23 microns. Additional processing steps used to achieve further particle size reduction, viscosity adjustment, and flavor development included refiner-conche, three roll refining, and conching, and were optionally utilized in one or more production runs.
12. For tasting evaluation purposes, the finished product was tempered to 31-32° C. to achieve a fat crystallization structure that is typical of commercial chocolate eaten by consumers.

### Example 5—Manufacture of Dry Cocoa Solids Replacement from Cocoa Shells

1. Cocoa shells in a dry state (having a moisture content below 10%) were submerged in water at a temperature of 75° C.
2. Hydrolysis was initiated with the addition of acid or alkali once the cacao waste material was submerged and brought up to the reaction temperature.
   a. For acid hydrolysis, the ratio of acid solution to the cacao waste material was adjusted to achieve a final desired pH of the solution in the range of 2-4.
   b. For alkali hydrolysis, the ratio of base solution to the cacao waste material was adjusted to achieve a final desired pH of the solution in the range of 7-9.
3. Once hydrolysis was initiated, a temperature of 75° C. was maintained for 30 minutes with stirring to distribute the acid or base evenly on the cocoa shell substrate.
4. The next step was to dehydrate the reacted cocoa shells to a moisture content below 20% over a period of 8 to 25 hours at a temperature of 50° C. to 70° C.
5. The dehydrated cocoa shells were roasted at a temperature of 140 to 160° C. for 15 to 45 minutes to reduce the moisture content below 1%.
6. The roasted cocoa shells were ground to a particle size of 350 μm or less using a mechanical grinder (a power grinder) for 45 seconds. Unlike wet milling, in which cacao waste products were ground into a wet paste in added fat or oil, dry grinding was utilized to pulverize the cocoa shells and generate a dry cocoa shell powder.
7. To create a cocoa shell chocolate from the milled cocoa shell powder, the powder was incorporated into a chocolate formula with guidance from the Food and Drug Administration Code of Federal Regulations Title 21 standard of identity for semisweet chocolate (formula below). Specifically, the dry cocoa shell powder was used to form a chocolate product at a maximum percentage of 22.5%. Additional ingredients were added, including cocoa butter, granulated sugar, vanilla extract, and soy lecithin.
8. The chocolate ingredients were mixed together (all fat-based ingredients were melted at 40-50° C.).
9. The chocolate ingredients were processed in a melanger for a period of 8-24 hours to reduce the particle size to 17-23 microns. Additional methods optionally used to achieve further particle size refinement, viscosity adjustment, and flavor development were refiner-conching, three roll refining, and conching.
10. For tasting evaluation purposes, the finished cocoa shell chocolate product was tempered to 31-32° C. to achieve a fat crystallization structure that is typical of commercial chocolate eaten by consumers.

### Example 6—Manufacture of Dry Cocoa Solids Replacement from Cocoa Pods

1. Cocoa pods in a dry state (below 10% moisture) were submerged in water at a temperature of 75° C.
2. Hydrolysis was initiated with the addition of acid or alkali once the cacao waste material was submerged and brought up to the reaction temperature.
   a. For acid hydrolysis, the ratio of acid solution to the cacao waste material was adjusted to achieve a final desired pH of the solution in the range of 2-4.
   b. For alkali hydrolysis, the ratio of base solution to the cacao waste material was adjusted to achieve a final desired pH of the solution in the range of 7-9.
3. Once hydrolysis was initiated, a temperature of 75° C. was maintained for 30 minutes with stirring to distribute the acid or base evenly on the cocoa pod substrate.
4. The next step was to dehydrate the reacted cocoa pods to a moisture content below 20% over a period of 8 to 25 hours at a temperature of 50° C. to 70° C.
5. The dehydrated cocoa pods were roasted at a temperature of 140 to 160° C. for 15 to 45 minutes to reduce the moisture content below 1%.
6. The roasted cocoa pods were ground to a particle size of 350 μm or less using a power grinder for 45 seconds.
7. The product was sifted to remove unwanted material, such as cocoa pod stems, which were more prevalent in the cocoa pod waste streams.
8. The milled powder product was then incorporated into a chocolate formula with guidance from the Food and Drug Administration Code of Federal Regulations Title 21 standard of identity for semisweet chocolate (formula below). The cocoa pod powder was introduced into the chocolate at a maximum percentage of 22.5%. Additional ingredients were cocoa butter, granulated sugar, vanilla extract, and soy lecithin.
9. The chocolate ingredients were mixed together and all fat-based ingredients were melted at 40-50° C.
10. The ingredients were processed in a melanger for a period of 8-24 hours to obtain a particle size of 17-23 microns. Additional methods optionally used to achieve further particle size refinement, viscosity adjustment, and/or flavor development were refiner-conche, three roll refining, and conching.
11. For tasting evaluation purposes, the finished product was tempered to 31-32° C. to achieve a fat crystallization structure that is typical of commercial chocolate eaten by consumers.

### Example 7—Manufacture of Chocolate Liquor Replacement from Cocoa Shells

1. Cocoa shells in a dry state (below 10% moisture) were submerged in water at a temperature of 75° C.
2. Hydrolysis was initiated with the addition of acid or alkali once the cacao waste material was submerged and brought up to the reaction temperature.
   a. For acid hydrolysis, the ratio of acid solution to the cacao waste material was adjusted to achieve a final pH of the solution in the range of 2-4.
   b. For alkali hydrolysis, the ratio of base solution to the cacao waste material was adjusted to achieve a final pH of the solution in the range of 7-9.
3. Once hydrolysis was initiated, an elevated temperature of 75° C. was maintained for 30 minutes with stirring to distribute the acid or base evenly on the cocoa shell substrate.
4. The next step was to dehydrate the reacted cocoa shells to a moisture content below 20% over a period of 8 to 25 hours at a temperature of 50° C. to 70° C.
5. The dehydrated cocoa shells were roasted at a temperature of 140 to 160° C. for 15 to 45 minutes to reduce the moisture content below 1%.
6. For wet milling, a fat or liquid oil (e.g., a vegetable fat such as cocoa butter or a cocoa butter equivalent) was added to the roasted cocoa shells in an amount of 30-60% by weight, and the shells were wet milled in the fat to produce a paste (cocoa shell liquor). Wet milling was performed on a stone mill (e.g., stone melanger), a colloid mill, a blade mill, or a corundum mill for 6 hours.
7. The milled product was then incorporated into a chocolate formula with guidance from the Food and Drug Administration Code of Federal Regulations Title 21 standard of identity for semisweet chocolate (formula below). The cocoa shell liquor was introduced into the chocolate at a maximum percentage of 22.5%. Additional ingredients included cocoa butter, granulated sugar, vanilla extract, and soy lecithin.
8. The chocolate ingredients were mixed together (all fat-based ingredients were melted at 40-50° C.).
9. The ingredients were processed in a melanger for a period of 8-24 hours to obtain a particle size of 17-23 microns. Additional methods optionally used to achieve particle size reduction, viscosity adjustment, and flavor development were refiner-conche, three roll refining, and conching.
10. For tasting evaluation, the finished product was tempered to 31-32° C. to achieve a fat crystallization structure that is typical of commercial chocolate eaten by consumers.

### Example 8—Manufacture of Chocolate Liquor Replacement from Cocoa Pods

1. Cocoa pods in a dry state (below 10% moisture) were submerged in water at a temperature of 75° C.
2. Hydrolysis was initiated with the addition of acid or alkali once the cacao waste material was submerged and brought up to the reaction temperature.
   a. For acid hydrolysis, the ratio of acid solution to the cacao waste material was adjusted to achieve a final desired pH of the solution in the range of 2-4.
   b. For alkali hydrolysis, the ratio of base solution to the cacao waste material was adjusted to achieve a final desired pH of the solution in the range of 7-9.
3. Once hydrolysis is initiated, a temperature of 75° C. was maintained for 30 minutes with stirring to distribute the acid or base evenly on the cacao waste substrate.
4. The next step was to dehydrate the reacted cocoa pods to a moisture content below 20% over a period of 8 to 25 hours at a temperature of 50° C. to 70° C.
5. The dehydrated cocoa pods were roasted at a temperature of 140 to 160° C. for 15 to 45 minutes to reduce the moisture content below 1%.
6. The roasted cocoa pods were ground to a particle size of 350 μm or less using a power grinder for 45 seconds.
7. The product was sifted to remove unwanted material (e.g., cocoa pod stems).
8. For wet milling, a fat or liquid oil (e.g., a vegetable fat such as cocoa butter or a cocoa butter equivalent) was added to the pods in an amount of 30-60% by weight, and the pods were wet milled in the fat to produce a paste (cocoa pod liquor). Wet milling was performed on a stone mill (e.g., stone melanger), a colloid mill, a blade mill, or a corundum mill for 6 hours.
9. The milled product was then incorporated into a chocolate formula with guidance from the Food and Drug Administration Code of Federal Regulations Title 21 standard of identity for semisweet chocolate (formula below). The cocoa pod liquor was introduced into the chocolate at a maximum percentage of 22.5%. Additional ingredients included contained cocoa butter, granulated sugar, vanilla extract, and soy lecithin.
10. The chocolate ingredients were mixed together (all fat-based ingredients were melted at 40-50° C.).
11. The ingredients were processed in a melanger for a period of 8-24 hours to obtain a particle size of 17-23 microns. Additional methods optionally used to achieve further particle size reduction, viscosity adjustment, and flavor development were refiner-conching, three roll refining, and conching.
12. For tasting evaluation, the finished product was tempered to 31-32° C. to achieve a fat crystallization structure that is typical of commercial chocolate eaten by consumers.

### Example 9—Effects of Hydrolysis and Heat treatment of Cocoa Shells and Pods

Cocoa shells and cocoa pods were subjected to acid or base hydrolysis with the application of heat treatment by submersion in an acid or base solution at an elevated temperature and then roasted to evaluate their characteristics. Hydrolysis agents were sodium hydroxide 100 w/w % as the base and phosphoric acid 85 w/w % as the acid. Experiments were conducted separately on cocoa shells and on cocoa pods. The shells or pods were subjected to hydrolysis for 30 minutes at a temperature of 75° C. Following treatment, they were roasted at a temperature of 160° C. for 45 minutes.

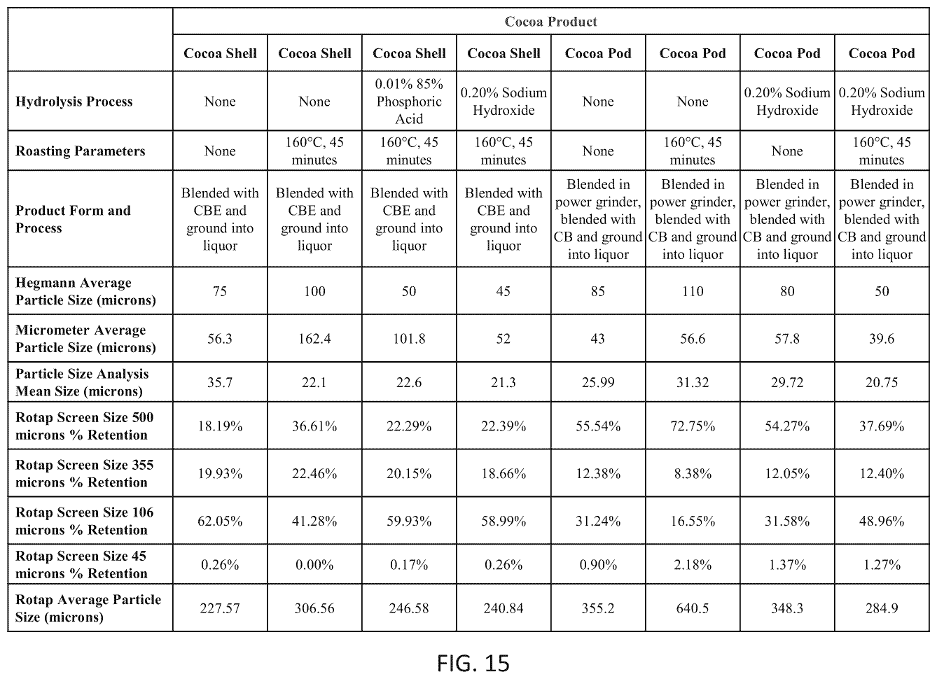

After processing of the shells and pods, their pH was assessed to determine the pH changes that occurred after the addition of the hydrolysis agents as compared to the original shells and pods. As shown in TABLE 2, for cocoa shells treated with phosphoric acid, there was minimal pH change in the final product; cocoa beans are acidic in nature and typically have a pH of about 5.2, and the pH of the treated cocoa shells was 5.3. The hydrolysis reaction still occurred, however, because there was a marked improvement in particle size reduction in shells subjected to the acid hydrolysis treatment (FIG. 15). For cocoa shells treated with alkali, there was an increase in the pH to about neutral (pH 7.23; TABLE 2). The fact that the pH increased slightly but did not increase to the pH of the original solution (pH 10-12) demonstrated that the shells were alkalized. In contrast, cocoa pods that underwent alkalinization had a high final pH, i.e., about 10, indicating that the alkalizing agent was not fully spent.

TABLE 2
Acid/Base hydrolysis of cocoa shell and cocoa pod batches

| | | pH of | pH of |
|---|---|---|---|
| Cacao Waste | | hydrolysis | final cacao |
| Material | Hydrolysis Process | solution | waste material |
| Cocoa Shell | None | 4.86 | 5.08 |
| Cocoa Shell | 0.01% 85% Phosphoric Acid | 1-2 | 5.30 |
| Cocoa Shell | 0.20% Sodium Hydroxide | 10-12 | 7.23 |
| Cocoa Pod | None | 5.05 | 5.45 |
| Cocoa Pod | 0.20% Sodium Hydroxide | 10-12 | 9.95-10.12 |

As shown in FIG. 15, a surprising compounding effect was observed when the high lignin cacao waste products were treated with acid or base at a temperature of 75° C. followed by roasting at a temperature of 160° C. In general, the addition of heat to an acid or base hydrolysis process can have detrimental effects that may hamper the hydrolysis process. Surprisingly, however, as shown in FIG. 15, cocoa shells that were hydrolyzed and subjected to heat treatment at roasting temperatures were able to be refined to a particle size much lower than that of untreated cacao waste material or cacao waste material that was subjected to hydrolysis without further heat treatment via roasting. Without being bound by a particular mechanism, it is possible that the further refinement capacity that resulted from the compounded effects of heat treatment and hydrolysis was a result of increased sugar content from broken down lignins that made the cocoa shells and cocoa pods more brittle, friable, and vulnerable to break down during dry or wet grinding processes. In addition, it is possible that the deleterious effects normally caused by the application of heat, such as a reduction in antioxidants, were off-set by making more sugars available from the lignin structure of these waste materials. Thus, in addition to increasing the breakability of the cocoa shells and cocoa pods, the heat treatment in conjunction with hydrolysis made reacting sugars in these materials more available for reactions catalyzed by the addition of heat (e.g., Maillard reactions). The flavor precursors created by the hydrolysis also resulted in increased levels of beneficial flavor compounds that were generated during the roasting.

Even more surprising was the finding that when combined with heat treatment, both acid and base hydrolysis resulted in particle sizes in the low 20 micron range. As shown in FIG. 15, acid hydrolysis of cocoa shells with phosphoric acid resulted in a cocoa shell chocolate having a particle size of 22.6 microns, while alkali hydrolysis of the cocoa shells with sodium hydroxide resulted in a shell chocolate having a particle size of 21.3 microns. This discovery was particularly unexpected because most commercial processes that involve a pH adjustment for cocoa beans, which are acidic in nature, attempt to raise the pH of the cocoa beans with an alkaline treatment such as Dutch processing. Acid treatment of cocoa beans or other cocoa-related materials, therefore, and acid treatment combined with heat, run contrary to conventional methodologies for adjusting the pH of cocoa beans.

In order to test the efficacy of the processes on upcycled ingredients, both cocoa pods (the hard, fibrous exterior) and the cocoa shell (the papery, fibrous material on the exterior of the cacao beans that is released during winnowing) were tested under different conditions. Cocoa shell samples included no treatment, roasting only, alkali hydrolysis with roasting, and acid hydrolysis with roasting. The samples were then processed into a liquor and their respective particle sizes and particle size distributions were evaluated using a Hegmann, micrometer and a laser diffraction particle size analyzer. Results are shown in FIG. 15. Cocoa pod samples included control (dehydrated from fresh raw pods), roasting only, alkali hydrolysis, and alkali hydrolysis with roasting. The pods were then ground into powders with a power grinder for 45 seconds, and particle size was determined using a RoTap instrument with four different screens. The screen sizes used for evaluation were the 500 micron (US Sieve Screen Size 35), 355 micron (US Sieve Screen Size 45), 106 micron (US Sieve Screen Size 140), and 45 micron (US Sieve Screen Size 325) sizes.

As shown in FIG. 15 the cocoa shell treatment results showed that hydrolysis paired with roasting resulted in an improvement in particle size reduction, as seen from the Hegmann and micrometer results. Alkali hydrolysis with roasting resulted in particle sizes of 45 microns and 52.0 microns on the Hegmann and the micrometer, respectively. Acid hydrolysis paired with roasting resulted in particle sizes of 50 microns and 101.8 microns on the Hegmann and the micrometer, respectively. Roasting alone did not improve the micrometer and Hegmann readings compared to the control with no treatment, and actually had a higher particle size than the no-treatment control. Thus, for both acid and alkali hydrolysis with roasting, there was a significant decrease in particle size compared to the no treatment control and also compared to roasting alone.

The particle size analyzer provided information on mean value and particle size distribution. The control cocoa shell sample had a mean size of 35.75 microns. In addition, the particle size distribution was bimodal in nature and had a taller peak at higher particle sizes. The cocoa shell sample that was only roasted had an average particle size of 22.06 microns. The particle size distribution was bimodal in nature, but the peaks were discrete and approximately equal in height. The alkali hydrolysis treatment of cocoa shells resulted in an average particle size of 21.32 microns. The particle size distribution was bimodal in nature, similar to the control sample, but the first peak was higher, indicating a high percentage of particles at a smaller size. The acid hydrolysis of cocoa shells resulted in an average particle size of 22.64, slightly larger the average particle size resulting from the alkali hydrolysis treatment. This was reflected through the slightly higher second peak compared to the alkali hydrolysis.

Cocoa pods were processed as described in Examples 2 and 4 above, and were blended in a power grinder to create a powder. The pods that were not treated had an approximate particle size of 355.16 microns. The pods that were only roasted had an average particle size of 640.51 microns. As discussed above, roasting treatment on its own can increase hardness as water evaporates from the material and the lignocellulosic material is more compressed/case-hardened. The pods that were treated with alkali only (not roasted) had an average particle size of 348.26 microns. The pods that were treated with alkali and roasted afterwards had an average particle size of 284.92 microns.

These results indicated that the hydrolysis process assisted in breaking down the lignins into smaller components (e.g., sugar groups) that were more amenable to particle size reduction in processing. The dimers and monomers formed in hydrolysis can crystallize in the dehydration process, which can improve the fracturability (also referred to as friability or breakability) of cocoa shells and pods and increases their ability to break down into fine particles during particle size reduction. Thus, roasting in conjunction with hydrolysis was able to create a brittle product with high friability. In addition, the hydrolyzing agents may have weakened the fibrous cocoa shell and cocoa pod materials to make them more brittle and grindable in a final liquor product.

The choice of a strong alkalizing agent such as sodium hydroxide may have resulted in higher levels of lignin degradation and then sugar degradation. As shown in the GC-MS analysis of treated cocoa shell product (described below), lignin degradation followed by sugar degradation was indicated by the observed increase in Maillard browning reaction products in the treated cacao waste material, which can be correlated with more available reducing sugars. Lignin and sugar degradation likely improved the fracturability of the cacao waste product particles during particle size reduction. In addition, the sugar degradation provided more precursors to the Maillard reaction, which occurred during the roasting process. The impacts of roasting and hydrolysis paired together resulted in improved processing of cocoa shells using standard chocolate production methods, without the need for specialized grinding equipment, since the hydrolysis and roasting treatments facilitated the breakdown of shell particles. As a result, cocoa shells that were separated from cocoa nibs by the winnowing process in standard chocolate manufacturing no longer need to be diverted as waste but instead can be used as an additive to chocolate and confectionery coating production.

Several surprising and unexpected effects were observed. The control sample of cocoa shells, for example, differed from the treatment samples in that there were large particles that filtered to the bottom and required additional stirring to prevent separation, more so than the acid and alkali hydrolysis treated samples that underwent the same liquor processing. The addition of roasting was observed to reduce the separation compared to the control but did not have the low particle size of the samples that were hydrolyzed prior to roasting. Additionally, the alkali hydrolysis samples leeched a thick, brown liquid that was easily reabsorbed by the shells during dehydration. The brown liquid was opaque, indicating the presence of starches freed from the ligno-cellulosic complexes prevalent in cocoa shells. The brown liquid also had a rich chocolate odor; these color and odor characteristics are both highly desirable in finished chocolate products. Cocoa shells typically have a neutral or slight odor and color and are not known to contribute appreciably to the flavor profile of a chocolate. Thus, the formation of the thick brown liquid having a rich chocolate odor was an unexpected and beneficial result of these studies.

Further, in the experiments for both cocoa pods and shells, there was a compounding effect observed when alkali and acid treatments were combined with roasting. The roasting process alone was shown to reduce particle size, especially for cocoa shells, but there were significant further size reductions and increased ratios of small particles, as seen in the Anton Paar particle size distribution (discussed further in the Examples below). For cocoa pods, the highest proportion of small particles (106-355 microns) was seen with the alkali roasted treatments.

Another surprising effect was that the cacao waste materials contributed positively to the chocolate aroma and flavor with characteristics akin to true cocoa. This was evidenced in sensory studies, described below, in which cocoa shell chocolate containing no cocoa solids achieved statistical parity to “real” chocolate made with chocolate liquor. This finding indicated that cocoa shell powder and cocoa shell liquor produced according to the methods provided herein served as total replacements of cocoa solids and/or cocoa liquor, in addition to their applications as fillers or bulking agents for mixtures with products made partially with cocoa nibs, dry cocoa solids, and/or cocoa liquor. Likewise, finished chocolate products made with cocoa shells (referred to herein as cocoa shell chocolate) exhibited chocolate qualities including a smooth, refined feel and taste of traditional fine chocolates, with an intense chocolate flavor experience that achieved statistical parity with gold standard commercial chocolate formulations.

Typically, cocoa pods have no odor other than perhaps a green odor of fresh plant material. In addition, despite the fact that cocoa shells in cacao plants envelop the cocoa nibs and thus are in close proximity with the meat of the cocoa bean, cocoa shells have surprisingly neutral odors. However, a true cocoa-like aroma was noted after processing the cocoa shells.

The results are further discussed in further detail below with respect to GC-MS analysis of cocoa shell and cocoa pod chocolate, where it was observed that cocoa shell chocolate and cocoa pod chocolate share several common volatile compounds with cocoa. In particular, cocoa shell chocolate exhibited volatile compounds also found in cocoa but also interesting variations and groups of compounds. The lack of strong off-odors and flavors from processed cocoa shells or cocoa pods also was notable, as this is quite unusual for most materials that are used as fillers or bulking agents in chocolate formulations. For example, conventional fillers and bulking agents either have no positive contribution of aroma (e.g., as with sugar, a common filler) or they negatively contribute to the flavor profile (e.g., as with protein powders and/or texturizing agents, which can provide an off-putting bean, fermented, and/or grain-like odors).

### Example 10—Preparation of Control Chocolate (45% Semi-sweet Chocolate)

A control “gold standard” commercial semi-sweet chocolate was prepared using standard methods for most small bean to bar chocolates. Raw, winnowed (shells removed) cocoa nibs of Peruvian origin were roasted 100 g at a time in a high convection oven for 7 minutes at 300° F. The recipe included, by weight: 45.0% chocolate liquor (made of 22.5% cocoa butter and 22.5% cocoa solids), 11.5% cocoa butter, 43.0% granulated sugar, 0.50% sunflower lecithin, and 0.05% natural vanilla flavor.

As shown in TABLE 3, a chocolate prepared using cocoa shells (“cocoa shell chocolate”) was created with the following composition to mimic the pure chocolate semi-sweet formula, based on solids information:

TABLE 3
Composition of prepared gold standard semi-sweet chocolate

| Ingredient | % of composition (w/w) |
|---|---|
| Chocolate Liquor (22.5% cocoa | 45.00% |
| butter; 22.5% cocoa solids) | |
| Sugar | 43.00% |
| Cocoa Butter | 11.50% |
| Lecithin | 0.50% |
| Natural Vanilla Flavor | 0.05% |

TABLE 4
Composition of prepared cocoa shell chocolate

| Ingredient | % of composition (w/w) |
|---|---|
| Cocoa Shells | 22.50% |
| Sugar | 42.95% |
| Cocoa Butter | 34.00% |
| Lecithin | 0.50% |
| Natural Vanilla Flavor | 0.05% |

Each formula was blended and ground for 48 hours using a stone melanger (COCOATOWN®) with the pressure set to “high.” Due to the harder shell material, the cocoa shell chocolate required more grinding action to create a similar particle size. The final particle size ranged from 27 to 35 microns. The particle size was measured using a micrometer screw and a Hegman gauge multiple times during the grinding process for both the control chocolate and the cocoa shell chocolate, and the readings confirmed a mean particle size of about 20 microns for both the control and the cocoa shell chocolate. The chocolate was tempered and molded into bars by hand, followed by full cooling and release of the chocolate from the molds. The chocolate bars were sensory tested at room temperature using the protocol described above. The ground flour (cocoa shell powder), prepared according to the above example, was added into the chocolate application at a maximum percentage of 22.5%. It is to be noted that depending on the intended final percentage of cacao solids, additional cocoa solids can be added to achieve the desired flavor characteristics while still achieving desirable particle size.

### Example 11—GC-MS analysis of Cocoa Shells and Cocoa Pods

Roasting includes a combination of Maillard browning and caramelization reactions that increase the concentration of volatile compounds, which generally correlates with increased consumer preference and also increased darker brown colors in the food product. Gas chromatography mass spectrometry (GC-MS) analysis was conducted to quantify the volatile compounds that were present after roasting. As described below, hydrolyzed and unhydrolyzed cocoa shell samples were analyzed by GC-MS to compare volatile compound profiles, demonstrating that cocoa shells treated by hydrolysis prior to roasting had superior VOC profiles as compared to non-treated cocoa shells, and also compared favorably with cocoa beans and cocoa powders.

### Samples

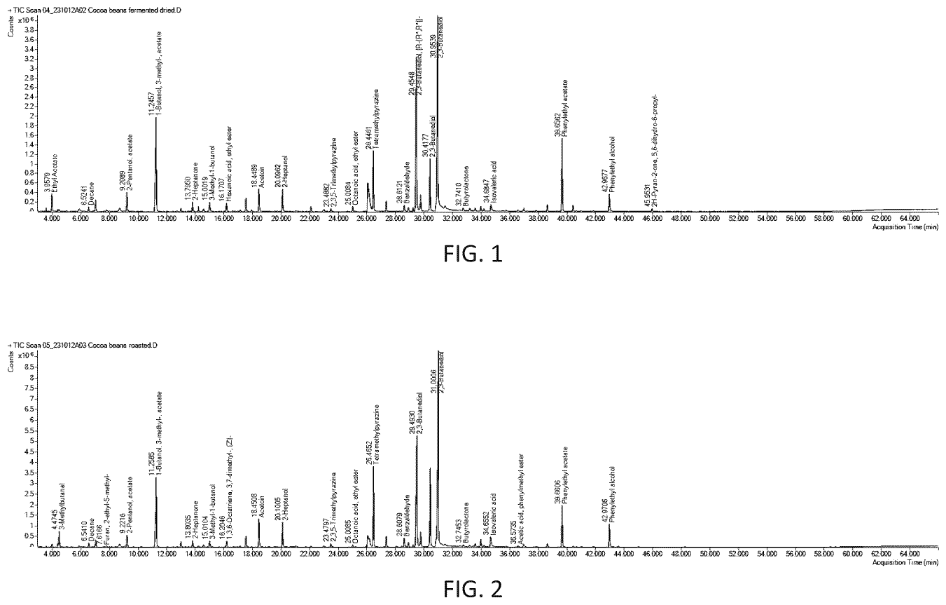

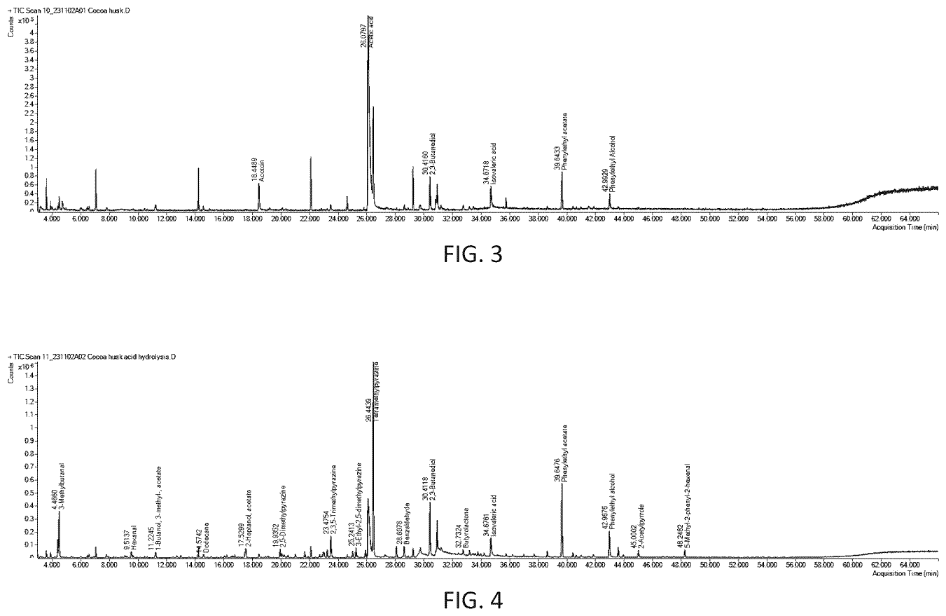

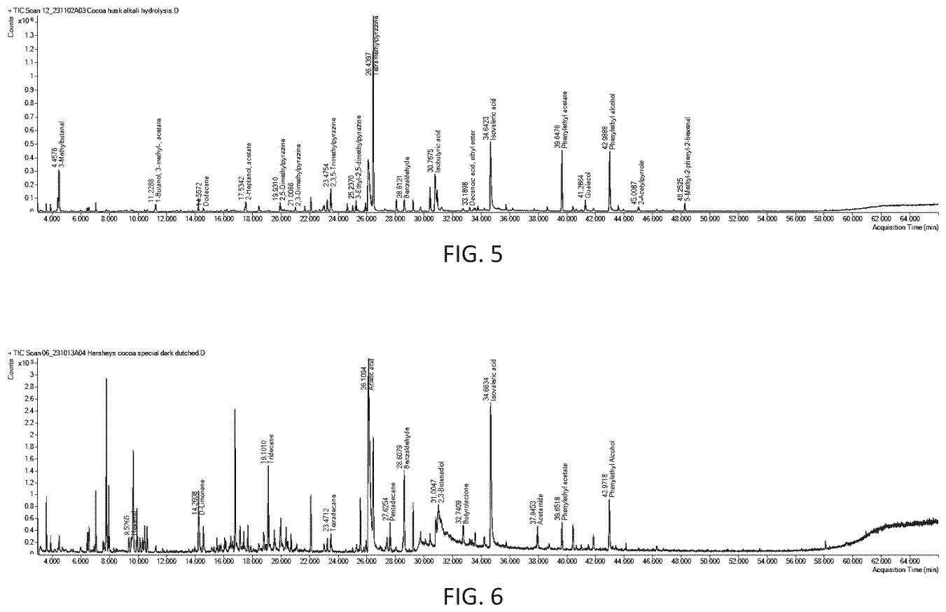

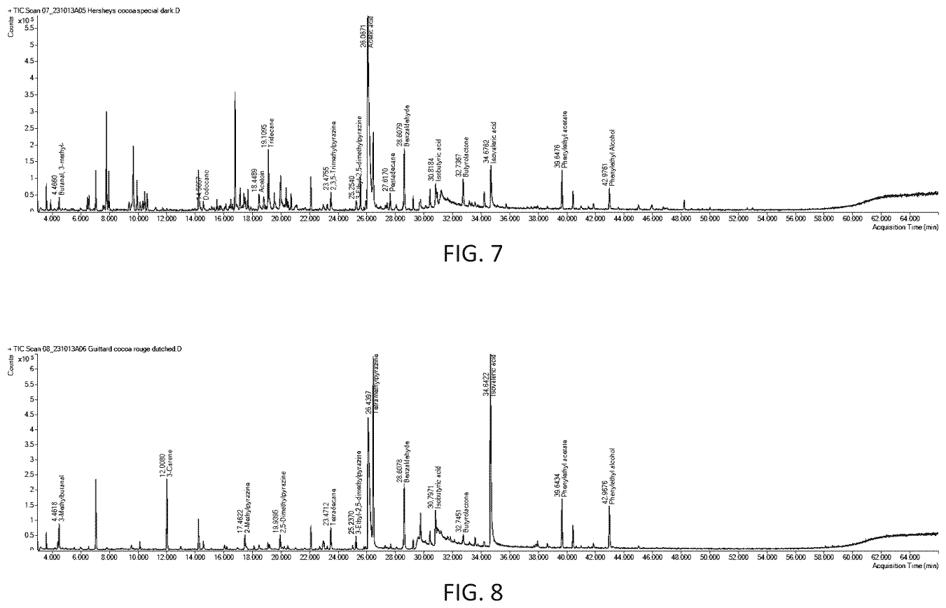

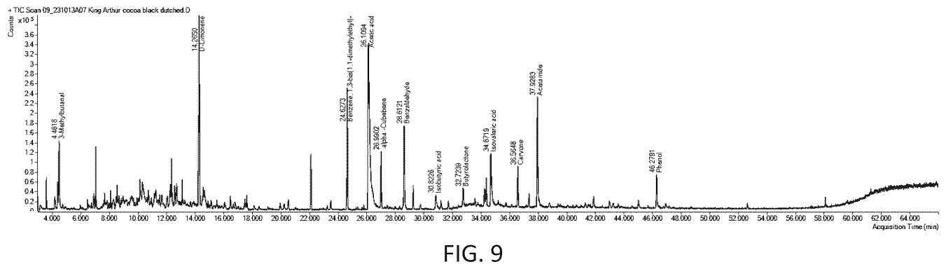

Cocoa beans were purchased from Merician Cacao. Cocoa shells were purchased from Soul Life Cacao. Cocoa powders were sourced from local grocery stores. Commercial cocoa bean and cocoa powder treatments were listed on the supplier packaging (TABLE 5). Cocoa shells were treated with acid or alkali hydrolysis and roasted on-site. Cocoa beans, cocoa powders, and cocoa shells were extracted using a dynamic headspace (DHS) technique and analyzed by GC-MS. The cocoa samples and their treatment regimens are shown in TABLE 5. Representative chromatograms for the nine samples listed in TABLE 5 are provided in FIGS. 1-9.

TABLE 5
Cocoa samples and treatments

| Sample | | |
|---|---|---|
| Number | Sample Type | Treatment |
| 1 | Cocoa beans | Fermented and dried |
| 2 | Cocoa beans | Roasted |
| 3 | Cocoa shells | Dried |
| 4 | Cocoa shells | Acid |
| 5 | Cocoa shells | Base |
| 6 | Hershey's special dark cocoa powder | Dutched |
| 7 | Hershey's special dark cocoa powder | No treatment listed |
| 8 | Guittard rouge cocoa powder | Dutched |
| 9 | King Arthur black cocoa powder | Dutched |

### Sample Preparation

Cocoa bean samples were ground to a powder with liquid nitrogen in a blender. Dried cocoa shells were provided as broken and ground pieces. Treated cocoa shells were provided as ground powders. Commercial cocoa powders were analyzed as supplied. Samples (100 mg±5 mg) were weighed directly into 20 mL glass headspace vials for DHS extraction.

### GC-MS Analysis

The GC-MS system consisted of an Agilent 8890 GC with a 7000D triple quadrupole MS (Agilent Technologies, USA). The GC-MS was equipped with a Gerstel Multipurpose Sampler Robotic Pro (MPS), a Thermal Desorption Unit 2 (TDU), a Cooled Injection System 4C (CIS), a C506 controller with liquid nitrogen cooling for CIS, a Universal Peltier Cooling (UPC) for TDU, a EPC pneumatic module for CIS use with Agilent 8890, an Automatic Tube Exchange (ATEX) option for MPS, and a dynamic headspace module (Gerstel GmbH, Germany). A Stabilwax-MS (30 meter, 0.25 mm ID, 0.25 μM film thickness) GC column was used (Restek, USA). The CIS was equipped with a deactivated, notched, glass bead liner (Gerstel GmbH, Germany). The Agilent GC-MS was controlled by MassHunter GCMS Acquisition software (Agilent Technologies, USA). The Gerstel components were controlled by Maestro software (Gerstel GmbH, Germany).

Samples were extracted in the DHS module with Tenax-TA TDU tubes as the trapping phase (Gerstel GmbH, Germany). The DHS module agitation settings were set to 60 seconds on and 1 second off with an agitator speed of 250 rpm. The DHS transfer heater was set to 75° C. Samples were initially incubated at 60° C. for 5 minutes. After initial incubation, the trapping phase began with the trap temperature set to 30° C. and incubation temperature 60° C. Nitrogen gas was purged through the sample headspace at a flow rate of 50 mL/min with a total trapping volume of 1500 mL (30 minutes). After the trapping phase, the Tenax-TA TDU tube was subjected to a drying phase with nitrogen gas at a flow rate of 50 mL/min, 150 mL volume (3 minutes), and a trap temperature of 40° C.

Tenax-TA samples were desorbed in the TDU with an initial temperature of 30° C., delay time of 0.5 min, after which the temperature was ramped at 720° C./min to 280° C. and held for 3 min. The TDU transfer temperature was fixed at 280° C. and the desorption mode in the TDU was splitless. Desorbed compounds were trapped in the CIS at an initial temperature of −120° C. with a 0.2 min equilibration time, after which the temperature was ramped at 12° C./s to 275° C., and held for 3 min. The inlet pneumatics were operated in solvent vent mode with a pressure of 13.356 psi, a purge flow to split vent of 20 mL/min at 0.01 min (equivalent to a 1:20 split ratio), and a vent flow of 50 mL/min. Helium was used as a carrier gas at a flow rate of 1 ml/min. The GC oven was set to an initial temperature of 40° C. with a 5 min hold time after which the temperature was ramped to 190° C. at 3° C./min and then ramped again to 250° C. at a rate of 10° C./min and held for 5 min for a total run time of 66 min. The collision cell used helium as a quench gas with 2.25 mL/min flow rate and nitrogen as collision gas at 1.5 mL/min flow rate. The MS transfer line was set to 250° C., the source temperature was 230° C., and the quadrupoles set to 150° C. The ion source was operated in electron impact (EI) mode at 70 eV. A 2.8 min solvent delay was used. The MS was operated in scan mode with a scan time of 245 ms and a scan range of 35-350 amu.

### Identification of Volatile Compounds

Compounds were identified by comparison of their retention time and mass spectra with a library generated by analysis of reference standards. Compounds for which no reference was available were identified by comparison of retention index (RI) and mass spectra with available databases. An alkane mix containing C8-C20 linear alkanes at 40 μg/mL in hexane (Sigma, USA) was spiked (5 μL) into 5 mL of water and analyzed in the same manner as cocoa shell samples to calculate RI. The NIST mass spectral database (Version 2.4, build Mar. 24, 2020) was used to search mass spectra and polar RI values. In addition, Flavornet (www.flavornet.org/index.html) and the Leibniz-LSB@TUM Odorant Database (www.leibniz-lsb.de/en/databases/leibniz-lsbtum-odorant-database/start/) were searched for RI values.

### Data Analysis

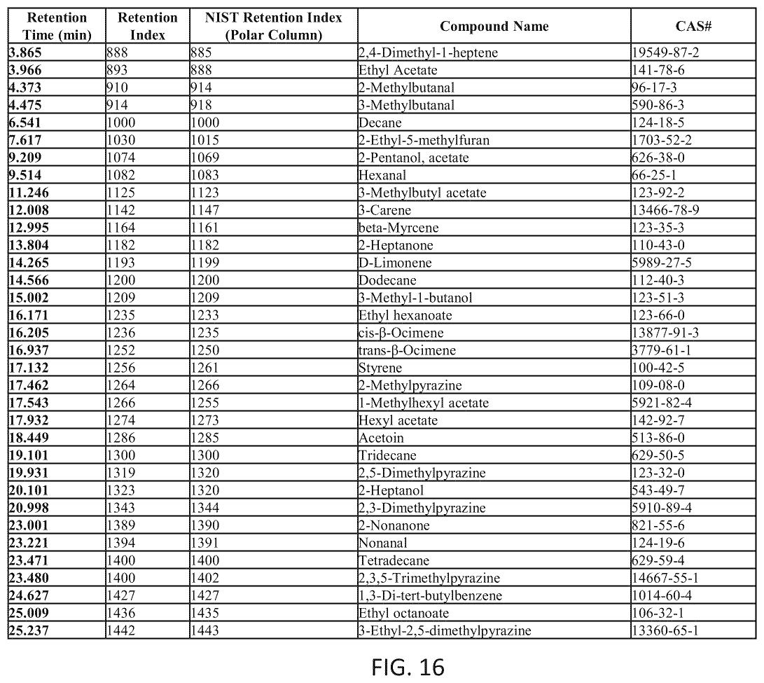

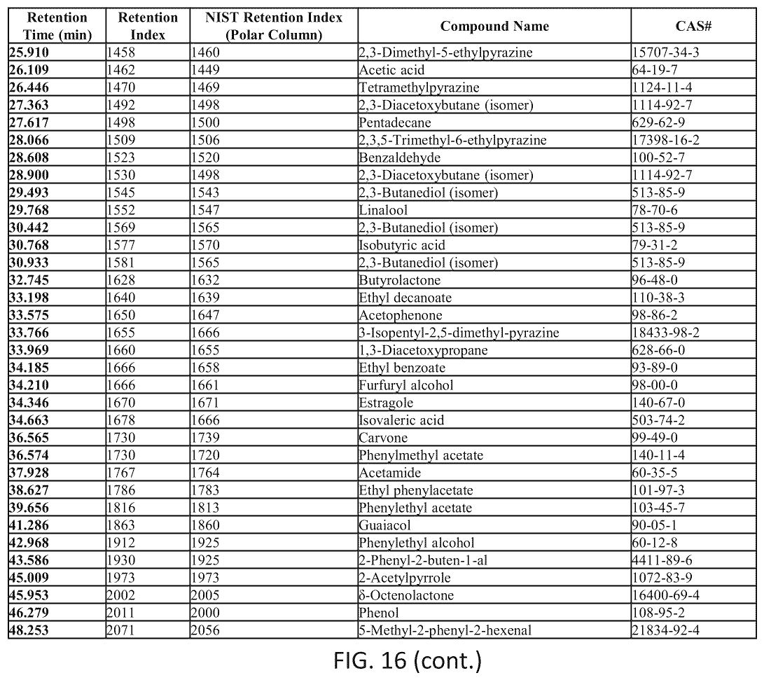

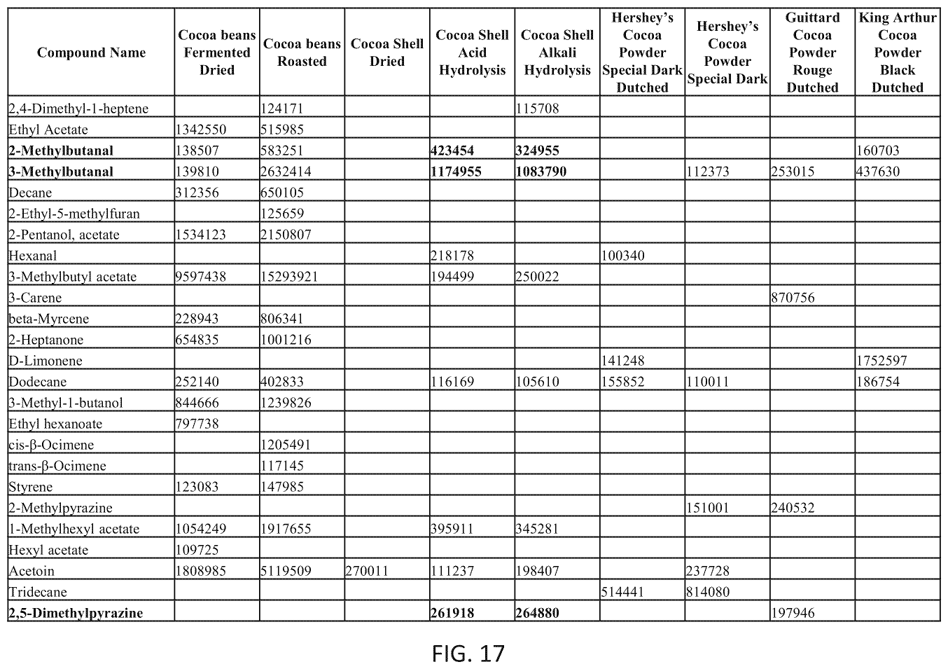

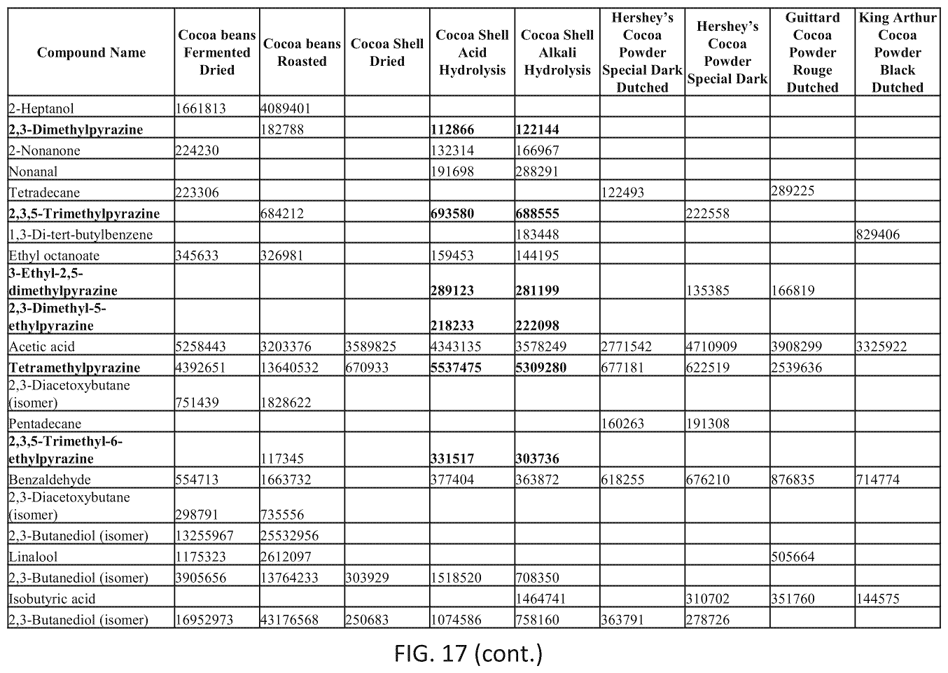

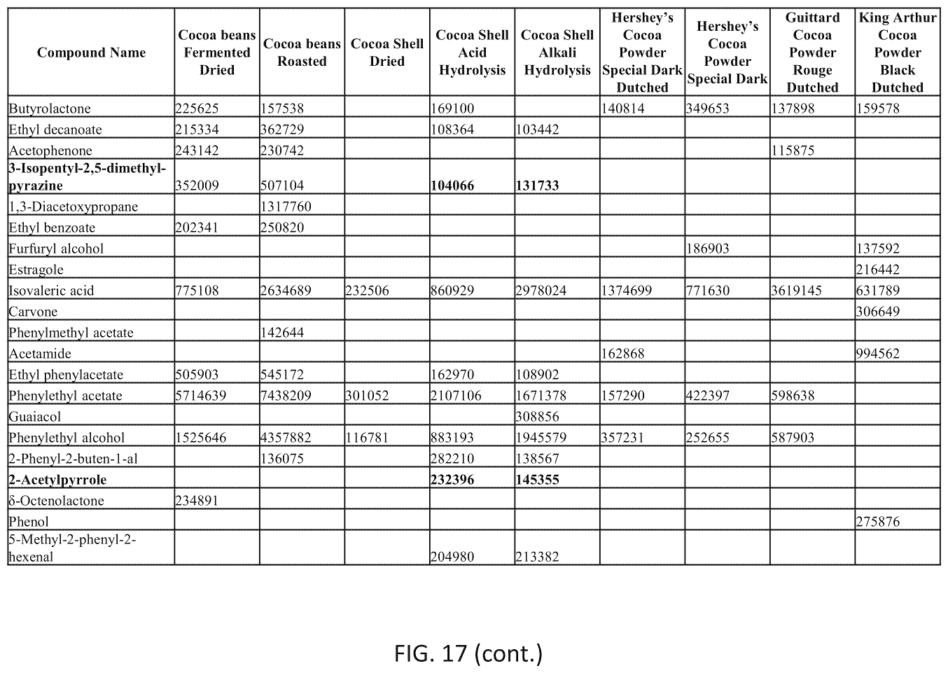

The compounds identified from the DHS GC-MS analysis of cocoa samples are shown in FIG. 16. FIG. 17 lists the peak area of the identified compounds in the cocoa samples. Representative chromatograms for the samples are shown in FIGS. 1-9. FIG. 16 also lists values from the National Institute of Standards and Technology mass spectral library, available online at https://chemdata.nist.gov/. This was the standard library used to assist with compound identification by providing reference mass spectra for GC-MS, enabling the identification of volatile compounds in samples that were analyzed by the mass spectrometer. FIG. 16 lists all of the compounds relevant to the search in these experiments.

The GC-MS data demonstrated that there was flavor development in the cocoa shells that underwent hydrolysis. The cocoa shells that were only dried developed significantly fewer compounds than the fermented and dried cocoa beans and the roasted cocoa beans. Surprisingly, however, both the acid hydrolyzed and alkali hydrolyzed cocoa shells contained more compounds than were found in commercial cocoa powders t and the untreated cocoa shells. As a result, the treatment of cocoa shells was found to impact significantly not only the ability to reduce particle size, but also to significantly impact flavor compound development to a product that is more on par with typical cocoa beans. Both the acid hydrolysis and alkali hydrolysis treated cocoa shells contained a similar number of compounds as the cocoa beans, and some of those were compounds not typically found in cocoa beans. Another surprising finding was that when comparing the cocoa shell powder to commercially available cocoa beans and powders, there was a decrease in overall compounds compared to the cocoa beans. The treated shells, however, had more compounds than were present in any of the commercial cocoa powders tested. Thus, although the cocoa shell powder compared well with commercial cocoa powders, regardless of whether the cocoa powder was dutched (alkalized) or not, it was unexpected that the dry cocoa shell powder possessed more overall compounds than any of the commercially available cocoa powders, which indicated an improvement in its flavor and odor characteristics.

In contrast, the untreated cocoa shells had almost no aroma, with few volatile organic compounds identified. Cocoa powder traditionally tends to be low in aroma due to the high amount of processing that it undergoes to create dry powder from the high-fat liquor process. Surprisingly, the treated cocoa shells had an increased amount of volatile compounds, more similar to real chocolate, than dry cocoa powder made from cocoa nibs. Additionally, there was a higher level of products from browning reactions, created by the increase in sugars from the pre-treatment processes.

Perhaps the most surprising result was the observed increase in volatile compounds associated with products from the Maillard reaction and caramelization in the samples that underwent treatment by acid hydrolysis and roasting and (separately) alkaline treatment and roasting. Unexpectedly, some of these volatile organic compounds (specifically, the eleven VOCs bolded in FIG. 17) were found in concentrations that were either comparable to or significantly higher than the concentrations found in cocoa products (dry cocoa powders or even roasted cocoa beans) that were tested. In addition, and unexpectedly, some of the bolded VOCs were not found in either cocoa solids or cocoa beans.

The primary variables that typically affect the identity and amounts of volatile compounds resulting from the reaction are reaction precursors, temperature, pH, and water content. The water content and temperature remained static in the studies described herein, so those variables were not likely the effect drivers here. The pH was changing, but in general the Maillard reaction is sped up with higher pHs and slowed down at lower pHs. This was not observed in these studies, however, as the acid and basic treatment procedures actually increased the volatile compounds associated with the Maillard reaction. Thus, it appears that the increase in volatile compounds was caused by an increase in the reaction precursors. The reaction precursors in the Maillard reaction are amino acids and reducing sugars. The high percentage of complex carbohydrates in the lignocellulosic structures of the cocoa shells were broken down to release more freely available sugars to participate in these reactions, as supported by the breakdown of the cellulose from a mechanical aspect of the lower particle size with the chemical treatments as well. The increase in volatile compound concentration was surprising because cocoa shells typically have been utilized in the chocolate industry either in spite of a neutral, non-chocolate flavor, or have been processed minimally so as to not create off-notes. The results of these studies indicated a real effect in a positive manner mechanically as well as aromatically. The 11 compounds bolded in FIG. 17 are the following:
1) 2-Methylbutanal
2) 3-Methylbutanal
3) 2,5-Dimethylpyrazine
4) 2,3-Dimethylpyrazine
5) 2,3,5-Trimethylpyrazine
6) 3-Ethyl-2,5-dimethylpyrazine
7) 2,3-Dimethyl-5-ethylpyrazine
8) Tetramethylpyrazine
9) 2,3,5-Trimethyl-6-ethylpyrazine
10) 3-Isopentyl-2,5-dimethyl-pyrazine
11) 2-Acetylpyrrole

VOCs that were present in particularly high concentrations in the treated cocoa shell samples included two methylbutanals, 2-acetylpyrrole, and a family of eight pyrazine compounds. This result was surprising because of the number and types of compounds that were observed at increased concentrations. Chocolate aroma and flavor is associated with hundreds, if not thousands of volatile compounds that combine to create the complex profile. However, these experimental data demonstrated that just eleven (11) volatile compounds, associated with roasted flavor, created a cocoa aroma that mimicked that of a standard semisweet chocolate. The ability to replicate the fullness of flavor and aroma of real chocolate through a key grouping of 11 VOCs concentrated in treated cacao waste materials, particularly treated cocoa shells, was unique and unexpected, both in terms of the total number of volatile organic compounds found and the concentration levels of these volatile organic compounds. Sensory studies, described in the following example, confirmed and corroborated the finding that cocoa shell chocolates produced according to the methods described herein were perceived as having an intense chocolate flavor akin to that of a gold standard semi-sweet chocolate formulation.

### Example 12—Sensory Data of Cocoa Shell Chocolates V. Standard Semi-Sweet Chocolate

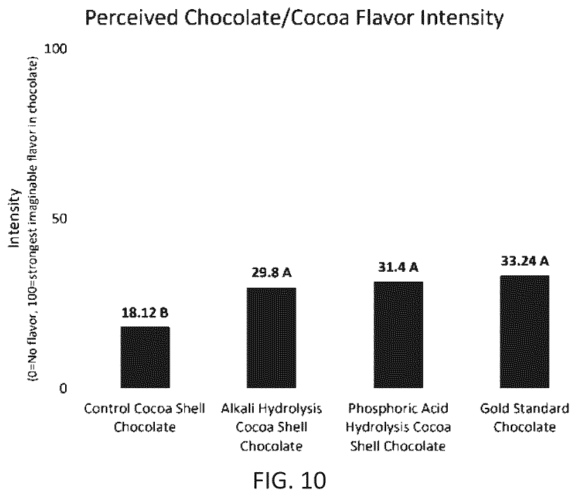

Twenty-five semi-sweet chocolate consumers participated in a central location test in which participants tasted four blinded chocolate samples served in a serial monadic balanced block design. While tasting each chocolate, participants rated perceived chocolate/cocoa flavor intensity on a 100-point labeled magnitude scale (LMS) on an online questionnaire. Participants were required to cleanse their palates with unsalted crackers and room temperature water between samples. As shown in FIG. 10, perceived chocolate/cocoa flavor is significantly higher than control cocoa shell chocolate in both the alkali and phosphoric acid hydrolysis treated cocoa shell chocolates and gold standard chocolates.

Surprisingly, cocoa shell chocolate performed competitively to the standard semi-sweet chocolate and was not perceived to take away from the cocoa flavor, even when the processed cocoa shell was present at a level of 22.5% and was the sole source of cacao-sourced solids in a semisweet chocolate product. The advantage is that there is a wide range of chocolate flavors, especially at higher percent cocoa solids due to difference in cocoa solids origin and processing. As a result, the filler is within the scope of what consumers consider a chocolate product. When comparing the chocolate made from cocoa shells to a gold standard semisweet chocolate, the treated cocoa shell chocolate was higher in cocoa/chocolate intensity compared to the cocoa shell control (n=25). These studies demonstrated that not only is the filler able to stand alone in a chocolate product, but it can also be blended into chocolate, e.g., milk, semi-sweet, or dark chocolate, for improved performance.

### Example 13—Particle Size Analysis of Cocoa Shell Chocolates V. Semi-Sweet Chocolate

All chocolate samples and tests from the above Example were performed with the same ingredients, except that the chocolate liquor was replaced with a ratio of cocoa butter and treated cocoa shells to achieve the same fat content as the gold standard semi-sweet chocolate. After they were refined to the same particle size, which all samples achieved over the same period of time (16 hours) in a melanger, samples were taken and run with the particle size analyzer. The exception was the control sample, which took 24 hours to refine to particle size and was not able to achieve the desired range of 17-23 microns. In addition, observationally, there were larger chunks of particles that could be seen with the eye. This was captured through the particle size distribution data as shown in TABLE 6.

The mean particle size for the control (no treatment) cocoa shell was 17.77 when using the particle size analyzer. In addition, the particle size distribution was distinctively bimodal in its distribution. The mean particle size for the treated cocoa shell chocolate samples were 14.93 microns and 14.67 microns for the alkali hydrolysis and acid hydrolysis treatments, respectively. This was in contrast to the gold standard chocolate that had a 10.33 microns average particle size. In addition, although the particle size distributions were similar, the gold standard sample had a peak at a lower particle size and also was monomodal in its distribution. Both the alkali hydrolysis and acid hydrolysis treatment chocolate samples were mostly monomodal in its distribution but had a slight bump or peak at higher particle size. Although there were some differences in particle size, the treated shell chocolates remained primarily monomodal and had a similar distribution compared to the standard chocolate sample. As a result, the treated cocoa shell chocolate did not negatively affect the particle size of chocolate. In addition, with different refining techniques (i.e., roll refining), the particle size distribution of a chocolate with the same average particle size as a melanged product may be different and have a bimodal distribution instead. With this in mind, the treated cacao waste products would further blend into the chocolate matrix.

TABLE 6
Semisweet chocolate particle size using particle size
analyzer and micrometer screw particle size method
after 16 hours of melanging except where noted.

| | Average | Mean Particle |
|---|---|---|
| | Micrometer | Size on Particle |
| | Particle Size | Size Analyzer |
| Sample | (microns) | (microns) |
| Gold Standard Semisweet | 20 | 10.33 |
| Chocolate | | |
| Control (no treatment) Cocoa Shell | 27 | 17.77 |
| Chocolate* 24 hours melanging | | |
| Alkali Hydrolysis and Roasted | 21 | 14.93 |
| Cocoa Shell Chocolate | | |
| Acid Hydrolysis and Roasted | 21 | 14.67 |
| Cocoa Shell Chocolate | | |

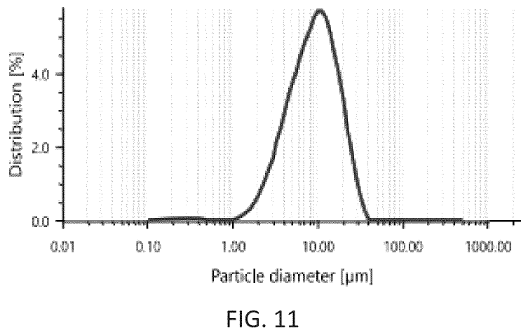

Gold standard chocolate liquor was added to the chocolate recipe and melanged for 16 hours. Particle size distribution was assessed with an Anton Paar particle size analyzer, which used laser diffraction. The graph shown in FIG. 11 demonstrates the monomodal distribution of the gold standard chocolate when using the same refining process as the cocoa shell treatment products.

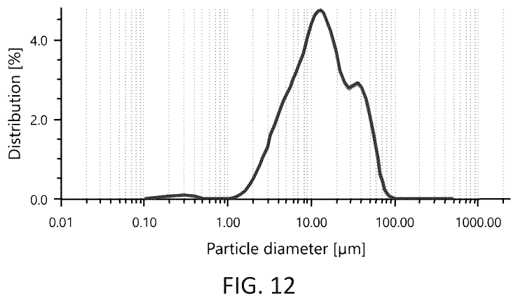

Cocoa shell liquor was added to the chocolate recipe and melanged for 24 hours. Particle size distribution was assessed with an Anton Paar particle size analyzer. The graph shown in FIG. 12 demonstrates the more bimodal distribution of the control (no treatment) cocoa shell chocolate, indicating that there was a proportion of cocoa particles that were larger.

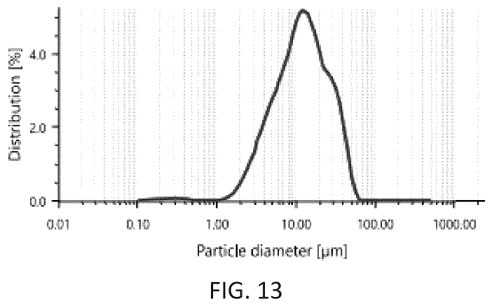

Alkali Hydrolysis and Roasted cocoa shell liquor was added to the chocolate recipe and melanged for 16 hours. Particle size distribution was assessed with an Anton Paar particle size analyzer. The graph shown in FIG. 13 demonstrates the monomodal distribution of the alkali and roast cocoa shell chocolate when using the same refining process as the cocoa shell treatment products. This was a tighter distribution than was observed for the no treatment chocolate.

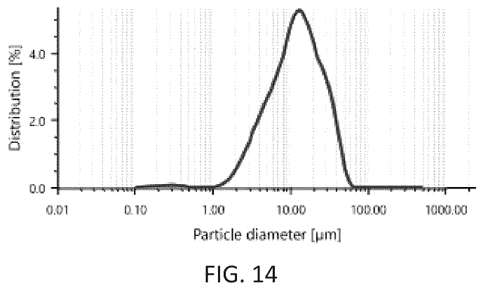

Acid hydrolysis cocoa shell liquor was added to the chocolate recipe and wet milled in a stone melanger for 16 hours. Particle size distribution was assessed with an Anton Paar particle size analyzer. The graph shown in FIG. 14 demonstrates the monomodal distribution of the treated cocoa shell chocolate when using the same refining process as the cocoa shell treatment products. This distribution demonstrated an improved particle size distribution that was more similar to the gold standard semi-sweet chocolate than to the control (no treatment).

### Example 14—Soluble “Instant Cocoa” Particles from Acid-Hydrolyzed Cocoa Shells

The following steps were used to obtain soluble “instant” dry cocoa-like particles having a particle size of about 15-150 microns, or larger particles, e.g., granules or pellets, having a particle size of about 150-350 microns or greater, from acid-hydrolyzed and roasted cocoa shells.

1) A solution containing water and 0.1-1% w/w of a 85% phosphoric acid solution was prepared and heated to about 85° C.

2) Cocoa shells were added to the phosphoric acid solution to generate a cocoa shell/acid solution mixture, which was gently stirred so that all shells were in contact with and submerged in the acid solution. Stirring was continued for 15-60 minutes.

3) After 15-60 minutes, the mixture was drained to separate the treated shells from the phosphoric acid bath. Vacuum suction was applied to partially dry the shells and to remove excess solution such that only a residual amount of acid remained. The vacuum lowered the moisture content to well below 25%. Although other dehydration methods can be used, vacuum drying allowed for faster drying times and efficient moisture removal of excess acid and water in preparation for subsequent roasting due to the reduced boiling point of water under vacuum, which accelerates the drying process.

4) The partially dried cocoa shells were then placed in a roaster and roasted to 165-250° C. resulting in roasted cocoa shells with retention of individual structure suitable for grinding in the next step.

5) The pre-treated (e.g., acid-treated) and roasted cocoa shells were ground into a powder having a particle size from about 15-150 μm that is a substitute for traditional dry cocoa powder. At least one or a combination of two or more of the following dry grinding mechanisms were utilized to produce particles that were coarse (e.g., 150-350 microns or greater) as well as fine (e.g., below 150 microns or even below about 15 microns): a crushing mill that applies pressure to crush materials into smaller pieces; burr mill that uses two revolving abrasive surfaces to grind materials and are known for their consistency in producing uniform particle sizes, particularly suitable for filter-type coffee grounds and hard seed-like materials; espresso grinder: primarily used for grinding coffee beans, it is suitable for grinding treated cocoa shells and pods; jet mill that uses high-speed air jets to pulverize materials; blade grinder that utilizes blades to chop and grind materials; hammer mill that uses hammers to pulverize materials and is especially suitable for coarse grinding or reducing particle sizes to around 100 um, after which, a subsequent grinding is performed to further reduce particle sizes down to about 15 μm; power grinder, which utilizes a powerful motor to quickly break down materials into smaller pieces; and vortex processing apparatus, a method using compressed air in a vortex pattern to grind cocoa shells without moving mechanical parts. This method can achieve fine particle sizes, in many instances, exceeding those of more conventional grinders.

6) The ground particles were extracted with 60-175° C. water via a recirculating pot for 5-45 minutes at 4-36% w/w grounds to water to extract soluble cocoa-like solids from the ground cocoa shell particles. Water is the solvent of choice for extraction since it is a safe and accessible solvent that can dissolve many of the soluble compounds in the cocoa shells. In addition to water, organic solvents such as ethanol or ethyl acetate (a compound found in fruits) can also be utilized. Extraction was continued until the solution obtained was about 15-25% w/w soluble cocoa shell solids.

7) The extract was optionally cooled to 10° C. and filtered through a 25 micron filter paper to remove any insoluble sediments (filtering is also optional but preferred to remove any undissolved particulates). It was found that cooling the extract was useful for several reasons: 1) cooling the extract helped prevent the formation of off-notes or undesirable flavors that can occur if the extract remains at high temperatures for too long (this ensures that the final product retains its intended flavor profile); 2) high temperatures can cause the loss of volatile aromatic compounds, which are important for retaining chocolate aromas and cooling can limit this loss; 3) cooling the extract stabilized chemical reactions that could degrade the quality of the chocolate extract; and 4) in further processing of the extract, such as freeze-drying or spray-drying, cooling the extract helps ensure that the extract is at the optimal temperature for these subsequent stages.

8) The extract was concentrated to increase the solid content, by evaporation (e.g., using a falling film evaporator, rising film evaporator, forced circulation evaporator, plate evaporator, or flash evaporator), by freezing and/or by thawing (i.e., freeze concentration involves freezing the coffee extract, partially thawing, and then removing ice crystals to increase the concentration of soluble solids.

9) The concentrate was dried by spray or freeze drying. In spray drying, the concentrated cocoa shell extract (“concentrate”) was sprayed into a tower with hot air (around 250° C.). The hot air rapidly evaporates the water, leaving behind fine particles in the form of fine soluble granules or soluble powder (e.g., “powder concentrate”). If larger soluble granules or soluble pellets were desired, the fine particles/powder collected at the bottom of the tower were agglomerated to form larger, more soluble granules or pellets. For agglomeration, the fine chocolate powder was subjected to the agglomeration process to form larger, more soluble granules or pellets. This process typically involves rewetting the dry particles with water or steam, bringing the wetted particles in contact with one another, often in a fluidized bed or a rotating drum, then drying the newly formed granules or pellets to remove any excess moisture and to ensure they are stable and free-flowing.

### Example 15—Phosphoric Acid Hydrolysis of Cocoa Shells to pH 2-4

Untreated cocoa shells typically have an acidic pH of about 5.2. Cocoa shells were treated with phosphoric acid to a pH of between about 2 to 4.5. Batches were treated to a different pH, including pH 2, 2.5, 3, 3.5, or 4.

1) For each batch, a solution containing water and a 85% phosphoric acid solution was prepared and heated to 85° C.

2) Cocoa shells were added to the phosphoric acid solution to generate a 50% chickpea, 50% acid solution mixture, which was gently stirred so that all cocoa shells were in contact with the acid solution. Gentle stirring was continued for 15-60 minutes so all shells were in contact with the acid solution. Stirring continued for 15-60 minutes.

3) After 15-60 minutes, the slurry was drained, and the chickpeas were placed in a roaster after partially drying the shells by vacuum pulling or another dehydration method to remove excess acidic solution resulting in removal of phosphoric acid with the exception of a residual amount on the shells.

4) The cocoa shells were roasted to 185-250° C. resulting in roasted cocoa shells with retention of individual structure suitable for grinding in the next step.

5) The acid-treated and roasted cocoa shells were ground to a powder having a particle size from about 15 to about 150 microns.

The above method was used to hydrolyze various batches of cocoa shells with phosphoric acid to produce batches having one of the following pHs: 2, 2.5, 3, 3.5, and 4.

Reducing sugars play a crucial role in the development of aroma and flavor in roasted cocoa nibs through Maillard reactions where, for example, the amino group of free amino acids and the carbonyl group of the reducing sugars form a complex mixture of compounds. In addition to the Maillard reaction, caramelization also occurs during roasting. This process involves the thermal decomposition of sugars, leading to the formation of caramel-like flavors and contributing to the color and sweetness of the chocolate. Phosphoric acid treatment of the cocoa shells facilitated the formation of reducing sugars and other simple sugars when the cocoa shells were roasted. Batches of cocoa shells were acid-hydrolyzed with phosphoric acid to different pH levels, which were then roasted, resulting in different batches of roasted cocoa shells.

The total sugar content of cocoa shells that were treated with phosphoric acid to varying pH levels and roasted is measured analytically through HPLC (High-Performance Liquid Chromatography) according to the following methodology. To prepare each hydrolyzed and roasted cocoa shell sample for HPLC analysis, each sample solution was kept at room temperature for 30 minutes. Sugars were extracted for multiple experimental runs; thereafter, the appropriate dilution was quantitated using HPLC. The moisture content is taken into account to transform results into dry basis % w/w amount of sugar in each sample.

### Example 16—Volatile Organic Compounds in Acid-Treated & Roasted Cocoa Shells

The Maillard reaction and Strecker degradation during roasting of cocoa nibs produce volatile organic compounds and derivatives, which are responsible for the characteristic rich aroma of chocolate. These chocolate compounds, which number in the thousands, include various aromatic molecules that give chocolate its distinct and appealing smell. The ability to replicate the fullness of flavor and aroma of real chocolate was unexpectedly discovered in a grouping of 11 VOCs found in phosphoric acid treated and roasted cocoa shells. The combination of these 11 VOCs were found to provide aroma characteristics perceived as that of real chocolate. As shown in FIG. 17, above, and the accompanying text, the peak area of compounds in cocoa shell samples were analyzed, and the volatile compounds that are reaction products of Maillard or caramelization, which showed a demonstrated increase in concentration in cocoa shells treated with phosphoric acid followed by a thermal roasting treatment, were identified in bolded font. VOCs that were present in particularly high concentrations in the treated cocoa shell samples included two methylbutanals, 2-acetylpyrrole, and a family of eight pyrazine compounds. It was surprising that these eleven (11) volatile compounds, in combination, created a strong, distinctive, odor that mimicked that of chocolate. TABLE 7 is a description of the aromas typically associated with each of the eleven VOCs, compounds whose concentrations were especially pronounced in the acid-hydrolyzed and roasted cocoa shell samples.

TABLE 7
Odor descriptors for Eleven VOCs in Acid-
Hydrolyzed and Roasted Cocoa Shell Samples

| Compound | Odor Descriptor |
|---|---|
| 2-Methylbutanal | Malty, green apple, nutty |
| 3-Methylbutanal | Malty, chocolate-like, pungent |
| 2,5-Dimethylpyrazine | Nutty, roasted, cocoa |
| 2,3-Dimethylpyrazine | Nutty, roasted, earthy |
| 2,3,5-Trimethyl-6-ethylpyrazine | Roasted, meaty, nutty |
| 2-Acetylpyrrole | Nutty, popcorn-like, caramel |
| 3-Isopentyl-2,5-dimethylpyrazine | Earthy, roasted, nutty |
| Tetramethylpyrazine | Cocoa, roasted, chocolate |
| 3-Ethyl-2,5-dimethylpyrazine | Roasted, savory, nutty |
| 2,3,5-Trimethylpyrazine | Nutty, roasted, chocolate-like |
| 2,3-Dimethyl-5-ethylpyrazine | Roasted, nutty, earthy |

### Data Analysis

GC-MS analysis of hydrolyzed and roasted cocoa shells was conducted. Specifically, acid or alkali hydrolyzed, roasted, and ground (HRG) cocoa shell samples were analyzed by GC-MS to compare volatile compound profiles and to determine how the concentrations of certain key VOC classes changed as a result of acid-hydrolysis compared to cocoa shells that were dried/roasted only, without treatment with either an acid or an alkali. The resulting chromatograms show the concentration of the eleven VOCs listed above in TABLE 7.

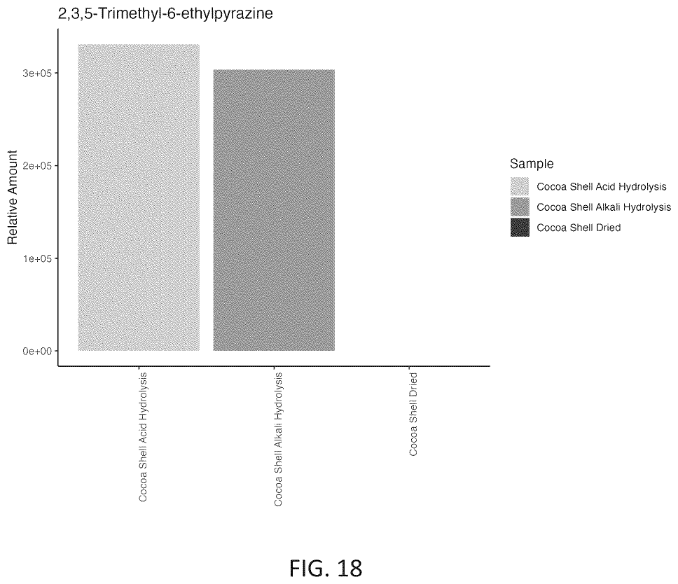

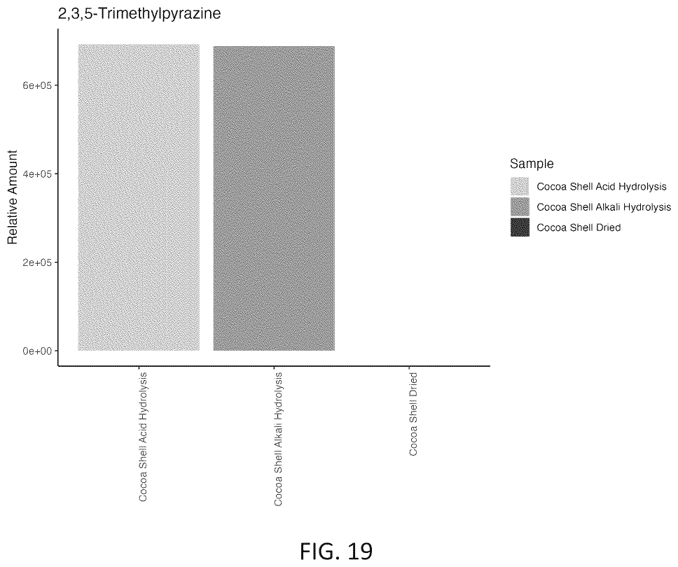

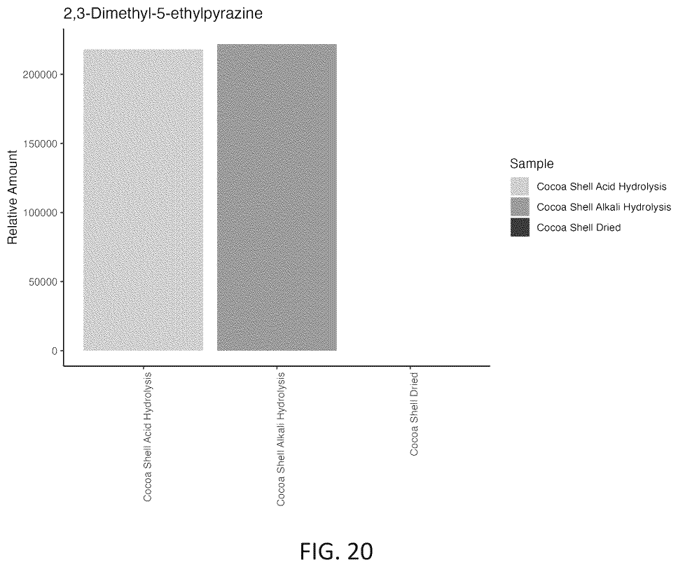

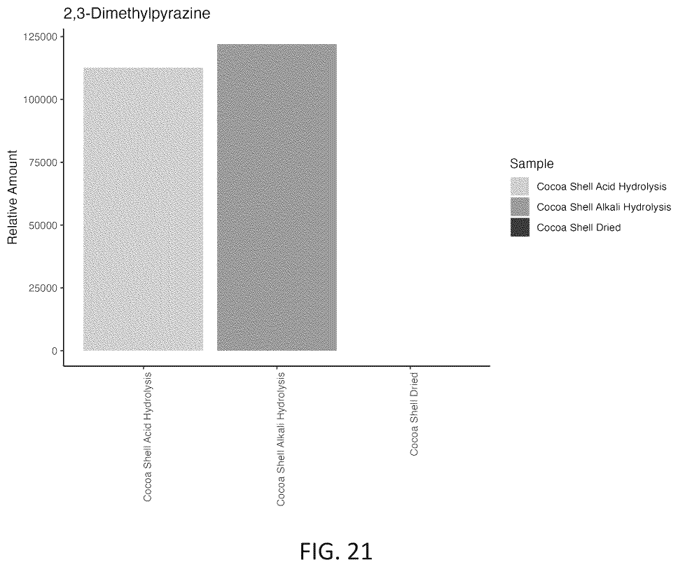

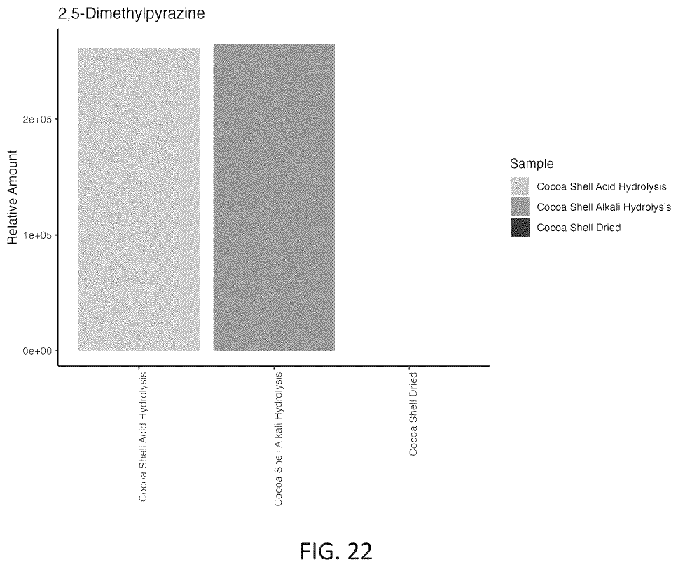

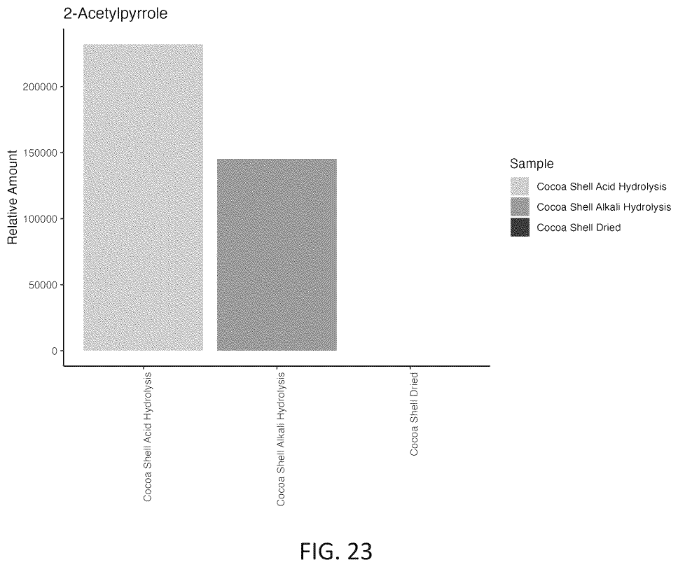

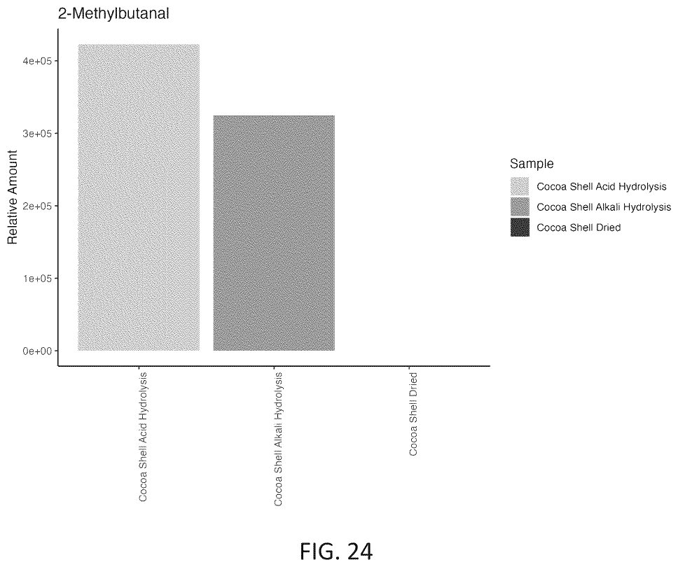

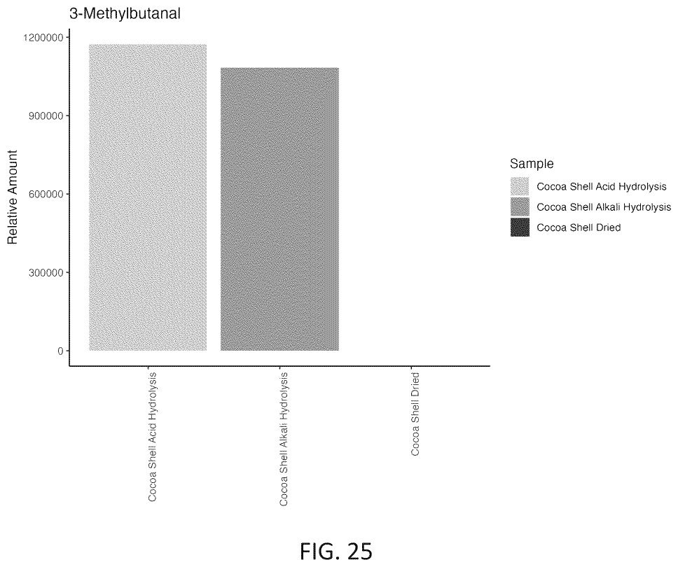

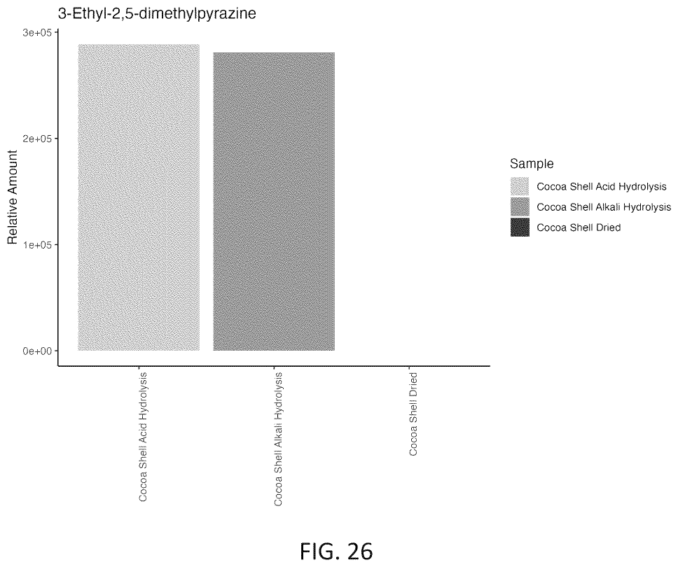

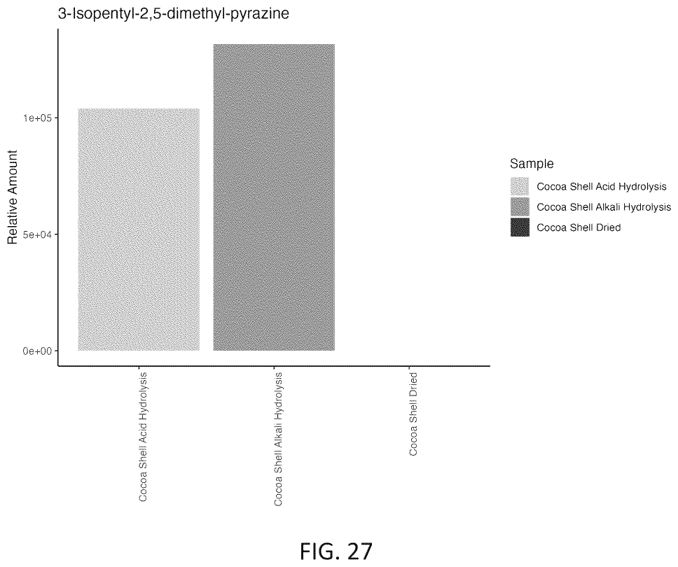

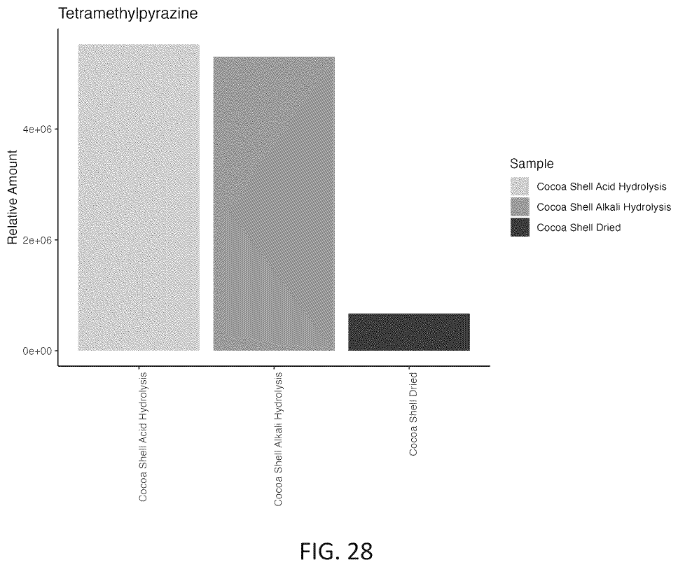

Referring to TABLE 7, when looking at three main classes of flavor-active Maillard reaction products, methylbutanals, acetylpyrroles, and pyrazines, some overarching trends become evident. Methylbutanals, especially the compounds 2-methylbutanal and 3-methylbutanal, impart a sweet, malty, and slightly nutty aroma to chocolate as well as roasted coffee. Acetylpyrroles, especially 2-acetylpyrrole, are known to impart a nutty, popcorn-like, and caramel notes, and slightly woody aroma to chocolate and roasted coffee. These compounds contribute to the complex and rich scent profile that makes chocolate so enticing. Pyrazines include 2,5-dimethylpyrazine, which contributes to the nutty and chocolatey notes to the products of interest and 2,3-dimethylpyrazine, which helps to bring the roasted character to foods like coffee or chocolate. Eight of the eleven VOCs compounds are pyrazines. FIGS. 18-22 and 26-28 represent the relative amounts of each of the eight pyrazines found in cocoa shells that were hydrolyzed with either phosphoric acid or sodium hydroxide prior to roasting when compared with cocoa shells that were dry roasted. In every instance, the concentration of the pyrazine compound was demonstrably higher in either the acid-hydrolyzed or alkali-hydrolyzed cocoa shells than the untreated cocoa shells. Similarly, for 2-acetylpyrrole, as shown in FIG. 23, the relative amount of this volatile compound was significantly higher for the acid-hydrolyzed cocoa shell than the untreated cocoa shells. Between the acid and alkali-hydrolyzed samples, the relative amount was the highest for the acid-hydrolyzed cocoa shell sample. Similarly, for 2-methylbutanal and 3-methylbutanal, shown in FIGS. 24 and 25, respectively, the relative amount of each volatile compound was significantly higher for the acid-hydrolyzed cocoa shell than the untreated cocoa shells. Between the acid and alkali-hydrolyzed samples, the relative amount was the highest for the acid-hydrolyzed cocoa shell sample.

Taken together, FIGS. 18 to 28 show that hydrolysis conditions can target the production of distinct classes of flavor-active Maillard reaction productions, directly leading to tailor-made flavor profiles, such that cocoa shells which are known to have little to no chocolate-like aroma, can be chemically encouraged through acid and/or alkali hydrolysis, to produce compounds that impart chocolate-like aromas.

Through extensive experimentation, it was determined that acid and alkali hydrolysis pre-treatment conditions can be modified, for example, by combining two or more batches of cocoa shells or pods that have been hydrolyzed to two or more pH levels, to promote the creation (or reduction) of important classes of aroma compounds. The cocoa shell and cocoa pod substitutes that were produced according to the examples herein possessed an intense chocolate aroma and flavor and the rich, dark brown color of traditional chocolate made from cocoa nibs. Thus, strong chocolate-like odorants were produced even though the overall chemistry of acid-hydrolyzed and roasted cocoa shells is not identical to that of traditional gold-standard chocolate produced from cocoa nibs.

Batches of cocoa shells that have been hydrolyzed at different pHs can be produced, with each batch optimizing the specific VOC family or compound that is desired. For example, one batch of cocoa shells acid-hydrolyzed to encourage the formation of methylbutanals, and a second batch of cocoa shells acid-hydrolyzed to encourage the formation of acetylpyrroles, can be blended together to create a hybrid mixture of cocoa shells that have been subjected to different reaction conditions. Thus, the concentration of one or more of the 11 key VOCs identified in FIG. 17, can be modulated to adjust the intensity of certain chocolate-like aromas. In addition, testing has shown that alkali conditions also encourage the formation of certain VOCs. As discussed above, the formation of key volatile organic compounds also resulted when cocoa shells were alkalized to a pH of between 10-12. Alkali-hydrolyzed cocoa shell batches treated with an alkali, e.g., sodium hydroxide, potassium hydroxide, lye, sodium carbonate, calcium carbonate, calcium hydroxide, or potassium bicarbonate from one batch can be combined with one or more acid-hydrolyzed cocoa shell batches to further modulate the resulting VOC profile of the resulting roasted cocoa shell product.

In another embodiment, extracts, concentrates, powders, can be made of cocoa shell processed under different pH conditions and two or more processed batches can be combined in a desired ratio, such as 50%/50% w/w, to produce a mixture that has a higher concentration of both methybutanals and 2,5-dimethylpyrazine, for example. Such mixtures can comprise a first, second, third or even more batches to create a mixture that has the desired concentrations of compounds to manipulate or balance the nutty, chocolatey, smoky, or other aroma notes such that the organoleptic characteristics more closely resemble that of a target food product such as chocolate, coffee, or a nut butter. Such combination mixtures of extracts, for example, can be made once the extract has been concentrated or after they have been dried into a soluble granule, pellet, or powder. Undesirable “off-notes” can be similarly reduced by adjusting the reaction conditions during hydrolysis (for example, pH, temperature, hydrolysis time, acid/alkali type, acid/alkali concentration) to lessen or minimize the contributions of certain volatile compounds that may be prominent in a source substrate, such as sulfur compounds. Thus, methods of preparing substitutes for food products like coffee, chocolate, or peanut butter, are contemplated and taught herein.

The data illustrate that the flavor profiles of the cocoa shell ingredient can be successfully manipulated in order to make this cacao waste product more versatile in food applications that seek to mimic traditional foods that have a complex chemical profile, such as traditional chocolate, traditional coffee, and traditional peanut butter, by elevating some of the compounds that are commonly found in those foods by adjusting hydrolysis reaction conditions in addition to roasting parameters, such as temperature, time, and pressure.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A consumable product comprising acid-hydrolyzed and roasted cacao waste material or alkali-hydrolyzed and roasted cacao waste material, wherein the cacao waste material comprises cocoa shells, cocoa pods, or cocoa shells and cocoa pods.

2. The consumable product of claim 1, further comprising enzymatically-treated cacao waste material.

3. The consumable product of any one of claim 1 or 2, wherein the cacao waste material is ground cacao waste material having an average particle size of about 15 to about 300 microns, about 200 to about 300 microns, about 150 to about 200 microns, about 100 microns to about 150 microns, about 50 microns to about 100 microns, about 50 microns to about 75 microns, about 25 to about 50 microns, about 25 microns, about 20 microns, or less than about 20 microns.

4. The consumable product of any one of claims 1 to 3, wherein the consumable product is a chocolate or chocolate-like product comprising a milk, semi-sweet, or dark chocolate or a milk, semi-sweet, or dark chocolate-like product.

5. The consumable product of any one of claims 1 to 4, wherein the consumable product is a chocolate comprising semi-sweet chocolate, milk chocolate, or dark chocolate, and wherein the ground cacao waste material is a filler for the chocolate.

6. The consumable product of any one of claims 1 to 5, wherein the consumable product is a chocolate comprising semi-sweet chocolate, milk chocolate, or dark chocolate, and wherein the consumable product further comprises one or more fillers.

7. The consumable product of any one of claims 4 to 6, wherein the chocolate further comprises cocoa nibs, cocoa solids, dry cocoa powder, or cocoa liquor.

8. The consumable product of any one of claims 3 to 7, wherein the ground cacao waste material comprises a cocoa-free substitute for cocoa solids.

9. The consumable product of any one of claims 3 to 7, wherein the ground cacao waste material comprises a cocoa-free substitute for chocolate liquor.

10. The consumable product of claim 9, further comprising one or more of the following: a fat, a liquid oil, a vegetable fat, cocoa butter, a cocoa butter equivalent and/or a cocoa butter substitute, wherein the ground cacao waste material is wet milled with one or more of the fat, liquid oil, vegetable fat, cocoa butter, cocoa butter equivalent and/or cocoa butter substitute to produce a cocoa-free substitute for chocolate liquor.

11. The consumable product of claim 8, wherein the ground cacao waste material comprises cacao waste material dry milled with a mechanical grinder, a power grinder, a crushing mill, a burr mill, an espresso grinder, a jet mill, a blade grinder, a vortex grinder, and/or a hammer mill.

12. The consumable product of any one of claims 1 to 11, wherein the consumable product further comprises a chocolate-like product comprising a cocoa-free substitute for cocoa solids or a cocoa-free substitute for chocolate liquor.

13. The consumable product of any one of claims 1 to 12, wherein the consumable product comprises a chocolate or chocolate-like product that comprises:
0.01% to about 50% by weight of the ground cacao waste material;
about 20% to about 55% by weight cocoa butter, cocoa butter equivalent, or cocoa butter substitute;
about 20% to about 60% by weight sugar;
and optionally, about 0.01% to about 50% by weight cocoa solids.

14. The consumable product of any one of claims 1 to 13, wherein the consumable product comprises a chocolate or chocolate-like product that comprises:
about 22.5% by weight of the ground cacao waste material;
about 22.5% by weight cocoa butter, cocoa butter equivalent, or cocoa butter substitute;
about 20 to about 60% by weight sugar;
and optionally, about 0.01% to about 50% by weight cocoa solids.

15. The consumable product of any one of claims 1 to 14, wherein the consumable product is a chocolate or chocolate-like product that further comprises one or more of sugar, vanilla extract, vanillin, soy lecithin, and sunflower lecithin.

16. The consumable product of any one of claims 1 to 15, wherein the ground cacao waste material comprises about 50 wt % of the consumable product and wherein cocoa butter, a cocoa butter equivalent, or a cocoa butter substitute comprises about 50 wt % of the consumable product.

17. The consumable product of any one of claims 1 to 12, wherein the consumable product is in the form of a powder.

18. The consumable product of any one of claim 1 to 12 or 17, wherein the consumable product is a substitute for dry cocoa powder.

19. The consumable product of any one of claims 1 to 16, wherein the consumable product is in the form of a paste.

20. The consumable product of any one of claim 1 to 12, 16, or 19, wherein the consumable product is a chocolate-like liquor.

21. The consumable product of any one of claims 1 to 20, wherein the product is a consumable food or beverage.

22. The consumable product of any one of claims 1 to 21, wherein the acid-hydrolyzed cacao waste material has been hydrolyzed with an acid comprising sulfuric acid, hydrochloric acid, phosphoric acid, lactic acid, citric acid, malic acid, acetic acid, fumaric acid, tartaric acid, nitric acid, or glucono-delta-lactone.

23. The consumable product of any one of claims 1 to 22, wherein the alkali-hydrolyzed cacao waste material has been hydrolyzed with an alkali comprising sodium hydroxide, potassium hydroxide, lye, sodium carbonate, calcium carbonate, calcium hydroxide, or potassium bicarbonate.

24. A consumable product comprising ground cocoa shells and/or ground cocoa pods, and one or more of a butanal, a pyrazine, or a pyrrole.

25. The consumable product of claim 24, wherein the ground cocoa shells and/or ground cocoa pods comprise acid-hydrolyzed and roasted cocoa shells and/or cocoa pods or alkali-hydrolyzed and roasted cocoa shells and/or cocoa pods.

26. The consumable product of claim 24, wherein the ground cocoa shells and/or cocoa pods comprise acid-hydrolyzed cocoa shells and/or cocoa pods hydrolyzed with an acid comprising sulfuric acid, hydrochloric acid, phosphoric acid, lactic acid, citric acid, malic acid, acetic acid, fumaric acid, tartaric acid, nitric acid, or glucono-delta-lactone.

27. The consumable product of claim 24, wherein the ground cocoa shells and/or cocoa pods comprise alkali-hydrolyzed cocoa shells and/or cocoa pods hydrolyzed with an alkali comprising sodium hydroxide, potassium hydroxide, lye, sodium carbonate, calcium carbonate, calcium hydroxide, or potassium bicarbonate.

28. A consumable product comprising a plant substrate, wherein the plant substrate comprises ground cocoa shells and/or ground cocoa pods, wherein the ground cocoa shells and/or ground cocoa pods were hydrolyzed with an acid or a base prior to being ground, and wherein the composition comprises one or more of 2-methylbutanal, 3-methylbutanal, 2,5-dimethylpyrazine, 2,3-dimethylpyrazine, 2,3,5-trimethylpyrazine, 3-ethyl-2,5-dimethylpyrazine, 2,3-dimethyl-5-ethylpyrazine, tetramethylpyrazine, 2,3,5-trimethyl-6-ethylpyrazine, 3-isopentyl-2,5-dimethyl-pyrazine, and 2-acetylpyrrole.

29. The consumable product of claim 28, wherein the acid comprises sulfuric acid, hydrochloric acid, phosphoric acid, lactic acid, citric acid, malic acid, acetic acid, fumaric acid, tartaric acid, nitric acid, or glucono-delta-lactone.

30. The consumable product of claim 28, wherein the alkali comprises sodium hydroxide, potassium hydroxide, lye, sodium carbonate, calcium carbonate, calcium hydroxide, or potassium bicarbonate.

31. A method for making a substitute for cocoa nib solids from cocoa shells or cocoa pods, wherein the method comprises:
(a) treating a plurality of cocoa shell or cocoa pod fragments with a chemical solution and/or an enzymatic solution, thereby producing treated shell or pod fragments;
(b) reducing the moisture content of the treated shell or pod fragments to about 3% w/w or less of the treated shell or pod fragments, thereby producing dried shell or pod fragments;
(c) roasting the dried shell or pod fragments, thereby producing roasted shell or pod fragments; and
(d) grinding the roasted shell or pod fragments, thereby producing a ground cocoa shell or ground cocoa pod composition, wherein the composition is effective as a substitute for cocoa nib solids.

32. A method for making a substitute for chocolate liquor from cocoa shells or cocoa pods, wherein the method comprises:
(a) treating a plurality of cocoa shell or cocoa pod fragments with a chemical solution and/or an enzymatic solution, thereby producing treated shell or pod fragments;
(b) reducing the moisture content of the treated shell or pod fragments to about 3% w/w or less of the treated shell or pod fragments, thereby producing dried shell or pod fragments;
(c) roasting the dried shell or pod fragments, thereby producing roasted shell or pod fragments; and
(d) wet grinding the roasted shell or pod fragments in the presence of an oil or fat, thereby producing a ground cocoa shell or ground cocoa pod paste, wherein the paste is effective as a substitute for cocoa liquor.

33. A method for making a filler for chocolate prepared from cocoa shell or cocoa pod fragments, wherein said method comprises:
(a) treating a plurality of cocoa shell or cocoa pod fragments with a chemical solution and/or an enzymatic solution, thereby producing treated cocoa shell or cocoa pod fragments;
(b) removing the treated cocoa shell or cocoa pod fragments from the chemical and/or enzymatic solution;
(c) roasting the treated cocoa shell or cocoa pod fragments, thereby producing roasted cocoa shell or cocoa pod fragments; and
(d) grinding the roasted cocoa shell or cocoa pod fragments, thereby producing a ground cocoa shell or ground cocoa pod composition, wherein the composition is used as all or a portion of the filler for chocolate.

34. The method of any one of claims 31 to 33, comprising treating the cocoa shell or cocoa pod fragments with a chemical solution comprising an acid or alkali solution for about 15 minutes to about 60 minutes, thereby producing acid-treated or alkali-treated cocoa shell or cocoa pod fragments.

35. The method of claim 34, comprising treating the cocoa shell or cocoa pod fragments with the acid or alkali solution at a temperature of about 50° C. to about 100° C.

36. The method of claim 34 or claim 35, comprising roasting the acid-treated or alkali-treated cocoa shell or cocoa pod fragments to a temperature of about 135° C. to about 250° C.

37. The method of any one of claims 31 to 36, wherein the chemical solution comprises an acid comprising sulfuric acid, hydrochloric acid, phosphoric acid, lactic acid, citric acid, malic acid, acetic acid, fumaric acid, tartaric acid, nitric acid, or glucono-delta-lactone.

38. The method of any one of claims 31 to 36, wherein the chemical solution comprises an alkali comprising sodium hydroxide, potassium hydroxide, lye, sodium carbonate, sodium bicarbonate, calcium carbonate, calcium hydroxide, or potassium bicarbonate.

39. A consumable product comprising particles of a processed cacao waste product that has been (a) chemically or enzymatically treated and (b) ground, wherein the particles in the composition are less than 150 microns in size.

40. The consumable product of claim 39, wherein the cacao waste product comprises cocoa shells.

41. The consumable product of claim 39 or claim 40, wherein the cacao waste product comprises cocoa pods.

42. The consumable product of any one of claims 39 to 41, wherein the particles are less than 100 microns in size.

43. The consumable product of any one of claims 39 to 41, wherein the particles have an average particle size of about 15 microns to about 150 microns.

44. The consumable product of any one of claims 39 to 43, wherein the consumable product is a powder.

45. The consumable product of any one of claims 39 to 43, wherein the consumable product is a paste.

46. The consumable product of any one of claim 39 to 43 or 45, wherein the consumable product is a chocolate-like liquor.

47. The consumable product of any one of claim 45 or 46, wherein about 50 wt % of the consumable product is the particles and about 50 wt % of the consumable product is cocoa butter, a cocoa butter substitute, a cocoa butter equivalent, an oil, or a vegetable fat.

48. The consumable product of any one of claims 39 to 47, wherein the consumable product is a consumable food or beverage.

49. A method for preparing a ground plant substrate from cacao waste material for use in a consumable food or beverage, wherein the method comprises:
treating the cacao waste material with an acid in aqueous solution until the cacao waste material reaches a pH of about 2 to 6, thereby generating an acid-treated cacao waste material,
roasting the acid-treated cacao waste material to generate a roasted, acid-treated cacao waste material, and
grinding the roasted, acid-treated cacao waste material to yield the ground plant substrate.

50. The method of claim 49, wherein the cocoa waste material comprises cocoa shells.

51. The method of claim 49 or claim 50, wherein the cocoa waste material comprises cocoa pods.

52. The method of any one of claims 49 to 51, wherein the acid comprises sulfuric acid, hydrochloric acid, phosphoric acid, lactic acid, citric acid, malic acid, acetic acid, fumaric acid, tartaric acid, nitric acid, or glucono-delta-lactone.

53. The method of any one of claims 49 to 52, comprising treating the cacao waste material until a pH of about 2.5 to about 4.5 is reached.

54. The method of any one of claims 49 to 53, comprising treating the cacao waste material with the acid solution at a temperature of about 50° C. to about 100° C.

55. The method of any one of claims 49 to 54, comprising treating the cacao waste material with the acid solution for about 10 minutes to about 3 hours.

56. The method of any one of claims 49 to 54, comprising treating the cacao waste material with the acid solution for about 15 minutes to about 60 minutes.

57. The method of any one of claims 49 to 56, comprising roasting the acid-treated plant material to a temperature of about 165° C. to about 250° C.

58. The method of any one of claims 49 to 57, comprising grinding the roasted, acid-treated plant material to an average particle size of about 15 microns to about 150 microns.

59. The method of any one of claims 49 to 58, further comprising extracting the ground substrate with an aqueous solution to produce an extract.

60. The method of claim 59, wherein the method comprises extracting the ground plant substrate with water at a temperature of about 60° C. to about 85° C.

61. The method of claim 59 or claim 60, further comprising cooling the extract.

62. The method of any one of claims 59 to 61, further comprising filtering the extract.

63. The method of any one of claims 59 to 62, further comprising concentrating the extract to form a concentrate.

64. The method of claim 63, wherein the method comprises concentrating the extract by removing at least some water from the extract.

65. The method of claim 64, wherein a portion of the water is removed by evaporation, freezing, and/or thawing of the extract.

66. The method of any one of claims 63 to 65, further comprising drying the concentrate to form a powder concentrate.

67. The method of claim 66, wherein the drying comprises spray drying, freeze drying or dehydrating.

68. The method of claim 66 or claim 67, wherein the concentrate comprises a soluble powder having a moisture content from about 1% w/w to about 10% w/w.

69. The method of claim 68, wherein the soluble powder is water soluble.

70. A consumable product comprising a ground plant substrate prepared using the method of any one of claims 49 to 69.

71. The consumable product of claim 70, wherein the consumable product is a consumable food or beverage.

72. A composition comprising an extract prepared using the method of any one of claims 59 to 62.

73. A composition comprising a concentrate prepared using the method of any one of claims 63 to 69.

74. A method for preparing a ground plant substrate from cacao waste material for use in a consumable food or beverage, wherein the method comprises:
treating the cacao waste material with a base in aqueous solution until the cacao waste material reaches a pH of about 7 to 12.5, thereby generating a base-treated cacao waste material,
roasting the base-treated cacao waste material to generate a roasted, base-treated cacao waste material, and
grinding the roasted, base-treated cacao waste material to yield the ground plant substrate.

75. The method of claim 74, wherein the cacao waste material comprises cocoa shells.

76. The method of claim 74 or claim 75, wherein the cacao waste material comprises cocoa pods.

77. The method of any one of claims 74 to 76, wherein the base comprises sodium hydroxide, potassium hydroxide, lye, sodium carbonate, calcium carbonate, calcium hydroxide, or potassium bicarbonate.

78. The method of any one of claims 74 to 77, comprising treating the cacao waste material until a pH of about 6 to about 10.5 is reached.

79. The method of any one of claims 74 to 78, comprising treating the cacao waste material with the base solution at a temperature of about 50° C. to about 100° C.

80. The method of any one of claims 74 to 79, comprising treating the cacao waste material with the base solution for about 10 minutes to about 3 hours.

81. The method of any one of claims 74 to 79, comprising treating the cacao waste material with the base solution for about 15 minutes to about 60 minutes.

82. The method of any one of claims 74 to 81, comprising roasting the base-treated plant material to a temperature of about 135° C. to about 250° C.

83. The method of any one of claims 74 to 82, comprising grinding the roasted, base-treated plant material to an average particle size of about 15 microns to about 150 microns.

84. The method of any one of claims 74 to 83, further comprising extracting the ground substrate with an aqueous solution to produce an extract.

85. The method of claim 84, wherein the method comprises extracting the ground plant substrate with water at a temperature of about 60° C. to about 85° C.

86. The method of claim 84 or claim 85, further comprising cooling the extract.

87. The method of any one of claims 84 to 86, further comprising filtering the extract.

88. The method of any one of claims 84 to 87, further comprising concentrating the extract to form a concentrate.

89. The method of claim 88, wherein the method comprises concentrating the extract by removing at least some water from the extract.

90. The method of claim 89, wherein a portion of the water is removed by evaporation, freezing, and/or thawing of the extract.

91. The method of any one of claims 88 to 90, further comprising drying the concentrate to form a powder concentrate.

92. The method of claim 91, wherein the drying comprises spray drying, freeze drying or dehydrating.

93. The method of claim 91 or claim 92, wherein the concentrate comprises a soluble powder having a moisture content from about 1% w/w to about 10% w/w.

94. The method of claim 93, wherein the soluble powder is water soluble.

95. A consumable product comprising a ground plant substrate prepared using the method of any one of claims 74 to 94.

96. The consumable product of claim 95, wherein the consumable product is a consumable food or beverage.

97. A consumable product comprising an extract prepared using the method of any one of claims 84 to 87.

98. A consumable product comprising a concentrate prepared using the method of any one of claims 88 to 94.

99. A method for preparing a ground plant substrate from cacao waste material for use in a consumable food or beverage, wherein the method comprises:
contacting the cacao waste material with an enzymatic solution containing one or more enzymes to generate an enzymatically-treated plant material,
roasting the enzymatically-treated plant material to generate a roasted, enzymatically-treated plant material, and
grinding the roasted, enzymatically-treated plant material to yield the ground plant substrate.

100. The method of claim 99, wherein the cocoa waste material comprises cocoa shells.

101. The method of claim 99 or claim 100, wherein the cocoa waste material comprises cocoa pods.

102. The method of any one of claims 99 to 101, wherein the one or more enzymes comprise a carbohydrase, a protease, and/or a ligninase.

103. The method of claim 102, wherein the one or more enzymes comprise at least one of amylase, a-amylase, β-amylase, lactase, sucrase, isomaltase, pectinase, cellulase, hemicellulase, xylanase, tannase, bromelain, an alkaline protease, papain, actinidin, and ligninase.

104. The method of any one of claims 99 to 103, wherein the enzymatic solution comprises about 0.1% to about 1% enzyme.

105. The method of any one of claims 99 to 104, comprising treating the cacao waste material with the enzymatic solution at a pH of about 7 to about 9.

106. The method of any one of claims 99 to 105, comprising treating the cacao waste material with the acid solution at a temperature of about 30° C. to about 80° C.

107. The method of any one of claims 99 to 106, comprising treating the cacao waste material with the enzymatic solution for about 15 minutes to about 60 minutes.

108. The method of any one of claims 99 to 107, comprising roasting the acid-treated plant material to a temperature of about 165° C. to about 250° C.

109. The method of any one of claims 99 to 108, comprising grinding the roasted, acid-treated plant material to an average particle size of about 100 microns to about 5 mm.

110. The method of any one of claims 99 to 109, further comprising extracting the ground substrate with an aqueous solution to produce an extract.

111. The method of claim 110, wherein the method comprises extracting the ground plant substrate with water at a temperature of about 60° C. to about 85° C.

112. The method of claim 110 or claim 111, further comprising cooling the extract.

113. The method of any one of claims 110 to 112, further comprising filtering the extract.

114. The method of any one of claims 110 to 113, further comprising concentrating the extract to form a concentrate.

115. The method of claim 114, wherein the method comprises concentrating the extract by removing at least some water from the extract.

116. The method of claim 115, wherein a portion of the water is removed by evaporation, freezing, and/or thawing of the extract.

117. The method of any one of claims 114 to 116, further comprising drying the concentrate to form a powder concentrate.

118. The method of claim 117, wherein the drying comprises spray drying, freeze drying or dehydrating.

119. The method of claim 117 or claim 118, wherein the concentrate comprises a soluble powder having a moisture content from about 1% w/w to about 10% w/w.

120. The method of claim 119, wherein the soluble powder is water soluble.

121. A consumable product comprising a ground plant substrate prepared using the method of any one of claims 99 to 120.

122. The consumable product of claim 121, wherein the consumable product is a consumable food or beverage.

123. A consumable product comprising an extract prepared using the method of any one of claims 110 to 113.

124. A consumable product comprising a concentrate prepared using the method of any one of claims 114 to 120.

125. A method for making a substitute for dry cocoa solids from cocoa shells, wherein the method comprises:
(a) treating a plurality of cocoa shells with a chemical solution, thereby producing treated cocoa shells;
(b) reducing the moisture content of the treated shells to 25% w/w or less of the treated shells, thereby producing dried cocoa shells;
(c) roasting the dried shells, thereby producing roasted cocoa shells; and
(d) grinding the roasted cocoa shells, thereby producing a ground shell composition,
wherein the composition is effective as a substitute for dry cocoa solids.

126. The method of claim 125, wherein step (a) comprises using a chemical solution comprising an acid (e.g., phosphoric acid, hydrochloric acid, sulfuric acid, acetic, adipic, citric, fumaric, lactic, malic, tartaric acids, glucono-delta-lactone, or a combination thereof), or a caustic agent (e.g., sodium hydroxide, potassium hydroxide, sodium carbonate, calcium carbonate, calcium hydroxide, potassium bicarbonate, iodine, or a combination thereof).

127. The method of any one of claim 125 or 126, wherein the cocoa shells are treated with the chemical solution at 60° C. to 150° C. (e.g., 75° C. to 100° C.) for 30 minutes to 2 hours, such that the treated shells have a pH of 2.0 to 4.5.
